(19) United States
(12) Patent Application Publication
(10) Pub. No.: US 2024/0340866 A1
(43) Pub. Date: Oct. 10, 2024

(54) BANDWIDTH PART OPERATIONS FOR MULTI-CELL SCHEDULING

(71) Applicant: Samsung Electronics Co., Ltd., Suwon-si (KR)

(72) Inventors: Ebrahim MolavianJazi, San Jose, CA (US); Aristides Papasakellariou, Houston, TX (US)

(21) Appl. No.: 18/620,849

(22) Filed: Mar. 28, 2024

Related U.S. Application Data
(60) Provisional application No. 63/457,694, filed on Apr. 6, 2023.
(60) Provisional application No. 63/466,170, filed on May 12, 2023.
(60) Provisional application No. 63/531,994, filed on Aug. 10, 2023.
(60) Provisional application No. 63/534,520, filed on Aug. 24, 2023.
(60) Provisional application No. 63/547,289, filed on Nov. 3, 2023.
(60) Provisional application No. 63/547,319, filed on Nov. 3, 2023.
(60) Provisional application No. 63/554,732, filed on Feb. 16, 2024.

(51) Int. Cl. H04W 72/0446; H04W 72/12; H04W 72/232

(52) U.S. Cl. CPC H04W 72/0446; H04W 72/12; H04W 72/232

(57) ABSTRACT

Apparatuses and methods for bandwidth part (BWP) operation for multi-cell scheduling. A method includes receiving first information for a set of cells that includes a first cell and a second cell, second information for a table providing time domain resource allocation (TDRA) indexes mapped to respective downlink (DL) BWPs of respective cells from the set of cells, and receiving a DCI format that schedules a first physical downlink shared channel (PDSCH) on a first DL BWP of the first cell and a second PDSCH on a second DL BWP of the second cell. The method further includes determining a first time-domain resource indicated by a first TDRA index that is mapped to the first DL BWP, and a second time-domain resource indicated by a second TDRA index that is mapped to the second DL BWP, and receiving the first and second PDSCHs in the first and second time-domain resources, respectively.

### CROSS-REFERENCE TO RELATED AND CLAIM OF PRIORITY

The present application claims priority under 35 U.S.C. § 119(e) to U.S. Provisional Patent Application No. 63/457,694 filed on Apr. 6, 2023; U.S. Provisional Patent Application No. 63/466,170 filed on May 12, 2023; U.S. Provisional Patent Application No. 63/531,994 filed on Aug. 10, 2023; U.S. Provisional Patent Application No. 63/534,520 filed on Aug. 24, 2023; U.S. Provisional Patent Application No. 63/547,289 filed on Nov. 3, 2023; U.S. Provisional Patent Application No. 63/547,319 filed on Nov. 3, 2023; and U.S. Provisional Patent Application No. 63/554,732 filed on Feb. 16, 2024, which are hereby incorporated by reference in their entirety.

### TECHNICAL FIELD

The present disclosure relates generally to wireless communication systems and, more specifically, the present disclosure is related to apparatuses and methods for bandwidth part (BWP) operations for multi-cell scheduling.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to BWP operations for multi-cell scheduling.

In one embodiment, a method is provided. The method includes receiving first information for a set of serving cells that includes a first serving cell and a second serving cell and second information for a first table. The first table includes a first number of rows. A first row, from the first number of rows, includes first time-domain resource allocation (TDRA) indexes and second TDRA indexes. The first TDRA indexes indicate respective first time-domain resources that have a first one-to-one mapping with first downlink (DL) bandwidth parts (BWPs) of the first serving cell. The second TDRA indexes indicate respective second time-domain resources that have a second one-to-one mapping with second DL BWPs of the second serving cell. The method further includes receiving a DCI format that schedules a first PDSCH reception on the first serving cell and a second PDSCH reception on the second serving cell. A value of a TDRA field in the DCI format indicates the first row of the first table. A value of a BWP indicator field in the DCI format indicates a first DL BWP, from the first DL BWPs, of the first serving cell, and a second DL BWP, from the second DL BWPs, of the second serving cell. The method further includes determining a first time-domain resource, from the first time-domain resources. The first time-domain resource is indicated by a first TDRA index, from the first TDRA indexes, and is mapped to the first DL BWP based on the first mapping, and a second time-domain resource, from the second time-domain resources. The second time-domain resource is indicated by a second TDRA index, from the second TDRA indexes, and is mapped to the second DL BWP based on the second mapping. The method further includes receiving the first PDSCH in the first time-domain resource on the first DL BWP of the first serving cell and the second PDSCH in the second time-domain resource on the second DL BWP of the second serving cell.

In another embodiment, a user equipment (UE) is provided. The UE includes a transceiver configured to receive first information for a set of serving cells that includes a first serving cell and a second serving cell and second information for a first table. The first table includes a first number of rows. A first row, from the first number of rows, includes first time-domain resource allocation (TDRA) indexes and second TDRA indexes. The first TDRA indexes indicate respective first time-domain resources that have a first one-to-one mapping with first DL BWPs of the first serving cell. The second TDRA indexes indicate respective second time-domain resources that have a second one-to-one mapping with second DL BWPs of the second serving cell. The transceiver is further configured to receive a downlink control information (DCI) format that schedules a first PDSCH reception on the first serving cell and a second PDSCH reception on the second serving cell. A value of a TDRA field in the DCI format indicates the first row of the first table. A value of a BWP indicator field in the DCI format indicates a first DL BWP, from the first DL BWPs, of the first serving cell, and a second DL BWP, from the second DL BWPs, of the second serving cell. The UE further includes a processor operably coupled with the transceiver. The processor is configured to determine a first time-domain resource, from the first time-domain resources. The first time-domain resource is indicated by a first TDRA index, from the first TDRA indexes, and is mapped to the first DL BWP based on the first mapping, and a second time-domain resource, from the second time-domain resources. The second time-domain resource is indicated by a second TDRA index, from the second TDRA indexes, and is mapped to the second DL BWP based on the second mapping. The transceiver is further configured to receive the first PDSCH in the first time-domain resource on the first DL BWP of the first serving cell and the second PDSCH in the second time-domain resource on the second DL BWP of the second serving cell.

In yet another embodiment, a base station is provided. The base station includes a transceiver configured to transmit first information for a set of serving cells that includes a first serving cell and a second serving cell and second information for a first table. A first row, from the first number of rows, includes first time-domain resource allocation (TDRA) indexes and second TDRA indexes. The first TDRA indexes indicate respective first time-domain resources that have a first one-to-one mapping with first DL BWPs of the first serving cell. The second TDRA indexes indicate respective second time-domain resources that have a second one-to-one mapping with second DL BWPs of the second serving cell. The transceiver is further configured to transmit a DCI format that schedules a first PDSCH transmission on the first serving cell and a second PDSCH transmission on the second serving cell. A value of a TDRA field in the DCI format indicates the first row of the first table. A value of a BWP indicator field of the DCI format indicates a first DL BWP, from the first DL BWPs, of the first serving cell, and a second DL BWP, from the second DL BWPs, of the second serving cell. The base station further includes a processor operably coupled with the transceiver. The processor is configured to determine a first time-domain resource, from the first time-domain resources. The first time-domain resource is indicated by a first TDRA index, from the first TDRA indexes, and is mapped to the first DL BWP based on the first mapping, and a second time-domain resource, from the second time-domain resources. The second time-domain resource is indicated by a second TDRA index, from the second TDRA indexes, and is mapped to the second DL BWP based on the second mapping. The transceiver is further configured to transmit the first PDSCH in the first time-domain resource on the first DL BWP of the first serving cell and the second PDSCH in the first time-domain resource on the second DL BWP of the second serving cell.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a flowchart of an example UE procedure for determining a value for the field on the new BWP of the cell according to embodiments of the present disclosure;

FIG. 7 illustrates a flowchart of an example UE procedure for determining a value for the field on the new BWP of the cell according to embodiments of the present disclosure; and

FIG. 8 illustrates a flowchart of an example UE procedure for determining a value for the field on the new BWP of the cell according to embodiments of the present disclosure.

### DETAILED DESCRIPTION

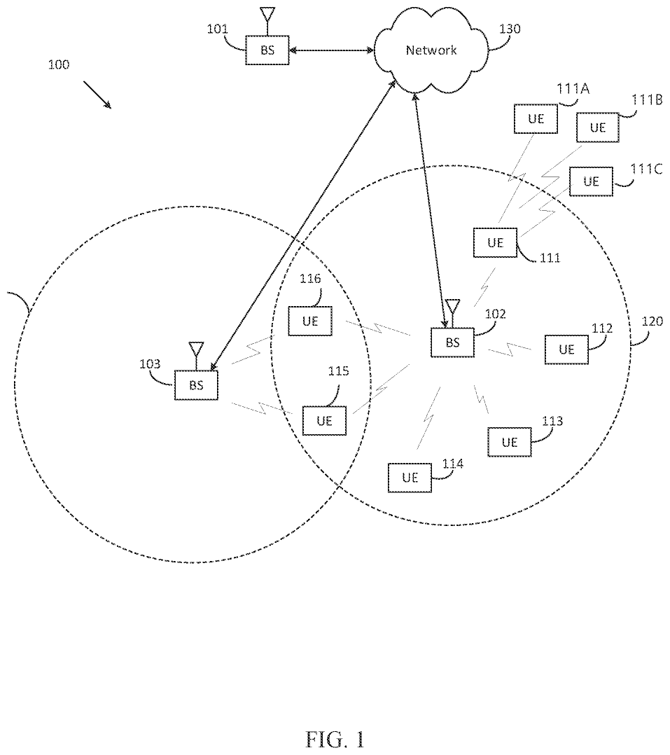

FIGS. 1-8, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [1] 3GPP TS 38.211 v17.4.0, “NR; Physical channels and modulation;” [2] 3GPP TS 38.212 v17.4.0, “NR; Multiplexing and Channel coding;” [3] 3GPP TS 38.213 v17.4.0, “NR; Physical Layer Procedures for Control;” [4] 3GPP TS 38.214 v17.4.0, “NR; Physical Layer Procedures for Data;” [5] 3GPP TS 38.215 v17.2.0, “NR; Physical Layer Measurements;” [6] 3GPP TS 38.321 v17.3.0, “NR; Medium Access Control (MAC) protocol specification;” [7] 3GPP TS 38.331 v17.3.0, “NR; Radio Resource Control (RRC) Protocol Specification;” and [8] 3GPP TS 38.300 Rel-16 v17.4.0, “NR; NR and NG-RAN Overall Description; Stage 2”.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE may be within network coverage and the other UE may be outside network coverage (e.g., UEs 111A-111C). In yet another example, both UEs are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for BWP operations for multi-cell scheduling in a wireless communication system. In certain embodiments, and one or more of the gNBs 101-103 includes circuitry, programing, or a combination thereof, for supporting BWP operations for multi-cell scheduling in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

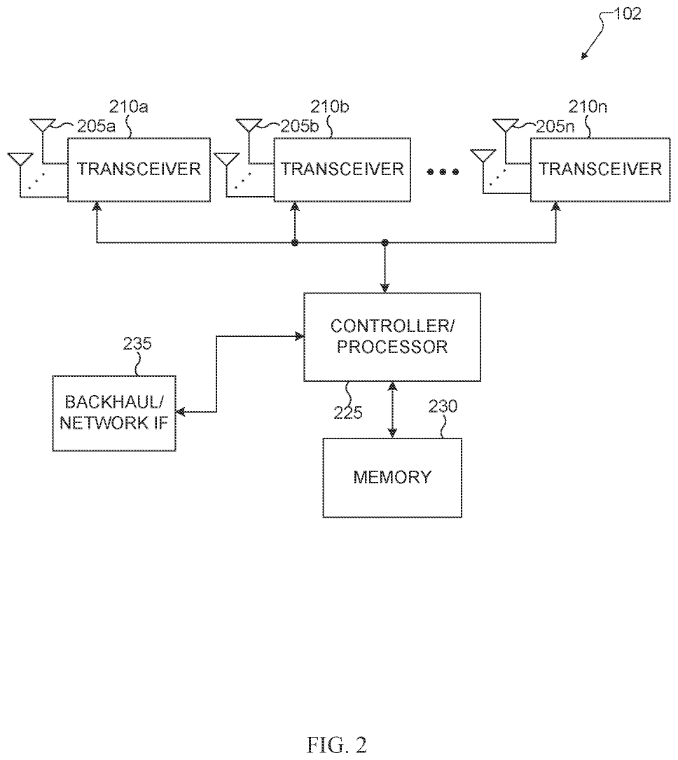

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels and/or signals and the transmission of DL channels and/or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting BWP operations for multi-cell scheduling in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

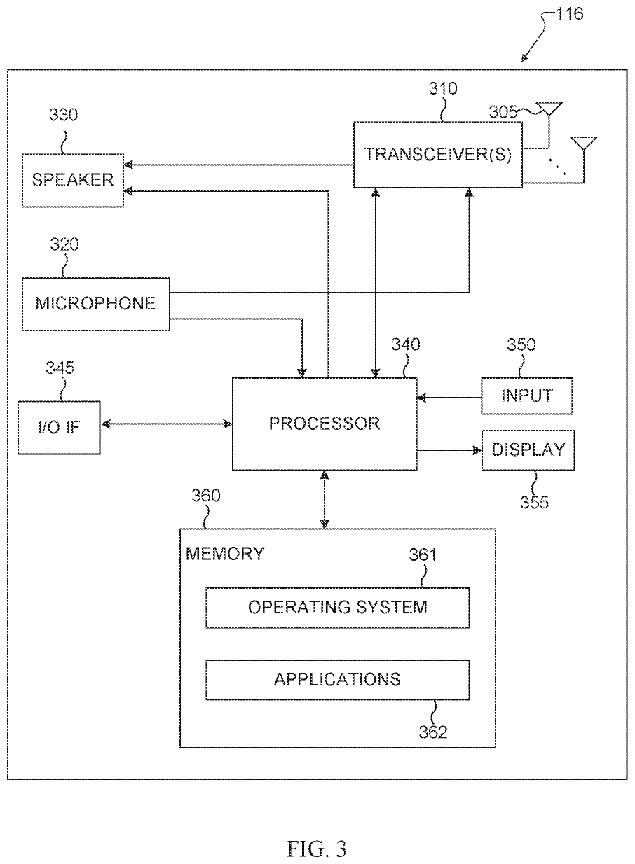

FIG. 3 illustrates an example UE according to embodiments of the present disclosure. The embodiment of the UE illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE includes antenna(s) 305, a transceiver(s) 310, and a microphone 320. The UE also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE. For example, the processor 340 could control the reception of DL channels and/or signals and SL channels and/or signals and the transmission of UL channels and/or signals and SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for BWP operations for multi-cell scheduling in a wireless communication system.

The processor 340 can move data into or out of the memory 360 as required by an executing process. In some embodiments, the processor 340 is configured to execute the applications 362 based on the OS 361 or in response to signals received from gNBs, another UE, or an operator. The processor 340 is also coupled to the I/O interface 345, which provides the UE with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE can use the input 350 to enter data into the UE. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE configured as a mobile telephone or smartphone, UEs could be configured to operate as other types of mobile or stationary devices.

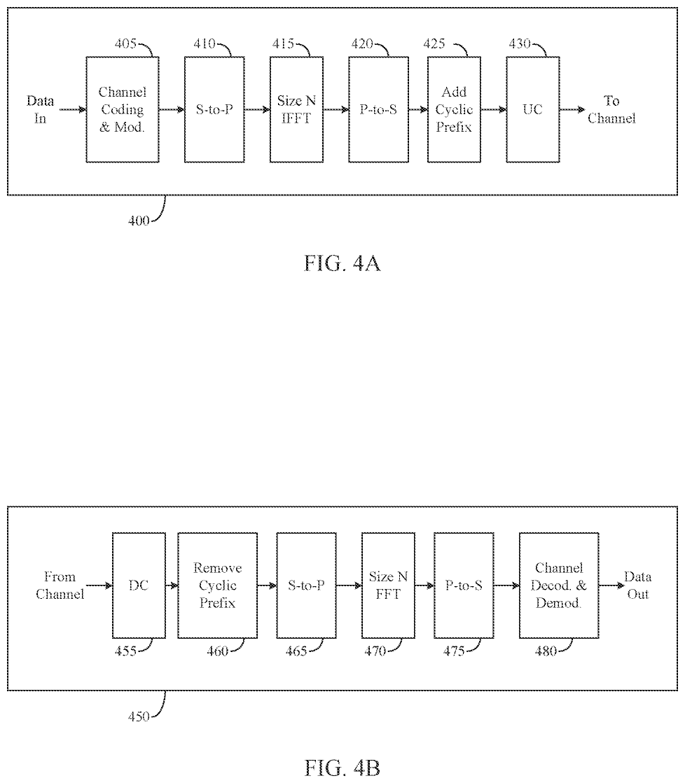

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE). However, it will be understood that the receive path 450 can be implemented in a gNB and that the transmit path 400 can be implemented in a UE. In some embodiments, the transmit path 400 and/or the receive path 450 is configured for BWP operations for multi-cell scheduling as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or sounding RS (SRS). In either case, the ID of the source reference signal identifies the beam. The TCI state and/or the spatial relation reference RS can determine a spatial RX filter for reception of downlink channels at the UE, or a spatial TX filter for transmission of uplink channels from the UE.

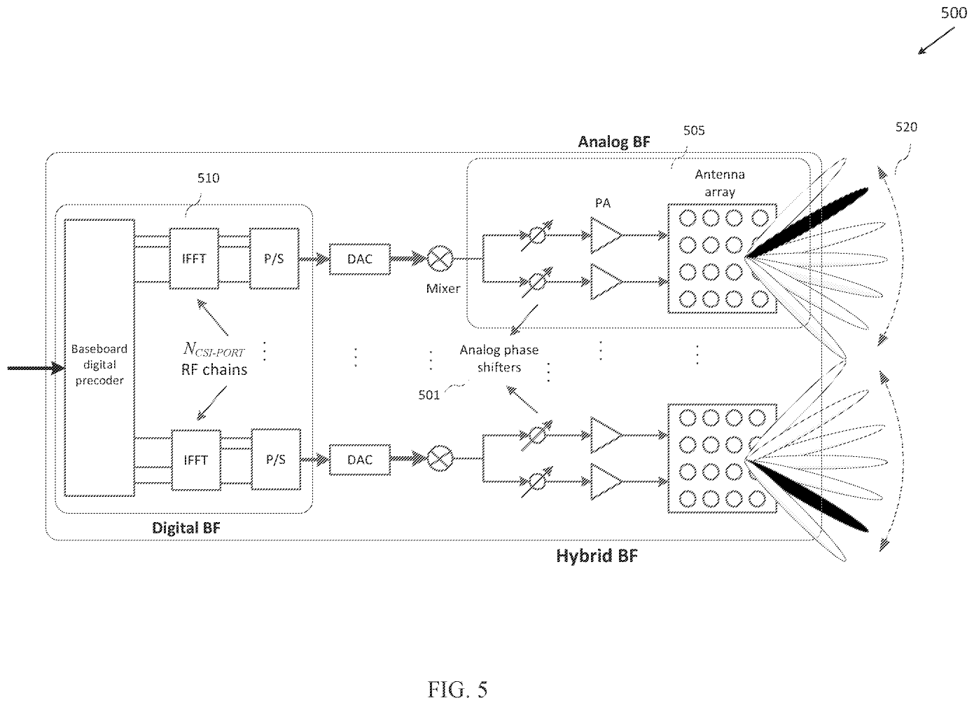

FIG. 5 illustrates an example of a transmitter structure 500 for beamforming according to embodiments of the present disclosure. In certain embodiments, one or more of gNB 102 or UE includes the transmitter structure 500. For example, one or more of antennas 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 500 for beamforming is for illustration only and other embodiments can be used without departing from the scope of the present disclosure.

The flowcharts herein illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

A description of example embodiments is provided on the following pages.

Any of the variation embodiments can be utilized independently or in combination with at least one other variation embodiment.

Throughout this disclosure, all FIGURES such as FIG. 1, FIG. 2, and so on, illustrate examples according to embodiments of the present disclosure. For each FIGURE, the corresponding embodiment shown in the FIG. 1s for illustration only. One or more of the components illustrated in each FIGURE can be implemented in specialized circuitry configured to perform the noted functions or one or more of the components can be implemented by one or more processors executing instructions to perform the noted functions. Other embodiments could be used without departing from the scope of the present disclosure. In addition, the descriptions of the FIGURES are not meant to imply physical or architectural limitations to the manner in which different embodiments may be implemented. Different embodiments of the present disclosure may be implemented in any suitably-arranged communications system.

The present disclosure relates to a pre-5th-Generation (5G) or 5G or beyond 5G communication system to be provided for supporting one or more of: higher data rates, lower latency, higher reliability, improved coverage, and massive connectivity, and so on. Various embodiments apply to UEs operating with other RATs and/or standards, such as different releases/generations of 3GPP standards (including beyond 5G, 5G Advanced, 6G, and so on), IEEE standards (such as 802.16 WiMAX and 802.11 Wi-Fi and so on), and so forth.

A communication system can include a downlink (DL) that refers to transmissions from a base station (such as the BS 102) or one or more transmission points to UEs (such as the UE) and an uplink (UL) that refers to transmissions from UEs (such as the UE) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources.

A UE (such as the UE) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot (n+3Nₛₗₒₜ^{subframe,μ})

In the following and throughout the disclosure, various embodiments of the disclosure may be also implemented in any type of UE including, for example, UEs with the same, similar, or more capabilities compared to legacy 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by MIB or a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with SCells or additional SCGs by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types ‘D’, ‘U’ or ‘F’ using at least one time-domain pattern with configurable periodicity.

In the following, for brevity of description, SFI refers to a slot format indicator as example that is indicated using higher layer provided IEs such as slotFormatCombination or slotFormatCombinationsPerCell and which is indicated to the UE by group common DCI format such as DCI F2_0 where slotFormats are defined in [REF3, TS 38.213].

The Synchronization Signal and PBCH block (SSB) consists of primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by sub-carrier spacing and the periodicity of the half-frames where SSBs are transmitted is configured by the network. During a half-frame, different SSBs may be transmitted in different spatial directions (i.e., using different beams, spanning the coverage area of a cell).

Within the frequency span of a carrier, multiple SSBs can be transmitted. The PCIs of SSBs transmitted in different frequency locations do not have to be unique, i.e., different SSBs in the frequency domain can have different PCIs. However, when an SSB is associated with an RMSI, the SSB is referred to as a Cell-Defining SSB (CD-SSB). A PCell is always associated to a CD-SSB located on the synchronization raster.

Polar coding is used for PBCH. The UE may assume a band-specific sub-carrier spacing for the SSB unless a network has configured the UE to assume a different sub-carrier spacing. PBCH symbols carry its own frequency-multiplexed DMRS. QPSK modulation is used for PBCH.

Measurement time resource(s) for SSB-based RSRP measurements may be confined within a SSB Measurement Time Configuration (SMTC). The SMTC configuration provides a measurement window periodicity/duration/offset information for UE RRM measurement per carrier frequency. For intra-frequency connected mode measurement, up to two measurement window periodicities can be configured. For RRC_IDLE, a single SMTC is configured per carrier frequency for measurements. For inter-frequency mode measurements in RRC_CONNECTED, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for RSSI are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

Throughout the present disclosure, the term “configuration” or “higher layer configuration” and variations thereof (such as “configured” and so on) are used to refer to one or more of: a system information signaling such as by a MIB or a SIB (such as SIB1), a common or cell-specific higher layer/RRC signaling, or a dedicated or UE-specific or BWP-specific higher layer/RRC signaling.

Throughout the present disclosure, the term signal quality is used to refer to e.g., RSRP or RSRQ or RSSI or SNR or SINR, with or without filtering such as L1 or L3 filtering, of a channel or a signal such as a reference signal (RS) including SSB, CSI-RS, or SRS.

Various method or examples in the present disclosure are expressed in terms of serving cells. Such methods or examples can apply also to cells other than serving cells, such as non-serving cells, candidate cells, cells of a different cell group such as different PUCCH group or master/secondary cells groups (MCG or SCG), or cells of a different radio access technology (RAT), and so on, or can apply to combinations of serving cells and such other cells, for example, in scenarios such as mobility or handover, including before, during or after such procedures or other UE events or such as coexistence or spectrum sharing with other RATs.

Independent of the configuration of tci-PresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’:
the UE may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).
If a UE is configured with enableDefaultTCIStatePerCoresetPoolIndex and the UE is configured by higher layer parameter PDCCH-Config that contains two different values of coresetPoolIndex in different ControlResourceSets:
   the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same coresetPoolIndex, the UE is expected to prioritize the reception of PDCCH associated with that CORESET. This also applies to the intra-band CA case (when PDSCH and the CORESET are in different component carriers).
If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, and the offset between the reception of the DL DCI and the first PDSCH transmission occasion is less than the threshold timeDurationForQCL, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers)
In all cases above, if none of configured TCI states for the serving cell of scheduled PDSCH is configured with qcl-Type set to ‘typeD’, the UE shall obtain the other QCL assumptions from the indicated TCI states for its scheduled PDSCH irrespective of the time offset between the reception of the DL DCI and the corresponding PDSCH.

If the PDCCH carrying the scheduling DCI is received on one component carrier, and the PDSCH scheduled by that DCI is on another component carrier:
The timeDurationForQCL is determined based on the subcarrier spacing of the scheduled PDSCH. If μ_{PDCCH}<μ_{PDSCH} an additional timing delay

$$d \frac{{2}^{{μ}_{PDSCH}}}{{2}^{{μ}_{PDCCH}}}$$

is added to the timeDurationForQCL, where d is defined in 5.2.1.5.1a-1, otherwise d is zero;
For both the cases, when the UE is configured with enableDefaultBeamForCCS, and when the offset between the reception of the DL DCI and the corresponding PDSCH is less than the threshold timeDurationForQCL, and when the DL DCI does not have the TCI field present, the UE obtains its QCL assumption for the scheduled PDSCH from the activated TCI state with the lowest ID applicable to PDSCH in the active BWP of the scheduled cell.

For PUSCH scheduled by DCI format 0_0 on a cell and if the higher layer parameter enableDefaultBeamPL-ForPUSCH0-0 is set ‘enabled’, the UE is not configured with PUCCH resources on the active UL BWP and the UE is in RRC connected mode, the UE shall transmit PUSCH according to the spatial relation, if applicable, with a reference to the RS configured with qcl-Type set to ‘typeD’ corresponding to the QCL assumption of the CORESET with the lowest ID on the active DL BWP of the cell.

For PUSCH scheduled by DCI format 0_0 on a cell and if the higher layer parameter enableDefaultBeamPL-ForPUSCH0 is set ‘enabled’, the UE is configured with PUCCH resources on the active UL BWP where all the PUCCH resource(s) are not configured with any spatial relation and the UE is in RRC connected mode, the UE shall transmit PUSCH according to the spatial relation, if applicable, with a reference to the RS configured with qcl-Type set to ‘typeD’ corresponding to the QCL assumption of the CORESET with the lowest ID on the active DL BWP of the cell in case CORESET(s) are configured on the cell.

In Multiple Transmit/Receive Point (multi-TRP) operation, a serving cell can schedule UE from two TRPs, providing better PDSCH coverage, reliability and/or data rates.

There are two different operation modes for multi-TRP: single-DCI and multi-DCI. For both modes, control of uplink and downlink operation is done by both physical layer and MAC. In single-DCI mode, UE is scheduled by the same DCI for both TRPs and in multi-DCI mode, UE is scheduled by independent DCIs from each TRP.

In Carrier Aggregation (CA), two or more Component Carriers (CCs) are aggregated. A UE may simultaneously receive or transmit on one or multiple CCs depending on its capabilities:
A UE with single timing advance capability for CA can simultaneously receive and/or transmit on multiple CCs corresponding to multiple serving cells sharing the same timing advance (multiple serving cells grouped in one TAG);
A UE with multiple timing advance capability for CA can simultaneously receive and/or transmit on multiple CCs corresponding to multiple serving cells with different timing advances (multiple serving cells grouped in multiple TAGs). NG-RAN ensures that each TAG contains at least one serving cell;
A non-CA capable UE can receive on a single CC and transmit on a single CC corresponding to one serving cell only (one serving cell in one TAG).

When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the Primary Cell (PCell). Depending on UE capabilities, Secondary Cells (SCells) can be configured to form together with the PCell a set of serving cells. The configured set of serving cells for a UE therefore always consists of one PCell and one or more SCells.

The reconfiguration, addition and removal of SCells can be performed by RRC. At intra-NR handover and during connection resume from RRC_INACTIVE, the network can also add, remove, keep, or reconfigure SCells for usage with the target PCell. When adding a new SCell, dedicated RRC signalling is used for sending all required system information of the SCell i.e., while in connected mode, UEs need not acquire broadcast system information directly from the SCells.

To enable reasonable UE battery consumption when CA is configured, an activation/deactivation mechanism of Cells is supported. When an SCell is deactivated, the UE does not need to receive the corresponding PDCCH or PDSCH, cannot transmit in the corresponding uplink, nor is it required to perform CQI measurements. Conversely, when an SCell is active, the UE shall receive PDSCH and PDCCH (if the UE is configured to monitor PDCCH from this SCell) and is expected to be able to perform CQI measurements. NG-RAN ensures that while PUCCH SCell (a Secondary Cell configured with PUCCH) is deactivated, SCells of secondary PUCCH group (a group of SCells whose PUCCH signalling is associated with the PUCCH on the PUCCH SCell) should not be activated. NG-RAN ensures that SCells mapped to PUCCH SCell are deactivated before the PUCCH SCell is changed or removed.

When reconfiguring the set of serving cells:
SCells added to the set are initially activated or deactivated;
SCells which remain in the set (either unchanged or reconfigured) do not change their activation status (activated or deactivated).

At handover or connection resume from RRC_INACTIVE:
SCells are activated or deactivated.

To enable reasonable UE battery consumption when BA is configured, only one UL BWP for each uplink carrier and one DL BWP or only one DL/UL BWP pair can be active at a time in an active serving cell, all other BWPs that the UE is configured with being deactivated. On deactivated BWPs, the UE does not monitor the PDCCH, does not transmit on PUCCH, PRACH and UL-SCH.

To enable fast SCell activation when CA is configured, one dormant BWP can be configured for an SCell. If the active BWP of the activated SCell is a dormant BWP, the UE stops monitoring PDCCH and transmitting SRS/PUSCH/PUCCH on the SCell but continues performing CSI measurements, AGC and beam management, if configured. A DCI is used to control entering/leaving the dormant BWP for one or more SCell(s) or one or more SCell group(s).

The dormant BWP is one of the UE's dedicated BWPs configured by network via dedicated RRC signalling. The SpCell and PUCCH SCell cannot be configured with a dormant BWP.

Cross-carrier scheduling with the Carrier Indicator Field (CIF) allows the PDCCH of a serving cell to schedule resources on another serving cell but with the following restrictions:
Cross-carrier scheduling does not apply to PCell i.e., PCell is always scheduled via its PDCCH;
When an SCell is configured with a PDCCH, that cell's PDSCH and PUSCH are always scheduled by the PDCCH on this SCell;
When an SCell is not configured with a PDCCH, that SCell's PDSCH and PUSCH are always scheduled by a PDCCH on another serving cell;
The scheduling PDCCH and the scheduled PDSCH/PUSCH can use the same or different numerologies.

Some of the restrictions herein may be relaxed. For example, dynamic spectrum sharing (DSS) allows LTE and NR to share the same carrier. As the number of NR devices in a network increases, it is important that sufficient scheduling capacity for NR UEs on the shared carriers is ensured. In the case of DSS operation, PDCCH enhancements for cross-carrier scheduling including can be considered such that PDCCH of an SCell, referred to as a special/scheduling SCell (sSCell), can schedule PDSCH or PUSCH on the P(S)Cell.

The Physical Downlink Control Channel (PDCCH) can be used to schedule DL transmissions on PDSCH and UL transmissions on PUSCH, where the Downlink Control Information (DCI) on PDCCH includes:
Downlink assignments containing at least modulation and coding format, resource allocation, and hybrid-ARQ information related to DL-SCH;
Uplink scheduling grants containing at least modulation and coding format, resource allocation, and hybrid-ARQ information related to UL-SCH.

In addition to scheduling, PDCCH can be used to for
Activation and deactivation of configured PUSCH transmission with configured grant;
Activation and deactivation of PDSCH semi-persistent transmission;
Notifying one or more UEs of the slot format;
Notifying one or more UEs of the PRB(s) and OFDM symbol(s) where the UE may assume no transmission is intended for the UE;
Transmission of TPC commands for PUCCH and PUSCH;
Transmission of one or more TPC commands for SRS transmissions by one or more UEs;
Switching a UE's active bandwidth part;
Initiating a random-access procedure;
Indicating the UE(s) to monitor the PDCCH during the next occurrence of the DRX on-duration;
In IAB context, indicating the availability for soft symbols of an IAB-DU;
Triggering one shot HARQ-ACK codebook feedback;
For operation with shared spectrum channel access:
   Triggering search space set group switching;
   Indicating one or more UEs about the available RB sets and channel occupancy time duration;
   Indicating downlink feedback information for configured grant PUSCH (CG-DFI).

A UE monitors a set of PDCCH candidates in the configured monitoring occasions in one or more configured COntrol REsource SETs (CORESETs) according to the corresponding search space configurations.

A CORESET consists of a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCE. Different code rates for the control channels are realized by aggregating different number of CCE. Interleaved and non-interleaved CCE-to-REG mapping are supported in a CORESET.

Polar coding and QPSK modulation are used for PDCCH. Each resource element group carrying PDCCH carries its own DMRS.

A UE monitors a set of PDCCH candidates in one or more CORESETs on the active DL BWP on each activated serving cell configured with PDCCH monitoring according to corresponding search space sets where monitoring implies decoding each PDCCH candidate according to the monitored DCI formats.

In the downlink, the gNB can dynamically allocate resources to UEs via the C-RNTI on PDCCH(s). A UE always monitors the PDCCH(s) in order to find possible assignments when its downlink reception is enabled (activity governed by DRX when configured). When CA is configured, the same C-RNTI applies to all serving cells.

The gNB may pre-empt an ongoing PDSCH transmission to one UE with a latency-critical transmission to another UE. The gNB can configure UEs to monitor interrupted transmission indications using INT-RNTI on a PDCCH. If a UE receives the interrupted transmission indication, the UE may assume that no useful information to that UE was carried by the resource elements included in the indication, even if some of those resource elements were already scheduled to this UE.

In addition, with Semi-Persistent Scheduling (SPS), the gNB can allocate downlink resources for the initial HARQ transmissions to UEs: RRC defines the periodicity of the configured downlink assignments while PDCCH addressed to CS-RNTI can either signal and activate the configured downlink assignment, or deactivate it; i.e. a PDCCH addressed to CS-RNTI indicates that the downlink assignment can be implicitly reused according to the periodicity defined by RRC, until deactivated. When required, retransmissions are explicitly scheduled on PDCCH(s).

The dynamically allocated downlink reception overrides the configured downlink assignment in the same serving cell, if they overlap in time. Otherwise, a downlink reception according to the configured downlink assignment is assumed, if activated.

The UE may be configured with up to 8 active configured downlink assignments for a given BWP of a serving cell. When more than one is configured:
The network decides which of these configured downlink assignments are active at a time (including all of them); and
Each configured downlink assignment is activated separately using a DCI command and deactivation of configured downlink assignments is done using a DCI command, which can either deactivate a single configured downlink assignment or multiple configured downlink assignments jointly.

PUSCH may be scheduled with DCI on PDCCH, or a semi-static configured grant may be provided over RRC, where two types of operation are supported:
The first PUSCH is triggered with a DCI, with subsequent PUSCH transmissions following the RRC configuration and scheduling received on the DCI, or
The PUSCH is triggered by data arrival to the UE's transmit buffer and the PUSCH transmissions follow the RRC configuration.

In the uplink, the gNB can dynamically allocate resources to UEs via the C-RNTI on PDCCH(s). A UE always monitors the PDCCH(s) in order to find possible grants for uplink transmission when its downlink reception is enabled (activity governed by DRX when configured).

When CA is configured, the same C-RNTI applies to all serving cells.

The gNB may cancel a PUSCH transmission, or a repetition of a PUSCH transmission, or an SRS transmission of a UE for another UE with a latency-critical transmission. The gNB can configure UEs to monitor cancelled transmission indications using CI-RNTI on a PDCCH. If a UE receives the cancelled transmission indication, the UE shall cancel the PUSCH transmission from the earliest symbol overlapped with the resource or the SRS transmission overlapped with the resource indicated by cancellation.

In addition, with Configured Grants, the gNB can allocate uplink resources for the initial HARQ transmissions and HARQ retransmissions to UEs. Two types of configured uplink grants are defined:
With Type 1, RRC directly provides the configured uplink grant (including the periodicity).
With Type 2, RRC defines the periodicity of the configured uplink grant while PDCCH addressed to CS-RNTI can either signal and activate the configured uplink grant, or deactivate it; i.e., a PDCCH addressed to CS-RNTI indicates that the uplink grant can be implicitly reused according to the periodicity defined by RRC, until deactivated.

The HARQ functionality ensures delivery between peer entities at Layer 1. A single HARQ process supports one TB when the physical layer is not configured for downlink/uplink spatial multiplexing, and when the physical layer is configured for downlink/uplink spatial multiplexing, a single HARQ process supports one or multiple TBs.

In case of CA, the multi-carrier nature of the physical layer is only exposed to the MAC layer for which one HARQ entity is required per serving cell. In both uplink and downlink, there is one independent HARQ entity per serving cell and one transport block is generated per assignment/grant per serving cell in the absence of spatial multiplexing. Each transport block and its potential HARQ retransmissions are mapped to a single serving cell.

For downlink, Asynchronous Incremental Redundancy Hybrid ARQ is supported. The gNB provides the UE with the HARQ-ACK feedback timing either dynamically in the DCI or semi-statically in an RRC configuration. Retransmission of HARQ-ACK feedback is supported for operation with shared spectrum channel access by using enhanced dynamic codebook and/or one-shot triggering of HARQ-ACK transmission for all configured CCs and HARQ processes in the PUCCH group. The UE may be configured to receive code block group-based transmissions where retransmissions may be scheduled to carry a sub-set of all the code blocks of a TB.

For uplink, Asynchronous Incremental Redundancy HARQ is supported. The gNB schedules each uplink transmission and retransmission using the uplink grant on DCI. For operation with shared spectrum channel access, UE can also retransmit on configured grants. The UE may be configured to transmit code block group-based transmissions where retransmissions may be scheduled to carry a sub-set of all the code blocks of a transport block.

Up to two HARQ-ACK codebooks corresponding to a priority (high/low) can be constructed simultaneously. For each HARQ-ACK codebook, more than one PUCCH for HARQ-ACK transmission within a slot is supported. Each PUCCH is limited within one sub-slot, and the sub-slot pattern is configured per HARQ-ACK codebook.

Physical uplink control channel (PUCCH) carries the Uplink Control Information (UCI) from the UE to the gNB. UCI includes at least hybrid automatic request acknowledgement (HARQ-ACK) information, scheduling request (SR), and channel state information (CSI).

UCI can be transmitted on a PUCCH or multiplexed in a PUSCH. UCI multiplexing in PUSCH is supported when UCI and PUSCH transmissions coincide in time, either due to transmission of a UL-SCH transport block or due to triggering of A-CSI transmission without UL-SCH transport block:
UCI carrying HARQ-ACK feedback with 1 or 2 bits is multiplexed by puncturing PUSCH;
In all other cases UCI is multiplexed by rate matching PUSCH.

The present disclosure considers enhancements for cross-carrier scheduling operation in a carrier aggregation (CA) framework to support joint scheduling of multiple cells.

In legacy 5G NR systems, a downlink or uplink data transmission can be scheduled only for a single serving cell. In other words, a downlink control information (DCI) format provides scheduling information parameters for a physical downlink shared channel (PDSCH) or a physical uplink shared channel (PUSCH) on a single serving cell. If the serving cell is a scheduled cell, the UE receives a DCI format for the PDSCH/PUSCH in a physical downlink control channel (PDCCH) that the UE receives on a corresponding scheduling cell. Based on a carrier indication field (CIF) in the DCI format, the UE can determine a serving cell on which the UE can receive the PDSCH or transmit the PUSCH.

However, legacy NR system does not support joint scheduling of multiple PDSCHs or multiple PUSCH on multiple cells using a single/common control signaling, such as by using a single DCI format. For such operation, the UE receives multiple DCI formats, wherein each DCI format can schedule one of the multiple PDSCHs or PUSCHs. Such operation achieves the intended outcome, but with possibly high signaling overhead. In various scenarios, several scheduling parameters or corresponding UE operations are shared/common among the multiple PDSCHs or PUSCHs on the jointly scheduled cells, referred to as co-scheduled cells.

Embodiments of the present disclosure recognize there is a need to determine the bit-width and values of the fields in a multi-cell scheduling DCI format when a multi-cell scheduling DCI format triggers a BWP change for one of the co-scheduled cells.

There is another need to determine a timeline for PDSCH reception or PUSCH transmission when a multi-cell scheduling DCI format triggers a BWP change for one of the co-scheduled cells.

The present disclosure provides methods and apparatus for bandwidth part (BWP) operation for multi-cell scheduling.

One motivation for multi-cell scheduling using a single DCI format is enhanced cross-carrier scheduling operation for larger number of cells, such as 4-8 cells, operating in an intra-band CA framework in frequency bands below 6 GHz or above 6 GHz, referred to as FR1 or FR2, respectively. In general, the embodiments apply to any deployments, verticals, or scenarios including inter-band CA, with enhanced mobile broadband (eMBB), ultra reliable low latency communications (URLLC) and industrial internet of things (IIoT) and extended reality (XR), massive machine-type communications (mMTC) and internet of things (IoT), with sidelink/vehicle to anything (V2X) communications, with multi-TRP/beam/panel, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, and so on.

Embodiments of the disclosure for supporting multi-cell scheduling with reduced signaling overhead are summarized in the following and are fully elaborated further below. Combinations of the embodiments are also applicable, but they are not described in detail for brevity.

Embodiments of the disclosure for hybrid automatic repeat request acknowledgement (HARQ-ACK) codebook design in presence of multiple sets of cells for multi-cell scheduling are summarized in the following and are fully elaborated further below. Combinations of the embodiments are also applicable, but they are not described in detail for brevity.

In one embodiment, a UE can be provided a number of sets of co-scheduled cells by higher layers. The term set of co-scheduled cells is used to refer to a set of serving cells wherein the UE can be scheduled PDSCH receptions or PUSCH transmissions on two or more cells from the set of co-scheduled cells by a single DCI format, or by using complementary methods such as described in one or more embodiments. Additionally, the UE can be indicated via a DCI format in a PDCCH or via a MAC control element (CE) in a PDSCH a subset of a set of co-scheduled cells, wherein cells of the subset can change across different PDCCH monitoring occasions, for example, as indicated by a corresponding DCI format.

In another embodiment, the UE can distinguish a single-cell scheduling DCI format from a multi-cell scheduling DCI format via various methods, such as a DCI format size, or a radio network temporary identifier (RNTI) used for scrambling a cyclic redundancy check (CRC) of a DCI format for multi-cell scheduling, or by an explicit indication by a field in the DCI format, or by a dedicated CORESET and associated search space sets.

In another embodiment, the UE can distinguish a single-cell scheduling DCI format from a multi-cell scheduling DCI format via various methods, such as a DCI format size, or an RNTI used for scrambling a CRC of a DCI format for multi-cell scheduling, or by an explicit indication by a field in the DCI format, or by a dedicated CORESET and associated search space sets. There can be two cases for monitoring a DCI format for multi-cell scheduling: a first case based on search space set(s) dedicated to multi-cell scheduling, and a second case based on search space set(s) shared by both single-cell scheduling and multi-cells scheduling.

In one embodiment, a size/bit-width of a cell-specific field (also known as, a “Type-2” field), for each cell from cells that are co-scheduled by a multi-cell scheduling DCI format 0_3/1_3, can be a size/bit-width of the field for the active BWP of the cell, or can be a maximum size/bit-width of the field across different configured BWPs of the cell. When the DCI format 0_3/1_3 triggers a BWP change for the cell, the UE determines a value of the field for the new BWP of the cell by using a value of the field that is provided in the DCI format 0_3/1_3 for the active BWP of the cell, and truncating from the left (or from the right) or prepending zeros if a corresponding size/bit-width is larger than or smaller than a size/bit-width needed for the new BWP of the cell, respectively.

In one embodiment, a size/bit-width of a cell-common field (also known as, a “Type-1A” field) in a multi-cell scheduling DCI format 0_3/1_3 that is associated with a set of cells for multi-cell scheduling can be based on a maximum size/bit-width of the field across respective active BWPs of different cells in the set of cell, or based on a maximum field size among all configured BWPs of different cells in the set of cells. In addition, when the DCI format triggers a BWP change for a cell, from cells that are co-scheduled by the DCI format 0_3/1_3 (or from cells in the set of cells), the UE determines a value of the cell-common/Type-1A field for the new BWP of the cell, in one option, by using a number of least significant bits (LSBs) from the value provided in the DCI format for the cell-common/Type-1A field, wherein the number is equal to a size/bit-width of the field for the new BWP of the cell. In another option, the UE uses a value of the cell-common/Type-1A field that is determined for the active BWP of the cell, which can be truncated from the right or prepended zeros if a corresponding size/bit-width is larger than or smaller than a size/bit-width needed for the new BWP of the cell. Similar methods also apply to “Type-1C” fields in the DCI format 0_3/1_3, namely fields for which the DCI format 0_3/1_3 provides a single value that is applicable to only one cell from the cells that are co-scheduled by the DCI format 0_3/1_3 (or from the set of cells).

In one embodiment, a size/bit-width of a Type-1B field in a multi-cell scheduling DCI format 0_3/1_3 (that provides a codepoint indicating a row of a joint multi-cell encoding table, with entries of the row corresponding to cells in a set of cells for multi-cell scheduling) is based on a number of rows configured in the table. For each Type-1B field, in one option, the UE can be configured multiple separate tables corresponding to different BWP combinations for the set of cells, wherein a BWP combination corresponds to a collection of a first configured BWP for a first cell, and a second configured BWP for a second cell, and so on. When a DCI format 0_3/1_3 triggers a BWP change to a new BWP for a cell, from the cells that are co-scheduled by the DCI format 0_3/1_3 (or from the set of cells), the UE uses for the new BWP of the cell, a value/entry corresponding to the cell in a row, as indicated by the codepoint in the DCI format 0_3/1_3, from a table associated with a new BWP combination that corresponds to the new BWP of the cell. When the codepoint in the DCI format 0_3/1_3 indicates a row index that is not present in (i.e., outside range of) the table, the UE transmits the corresponding PUSCH or receive the corresponding PDSCH on the cell by applying a default behavior for the field, or the UE drops the corresponding PUSCH transmission or PDSCH reception on the cell. In another option, for each Type-1B field, the UE can be configured a single table that corresponds to all different BWP combinations for the set of cells. When a DCI format 0_3/1_3 triggers a BWP change for a cell, from the co-scheduled cells (or from the set of cells), and an entry, corresponding to the cell, in a row of the table provides a value (or ID of a value) that is not configured or activated for the new BWP of the cell, the UE transmits the corresponding PUSCH or receive the corresponding PDSCH on the cell by truncating or zero-padding the value (or ID of the value) provided by the table, or by applying a default behavior for the field, or the UE drops the corresponding PUSCH transmission or PDSCH reception on the cell.

In one embodiment, for a UE that is capable of multi-cell scheduling, the UE can report a capability for a number of unicast DCI formats that the UE can process per slot or per a number of consecutive slots. A unicast DCI format can be a single-cell scheduling DCI (SC-DCI) format such as DCI format 0_0/1_0/0_1/1_1/0_2/1_2 or a multi-cell scheduling DCI (MC-DCI) format 0_3/1_3. There can be various options in terms of processing only one of MC-DCI or SC-DCI or both of them, and also in terms of counting the processed unicast DCIs per scheduled cell or per set of cells for multi-cell scheduling.

In one embodiment, when a multi-cell scheduling DCI format 0_3/1_3 indicates UL/DL BWP change for at least one cell from the set of cells that is associated with the DCI format 0_3/1_3, the UE transmits the scheduled PUSCHs or receives the scheduled PDSCHs (only) if respective K2/K0 values (indicating a gap between PDCCH and corresponding PUSCH/PDSCH) indicated by respective time domain resource allocation (TDRA) values applicable for the at least one cell is not smaller than a BWP switching delay for the UL/DL BWP. Otherwise, the UE does not transmit PUSCHs or receive PDSCHs on (the new UL/DL BWP) of the at least cell. In one example, the UE does not transmit any of the PUSCHs or receive any of the PDSCHs on (the new UL/DL BWP of) any of the cells in the set of cells.

In one embodiment, when a DCI format 1_3 schedules PDSCHs on cell from a set of cells, and the UE receives a PDCCH providing the DCI format 1_3 in a PDCCH monitoring occasion that is before a BWP change on a cell, from the cell, or before a BWP change for a reference cell from the set of cells, or before a BWP change for all co-scheduled cells, the UE drops HARQ-ACK information corresponding to the cell or the co-scheduled cells, for example, by including negative ACKs (NACKs) for the cell or cells.

Throughout the present disclosure, the term “configuration” or “higher layer configuration” and variations thereof (such as “configured” and so on) are used to refer to one or more of: a system information signaling such as by a master information block (MIB) or a system information block (SIB) (such as SIB1), a common or cell-specific higher layer/RRC signaling, or a dedicated or UE-specific or BWP-specific higher layer/RRC signaling.

Throughout the present disclosure, the term signal quality is used to refer to e.g., reference signal received power (RSRP), or reference signal received quality (RSRQ) or received signal strength indicator (RSSI) or signal-to-noise ratio (SNR) or signal to interference and noise ratio (SINR), with or without filtering such as L1 or L3 filtering, of a channel or a signal such as a reference signal (RS) including SSB, CSI-RS, or SRS.

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE may assume that SS/PBCH blocks transmitted with the same block index on the same center frequency location are quasi co-located with respect to Doppler spread, Doppler shift, average gain, average delay, delay spread, and, when applicable, spatial Rx parameters. The UE shall not assume quasi co-location for any other SS/PBCH block transmissions.

In absence of CSI-RS configuration, and unless otherwise configured, the ULE may assume PDSCH DM-RS and SS/PBCH block to be quasi co-located with respect to Doppler shift, Doppler spread, average delay, delay spread, and, when applicable, spatial Rx parameters. The UE may assume that the PDSCH DM-RS within the same code-division multiplexing (CDM) group are quasi co-located with respect to Doppler shift, Doppler spread, average delay, delay spread, and spatial Rx. The UE may also assume that demodulation reference signal (DM-RS) ports associated with a PDSCH are QCL with QCL Type A, Type D (when applicable) and average gain. The UE may further assume that no DM-RS collides with the SS/PBCH block.

A UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-co-location (QCL) relationship between one or two downlink reference signals and the DMRS ports of the PDSCH, the DMRS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives a MAC-CE activation command to map up to N, e.g., N=8 TCI states to the codepoints of the DCI field ‘Transmission Configuration Indication’. When the HARQ-ACK information corresponding to the PDSCH carrying the (MAC-CE) activation command is transmitted in slot n, the indicated mapping between TCI states and codepoints of the DCI field ‘Transmission Configuration Indication’ should be applied after a MAC-CE application time, e.g., starting from the first slot that is after slot n+3Nₛₗₒₜ^{subframe,μ} where Nₛₗₒₜ^{subframe,μ} is a number of slot per subframe for subcarrier spacing (SCS) configuration p.

Independent of the configuration of tci-PresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’:
The UE may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).
If a UE is configured with enableDefaultTCIStatePerCoresetPoolIndex and the UE is configured by higher layer parameter PDCCH-Config that contains two different values of coresetPoolIndex in different ControlResourceSets:
   The UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same coresetPoolIndex, the UE is expected to prioritize the reception of PDCCH associated with that CORESET. This also applies to the intra-band CA case (when PDSCH and the CORESET are in different component carriers).
If a UE is configured with enableTwoDefaultTCI-States and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, and the offset between the reception of the DL DCI and the first PDSCH transmission occasion is less than the threshold timeDurationForQCL, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers)
In all cases above, if none of configured TCI states for the serving cell of scheduled PDSCH is configured with qcl-Type set to ‘typeD’, the UE shall obtain the other QCL assumptions from the indicated TCI states for its scheduled PDSCH irrespective of the time offset between the reception of the DL DCI and the corresponding PDSCH.

If the PDCCH carrying the scheduling DCI is received on one component carrier, and the PDSCH scheduled by that DCI is on another component carrier:
The timeDurationForQCL is determined based on the subcarrier spacing of the scheduled PDSCH. If μ_{PDCCH}<μ_{PDSCH} an additional timing delay

$$d \frac{{2}^{{μ}_{PDSCH}}}{{2}^{{μ}_{PDCCH}}}$$

is added to the timeDurationForQCL, where d is defined in 5.2.1.5.1a-1, otherwise d is zero;
For both the cases, when the UE is configured with enableDefaultBeamForCCS, and when the offset between the reception of the DL DCI and the corresponding PDSCH is less than the threshold timeDurationForQCL, and when the DL DCI does not have the TCI field present, the UE obtains its QCL assumption for the scheduled PDSCH from the activated TCI state with the lowest ID applicable to PDSCH in the active BWP of the scheduled cell.

For PUSCH scheduled by DCI format 0_0 on a cell, if the higher layer parameter enableDefaultBeamPL-ForPUSCH0-0 is set ‘enabled’, the UE is not configured with physical uplink control channel (PUCCH) resources on the active UL BWP and the UE is in RRC connected mode. The UE shall transmit PUSCH according to the spatial relation, if applicable, with a reference to the RS configured with qcl-Type set to ‘typeD’ corresponding to the QCL assumption of the CORESET with the lowest ID on the active DL BWP of the cell.

For PUSCH scheduled by DCI format 0_0 on a cell and if the higher layer parameter enableDefaultBeamPL-ForPUSCH0 is set ‘enabled’, the UE is configured with PUCCH resources on the active UL BWP where all the PUCCH resource(s) are not configured with any spatial relation and the UE is in RRC connected mode. The UE shall transmit PUSCH according to the spatial relation, if applicable, with a reference to the RS configured with qcl-Type set to ‘typeD’ corresponding to the QCL assumption of the CORESET with the lowest ID on the active DL BWP of the cell in case CORESET(s) are configured on the cell.

In Carrier Aggregation (CA), two or more Component Carriers (CCs) are aggregated. A UE may simultaneously receive or transmit on one or multiple CCs depending on its capabilities:
A UE with single timing advance capability for CA can simultaneously receive and/or transmit on multiple CCs corresponding to multiple serving cells sharing the same timing advance (multiple serving cells grouped in one TAG).
A UE with multiple timing advance capability for CA can simultaneously receive and/or transmit on multiple CCs corresponding to multiple serving cells with different timing advances (multiple serving cells grouped in multiple TAGs). NG-RAN ensures that each TAG contains at least one serving cell.
A non-CA capable UE can receive on a single CC and transmit on a single CC corresponding to one serving cell only (one serving cell in one TAG).

CA is supported for both contiguous and non-contiguous CCs. When CA is deployed frame timing and system frame number (SFN) are aligned across cells that can be aggregated, or an offset in multiples of slots between the primary cell (PCell/PSCell) and an SCell is configured to the UE. The maximum number of configured CCs for a UE is 16 for DL and 16 for UL.

When CA is configured, the UE only has one RRC connection with the network 130. At RRC connection establishment/re-establishment/handover, one serving cell provides the non access stratum (NAS) mobility information and at RRC connection re-establishment/handover, one serving cell provides the security input. This cell is referred to as the Primary Cell (PCell). Depending on UE capabilities, Secondary Cells (SCells) can be configured to form together with the PCell a set of serving cells. The configured set of serving cells for a UE therefore includes one PCell and one or more SCells.

The reconfiguration, addition, and removal of SCells can be performed by RRC. At intra-NR handover and during connection resume from RRC_INACTIVE, the network 130 can also add, remove, keep, or reconfigure SCells for usage with the target PCell. When adding a new SCell, dedicated RRC signalling is used for sending all required system information of the SCell i.e., while in connected mode, UEs need not acquire broadcast system information directly from the SCells.

To enable reasonable UE battery consumption when CA is configured, an activation/deactivation mechanism of Cells is supported. When an SCell is deactivated, the UE does not need to receive the corresponding PDCCH or PDSCH and cannot transmit in the corresponding uplink nor is it required to perform channel quality indicator (CQI) measurements. Conversely, when an SCell is active, the UE shall receive PDSCH and PDCCH (if the UE is configured to monitor PDCCH from this SCell) and is expected to be able to perform CQI measurements. NG-RAN ensures that while PUCCH SCell (a Secondary Cell configured with PUCCH) is deactivated, SCells of secondary PUCCH group (a group of SCells whose PUCCH signalling is associated with the PUCCH on the PUCCH SCell) should not be activated. NG-RAN ensures that SCells mapped to PUCCH SCell are deactivated before the PUCCH SCell is changed or removed.

When reconfiguring the set of serving cells:
SCells added to the set are initially activated or deactivated.
SCells which remain in the set (either unchanged or reconfigured) do not change their activation status (activated or deactivated).

At handover or connection resume from RRC_INACTIVE:
SCells are activated or deactivated.

To enable reasonable UE battery consumption when BA is configured, only one UL BWP for each uplink carrier and one DL BWP or only one DL/UL BWP pair can be active at a time in an active serving cell, all other BWPs that the UE is configured with being deactivated. On deactivated BWPs, the UE does not monitor the PDCCH, does not transmit on PUCCH, physical random-access channel (PRACH) and UL-SCH.

To enable fast SCell activation when CA is configured, one dormant BWP can be configured for an SCell. If the active BWP of the activated SCell is a dormant BWP, the UE stops monitoring PDCCH and transmitting SRS/PUSCH/PUCCH on the SCell but continues performing CSI measurements, AGC and beam management, if configured. A DCI is used to control entering/leaving the dormant BWP for one or more SCell(s) or one or more SCell group(s).

The dormant BWP is one of the UE's dedicated BWPs configured by network via dedicated RRC signalling. The SpCell and PUCCH SCell cannot be configured with a dormant BWP.

Cross-carrier scheduling with the Carrier Indicator Field (CIF) allows the PDCCH of a serving cell to schedule resources on another serving cell but with the following restrictions:
Cross-carrier scheduling does not apply to PCell i.e., PCell is scheduled via its PDCCH.
When an SCell is configured with a PDCCH, that cell's PDSCH and PUSCH are scheduled by the PDCCH on this SCell.
When an SCell is not configured with a PDCCH, that SCell's PDSCH and PUSCH are scheduled by a PDCCH on another serving cell.
The scheduling PDCCH and the scheduled PDSCH/PUSCH can use the same or different numerologies.

Some of the restrictions may be relaxed. For example, dynamic spectrum sharing (DSS) allows LTE and NR to share the same carrier. As the number of NR devices in a network increases, it is important that sufficient scheduling capacity for NR UEs on the shared carriers is ensured. In the case of DSS operation, PDCCH enhancements for cross-carrier scheduling including can be considered such that PDCCH of an SCell, referred to as a special/scheduling SCell (sSCell), can schedule PDSCH or PUSCH on the P(S)Cell.

The Physical Downlink Control Channel (PDCCH) can be used to schedule DL transmissions on PDSCH and UL transmissions on PUSCH, where the Downlink Control Information (DCI) on PDCCH includes:
Downlink assignments containing at least modulation and coding format, resource allocation, and hybrid-ARQ information related to DL-SCH.
Uplink scheduling grants containing at least modulation and coding format, resource allocation, and hybrid-ARQ information related to UL-SCH.

In addition to scheduling, PDCCH can be used for
Activation and deactivation of configured PUSCH transmission with configured grant.
Activation and deactivation of PDSCH semi-persistent transmission.
Notifying one or more UEs of the slot format.
Notifying one or more UEs of the physical resource block(s) (PRB(s)) and OFDM symbol(s) where the UE may assume no transmission is intended for the UE.
Transmission of transmit power control (TPC) commands for PUCCH and PUSCH.
Transmission of one or more TPC commands for SRS transmissions by one or more UEs.
Switching a UE's active bandwidth part.
Initiating a random-access procedure.
Indicating the UE(s) to monitor the PDCCH during the next occurrence of the discontinuous reception (DRX) on-duration.
In integrated access and backhaul (IAB) context, indicating the availability for soft symbols of an IAB-distributed unit (DU).

A UE monitors a set of PDCCH candidates in the configured monitoring occasions in one or more configured COntrol REsource SETs (CORESETs) according to the corresponding search space configurations.

A CORESET consists of a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCE. Different code rates for the control channels are realized by aggregating different number of CCE. Interleaved and non-interleaved CCE-to-REG mapping are supported in a CORESET.

Polar coding is used for PDCCH. Each resource element group carrying PDCCH carries its own DMRS. QPSK modulation is used for PDCCH.

A UE monitors a set of PDCCH candidates in one or more CORESETs on the active DL BWP on each activated serving cell configured with PDCCH monitoring according to corresponding search space sets where monitoring implies decoding each PDCCH candidate according to the monitored DCI formats.

In the downlink, the gNB can dynamically allocate resources to UEs via the cell RNTI (C-RNTI) on PDCCH(s). A UE monitors the PDCCH(s) in order to find assignments when its downlink reception is enabled (activity governed by DRX when configured). When CA is configured, the same C-RNTI applies to all serving cells.

The gNB 102 may pre-empt an ongoing PDSCH transmission to one UE with a latency-critical transmission to another UE. The gNB 102 can configure UEs to monitor interrupted transmission indications using INT-RNTI on a PDCCH. If a UE receives the interrupted transmission indication, the UE may assume that no useful information to that UE was carried by the resource elements included in the indication, even if some of those resource elements were already scheduled to this UE.

In addition, with Semi-Persistent Scheduling (SPS), the gNB 102 can allocate downlink resources for the initial HARQ transmissions to UEs. RRC defines the periodicity of the configured downlink assignments while PDCCH addressed to CS-RNTI can either signal and activate the configured downlink assignment, or deactivate it, i.e., a PDCCH addressed to CS-RNTI indicates that the downlink assignment can be implicitly reused according to the periodicity defined by RRC, until deactivated. When required, retransmissions are explicitly scheduled on PDCCH(s).

The dynamically allocated downlink reception overrides the configured downlink assignment in the same serving cell if they overlap in time. Otherwise, a downlink reception according to the configured downlink assignment is assumed, if activated.

The UE may be configured with up to 8 active configured downlink assignments for a given BWP of a serving cell. When more than one is configured:
The network 130 decides which of these configured downlink assignments are active at a time (including all of them); and
Each configured downlink assignment is activated separately using a DCI command and deactivation of configured downlink assignments is done using a DCI command, which can either deactivate a single configured downlink assignment or multiple configured downlink assignments jointly.

PUSCH may be scheduled with DCI on PDCCH, or a semi-static configured grant may be provided over RRC, where two types of operation are supported:
The first PUSCH is triggered with a DCI, with subsequent PUSCH transmissions following the RRC configuration and scheduling received on the DCI; or
The PUSCH is triggered by data arrival to the UE's transmit buffer and the PUSCH transmissions follow the RRC configuration.

In the uplink, the gNB 102 can dynamically allocate resources to UEs via the C-RNTI on PDCCH(s). A UE monitors the PDCCH(s) in order to find grants for uplink transmission when its downlink reception is enabled (activity governed by DRX when configured). When CA is configured, the same C-RNTI applies to all serving cells.

The gNB 102 may cancel a PUSCH transmission, or a repetition of a PUSCH transmission, or an SRS transmission of a UE for another UE with a latency-critical transmission. The gNB 102 can configure UEs to monitor cancelled transmission indications using cancellation indication RNTI (CI-RNTI) on a PDCCH. If a UE receives the cancelled transmission indication, the UE shall cancel the PUSCH transmission from the earliest symbol overlapped with the resource or the SRS transmission overlapped with the resource indicated by cancellation.

In addition, with Configured Grants, the gNB 102 can allocate uplink resources for the initial HARQ transmissions and HARQ retransmissions to UEs. Two types of configured uplink grants are defined:
With Type 1, RRC directly provides the configured uplink grant (including the periodicity).
With Type 2, RRC defines the periodicity of the configured uplink grant while PDCCH addressed to CS-RNTI can either signal and activate the configured uplink grant, or deactivate it, i.e., a PDCCH addressed to CS-RNTI indicates that the uplink grant can be implicitly reused according to the periodicity defined by RRC, until deactivated.

If the UE is not configured with enhanced intra-UE overlapping resources prioritization, the dynamically allocated uplink transmission overrides the configured uplink grant in the same serving cell if they overlap in time. Otherwise, an uplink transmission according to the configured uplink grant is assumed, if activated.

If the UE is configured with enhanced intra-UE overlapping resources prioritization, in case a configured uplink grant transmission overlaps in time with dynamically allocated uplink transmission or with another configured uplink grant transmission in the same serving cell, the UE prioritizes the transmission based on the comparison between the highest priority of the logical channels that have data to be transmitted and which are multiplexed or can be multiplexed in MAC protocol data unit (PDUs) associated with the overlapping resources. Similarly, in case a configured uplink grant transmissions or a dynamically allocated uplink transmission overlaps in time with a scheduling request transmission, the UE prioritizes the transmission based on the comparison between the priority of the logical channel which triggered the scheduling request and the highest priority of the logical channels that have data to be transmitted and which are multiplexed or can be multiplexed in MAC PDU associated with the overlapping resource. In case the MAC PDU associated with a deprioritized transmission has already been generated, the UE keeps it stored to allow the gNB 102 to schedule a retransmission. The UE may also be configured by the gNB 102 to transmit the stored MAC PDU as a new transmission using a subsequent resource of the same configured uplink grant configuration when an explicit retransmission grant is not provided by the gNB 102.

Retransmissions other than repetitions are explicitly allocated via PDCCH(s) or via configuration of a retransmission timer.

The UE may be configured with up to 12 active configured uplink grants for a given BWP of a serving cell. When more than one is configured, the network 130 decides which of these configured uplink grants are active at a time (including all of them). Each configured uplink grant can either be of Type 1 or Type 2. For Type 2, activation and deactivation of configured uplink grants are independent among the serving cells. When more than one Type 2 configured grant is configured, each configured grant is activated separately using a DCI command and deactivation of Type 2 configured grants is done using a DCI command, which can either deactivate a single configured grant configuration or multiple configured grant configurations jointly.

When supplemental UL (SUL) is configured, the network 130 should ensure that an active configured uplink grant on SUL does not overlap in time with another active configured uplink grant on the other UL configuration.

For both dynamic grant and configured grant, for a transport block, two or more repetitions can be in one slot, or across slot boundary in consecutive available slots with each repetition in one slot. For both dynamic grant and configured grant Type 2, the number of repetitions can be also dynamically indicated in the L1 signalling. The dynamically indicated number of repetitions shall override the RRC configured number of repetitions, if both are present.

In Multiple Transmit/Receive Point (multi-TRP) operation, a serving cell can schedule UE from two TRPs, providing better PDSCH coverage, reliability and/or data rates.

There are two different operation modes for multi-TRP: single-DCI and multi-DCI. For both modes, control of uplink and downlink operation is done by both physical layer and MAC. In single-DCI mode, UE is scheduled by the same DCI for both TRPs and in multi-DCI mode, UE is scheduled by independent DCIs from each TRP.

HARQ operation is supported for DL reception. Asynchronous Incremental Redundancy HARQ is supported. The gNB 102 provides the UE with the HARQ-ACK feedback timing either dynamically in the DCI or semi-statically in an RRC configuration. Retransmission of HARQ-ACK feedback is supported for operation with shared spectrum channel access by using enhanced dynamic codebook and/or one-shot triggering of HARQ-ACK transmission for all configured CCs and HARQ processes in the PUCCH group. The UE may be configured to receive code block group-based transmissions where retransmissions may be scheduled to carry a sub-set of all the code blocks of a transport block (TB).

HARQ operation is supported for UL transmission. Asynchronous Incremental Redundancy HARQ is supported. The gNB 102 schedules each uplink transmission and retransmission using the uplink grant on DCI. For operation with shared spectrum channel access, UE can also retransmit on configured grants. The UE may be configured to transmit code block group-based transmissions where retransmissions may be scheduled to carry a sub-set of all the code blocks of a transport block.

Up to two HARQ-ACK codebooks corresponding to a priority (high/low) can be constructed simultaneously. For each HARQ-ACK codebook, more than one PUCCH for HARQ-ACK transmission within a slot is supported. Each PUCCH is limited within one sub-slot, and the sub-slot pattern is configured per HARQ-ACK codebook.

The HARQ functionality ensures delivery between peer entities at Layer 1. A single HARQ process supports one TB when the physical layer is not configured for downlink/uplink spatial multiplexing, and when the physical layer is configured for downlink/uplink spatial multiplexing, a single HARQ process supports one or multiple TBs.

In case of CA, the multi-carrier nature of the physical layer is only exposed to the MAC layer for which one HARQ entity is required per serving cell. In both uplink and downlink, there is one independent HARQ entity per serving cell and one transport block is generated per assignment/grant per serving cell in the absence of spatial multiplexing. Each transport block and its potential HARQ retransmissions are mapped to a single serving cell.

Physical uplink control channel (PUCCH) carries the Uplink Control Information (UCI) from the UE to the gNB 102. UCI includes at least hybrid automatic request acknowledgement (HARQ-ACK) information, scheduling request (SR), and channel state information (CSI).

Various embodiments are described in terms of multiple PDSCHs or multiple PUSCHs that are jointly scheduled on multiple serving cells, such as a subset/set of cells from among one or more sets of co-scheduled cells.

The embodiments are generic and can apply to various other scenarios such as when a UE is jointly scheduled to receive/transmit multiple PDSCHs/PUSCHs:
from/to multiple transmission-reception points (TRPs) or other communication entities, such as multiple distributed units (DUs) or multiple remote radio heads (RRHs) and so on, for example, in a distributed MIMO operation, wherein TRPs/DUs/RRHs can be associated with one or more cells; or
in multiple time units, such as multiple slots or multiple transmission time intervals (TTIs); or
on multiple BWPs associated with one or more cells/carriers/TRPs, including multiple BWPs of a single serving cell/carrier for a UE with a capability of reception/transmission on multiple active BWPs; or
on one or more TRPs/cells, wherein the UE can receive/transmit more than one PDSCH/PUSCH on each co-scheduled TRP/cell; or
for multiple transport blocks (TBs), or for multiple codewords (CWs) corresponding to single TB or multiple TBs; or
for multiple semi-persistently scheduled PDSCHs (SPS PDSCHs) or for multiple configured grant PUSCHs (CG PUSCHs) that are jointly activated on one or multiple TRPs/cells.

Accordingly, any reference to “co-scheduled cells” can be replaced with/by “co-scheduled TRPs/DUs/RRHs”, or “co-scheduled slots/TTIs”, or “co-scheduled BWPs”, or “co-scheduled PDSCHs/PUSCHs”, or “co-scheduled TBs/CWs”, or “co-scheduled SPS-PDSCHs/CG-PUSCHs”, and so on. Similar for other related terms, such as “multi-cell scheduling”, and so on.

Various embodiments evaluate reception of multiple PDSCHs or transmission of multiple PUSCHs on respective cells, including carriers of a same cell such as on an UL carrier (also referred to as, a normal UL (NUL) carrier) or a supplemental UL (SUL) carrier. The embodiments also apply to cases where scheduling is for a mixture of PDSCHs and PUSCHs. For example, the UE can receive first PDSCHs on respective first cells and can transmit second PUSCHs on respective second cells, wherein the first PDSCHs and the second PUSCHs are jointly scheduled.

In various embodiments, the phrase “a UE configured with multi-cell scheduling” refers to a UE that is configured joint scheduling for at least one set of co-scheduled cells.

In various embodiments, the phrase “scheduled PDSCH” refers to a PDSCH that is scheduled/indicated by a DCI format, regardless of whether the PDSCH is received or not yet.

In one embodiment, a UE can be provided a number of sets of co-scheduled cells by higher layers. The term set of co-scheduled cells is used to refer to a set of serving cells wherein the UE can be scheduled PDSCH receptions or PUSCH transmissions on two or more cells from the set of co-scheduled cells by a single DCI format, or by using complementary methods such as described in one or more embodiments herein. Additionally, the UE can be indicated via a DCI format in a PDCCH or via a MAC CE in a PDSCH a subset of a set of co-scheduled cells, wherein cells of the subset can change across different PDCCH monitoring occasions, for example, as indicated by a corresponding DCI format.

In one example, multi-cell scheduling can also include operations related to DL/UL transmissions such as reporting HARQ-ACK information, beam/CSI measurement or reporting, transmission, or reception of UL/DL reference signals, and so on.

In one example, the UE can be configured by higher layers, such as by a UE-specific RRC configuration, a number of sets of co-scheduled cells. For example, the UE can be configured a first set of cells, such as {cell #0, cell #1, cell #4, cell #7} and a second set {cell #2, cell #3, cell #5, cell #6}. The multiple sets of co-scheduled cells can be scheduled from a same scheduling cell or from different scheduling cells.

In one example, a set of co-scheduled cells can include a primary cell (PCell/PSCell) and one or more SCells. In another example, a set of co-scheduled cells can include only SCells. In one example, a scheduling cell can belong to a set of co-scheduled cells. In another example, the UE does not expect that a scheduling cell belongs to a set of co-scheduled cells.

In one example, per specifications of the system operation, a set of co-scheduled cells is defined as a set that includes all scheduled cells having a same scheduling cell, and additional higher layer configuration is not required for indication of the set of co-scheduled cells. Accordingly, a DCI format for multi-cell scheduling, or other complementary methods, can jointly schedule any number of scheduled cells that have a same scheduling cell.

In another example, a set of co-scheduled cells can have two or more scheduling cells. For example, a UE can receive a DCI format for scheduling multiple co-scheduled cells on a first scheduling cell in a first PDCCH monitoring occasion, or on a second scheduling cell in a second PDCCH monitoring occasion. The DCI format can be associated with any search space set or can be restricted to be associated with UE-specific search space (USS) sets. For example, the DCI format can be associated with multicast scheduling and have CRC scrambled by a group RNTI (G-RNTI) and PDCCH candidates monitored according to common search space (CSS) sets, or can be associated with unicast scheduling and have CRC scrambled by a C-RNTI and PDCCH candidates monitored according to USS sets. Such PDCCH monitoring from two scheduling cells can be simultaneous, for example in a same span of symbol or in a same slot, or can be non-overlapping, such as in different slots (per higher layer configuration, or per indication in a PDCCH or via a MAC CE). The UE may or may not expect that both the first scheduling cell and the second scheduling cell can schedule, through PDCCH transmissions in a same time interval such as a span or a slot, transmissions or receptions on a same cell. The UE can also monitor PDCCH for detection of a DCI format providing scheduling only on one cell from the set of co-scheduled cells (single-cell scheduling DCI format).

A UE can report one or more of: a maximum number of sets of co-scheduled cells, or a maximum number of cells within a set of co-scheduled cells, or a maximum total number of co-scheduled cells across different sets, or a maximum number of co-scheduled cells per PDCCH monitoring occasion, as capability to the gNB 102. In one example, that capability can depend on an operating frequency band or on a frequency range such as above or below 6 GHz.

Multi-cell scheduling can be an optional UE feature with capability signaling that can additionally be separate for PDSCH receptions and for PUSCH transmissions. For example, a UE can report a capability for a maximum number of {2, 4, 8, 16} co-scheduled cells for the DL and a maximum of {2, 4} co-scheduled cells for the UL.

A UE can also be configured a number of cells that do not belong to any of set of co-scheduled cells. For example, the UE can be configured a cell #8 that does not belong to either the first set or the second set of co-scheduled cells in the previous example.

In one example, restrictions can apply for co-scheduled cells and a UE can expect that co-scheduled cells in a corresponding set:
have a same numerology (SCS configuration and CP); or
have a same numerology for respective active DL/UL BWPs; or
have a same duplex configuration. For example, all cells have frequency division duplexing (FDD) configuration, or all cells have time division duplexing (TDD) configuration and, in case of a TDD configuration, also have a same UL-DL configuration; or
are within a same frequency band (intra-band CA).

A serving cell can belong only to a single set of co-scheduled cells so that the sets of co-scheduled cells do not include any common cell or can belong to multiple sets of co-scheduled cells to enable larger scheduling flexibility to a serving gNB. For example, a serving cell can belong to a first set of co-scheduled cells and to a second set of co-scheduled cells, when cells in the first and second sets of co-scheduled cells have a common feature such as a common numerology, duplex configuration, operating frequency band/range, and so on. Also, a serving cell can belong to both a first set of co-scheduled cells and to a second set of co-scheduled cells, when the serving cell has a first common feature with cells in the first set of co-scheduled cells and a second common feature with cells in the second set of co-scheduled cells, wherein the first common feature can be different from the second common feature.

In a first approach, a UE expects to be provided multi-cell scheduling for all cells in a set of co-scheduled cells. For example, for a first set of co-scheduled cells including cells {cell #0, cell #1, cell #4, cell #7}, a DCI format schedules PDSCH receptions or PUSCH transmissions on all four cells in the first set of co-scheduled cells {cell #0, cell #1, cell #4, cell #7}.

In a second approach, the UE can be provided multi-cell scheduling for a subset of a set of co-scheduled cells. For example, a DCI format can schedule PDSCH receptions or PUSCH transmissions on only two cells, such as {cell #0, cell #4}, from the first set of cells.

In a first option for the second approach, the subset of cells can be indicated by a MAC CE. Such a MAC CE command can include one or more of: an indication for activation or deactivation/release of a subset of cells; an indication for a number of sets of co-scheduled cells; or an indication for a number of subsets of co-scheduled cells from a corresponding number of sets of co-scheduled cells.

For example, a MAC CE activates a first subset of a set of co-scheduled cells and subsequent DCI format(s) for multi-cell scheduling apply to the first subset of cells activated by the MAC CE. The UE can receive another MAC CE command that deactivates the first subset of co-scheduled cells, or activates a second subset of co-scheduled cells, wherein the second subset can be a subset of the same set of co-scheduled cells or a subset of a different set of co-scheduled cells. If a UE receives a MAC CE that deactivates the first subset of co-scheduled cells, but does not activate a second subset of co-scheduled cells, in one alternative, the UE does not expect to receive a DCI format for multi-cell scheduling and the UE may not monitor PDCCH according to respective search space sets until the UE receives a new MAC CE that activates a second subset of co-scheduled cells. In another alternative, the UE can receive DCI format(s) for multi-cell scheduling even before receiving a new MAC CE that activates a second subset of co-scheduled cells, but the UE expects to be provided an indication for a subset of co-scheduled cells by the DCI format(s), or by using complementary methods, such as described in one or more embodiments herein, for multi-cell scheduling.

In a second option for the second approach, the subset of the set of co-scheduled cells can be provided by a DCI format in a PDCCH/PDSCH. The subset of cells can change between PDCCH monitoring occasions (MOs) for PDSCH/PUSCH scheduling as indicated by a corresponding DCI format. For example, a first DCI format in a first PDCCH MO indicates scheduling on a first subset of cells, while a second DCI format in a second PDCCH MO indicates scheduling on a second subset of cells.

In a first example, a DCI format for multi-cell scheduling provides an index for a subset of cells that are co-scheduled such as a CIF value that corresponds to a subset of one or more cells from a set of co-scheduled cells. For example, UE-specific RRC signaling can indicate first/second/third/fourth indexes and corresponding first/second/third/fourth subsets that include one or more cells from a set of co-scheduled cells, wherein a subset can also include all cells from the set of co-scheduled cells. Then, a CIF field of 2 bits in a DCI format can provide a value that indicates the subset of scheduled cells.

In a second example, a DCI format can include a 1-bit flag field to indicate whether the DCI format is for single-cell scheduling or for multi-cell scheduling in order for a UE to accordingly interpret fields of the DCI format that may also include the CIF field. Then, for single-cell scheduling, the CIF field can be interpreted as in case of single-cell cross-carrier scheduling while for multi-cell scheduling the CIF field can be interpreted as indicating a subset from the set of co-scheduled cells.

In a third example, a DCI format for multi-cell scheduling provides a number of co-scheduled cells and the indexes of the co-scheduled cells are provided by additional methods, such as by an additional DCI format (or an additional part/stage of a same DCI format) or by higher layer signaling as described in one or more embodiments herein.

In a fourth example, a CIF field in a DCI format for multi-cell scheduling can be a bitmap mapping to the individual cells or subsets of cells from the set of co-scheduled cells. When the DCI format is applicable to all cells in the set of co-scheduled cells, the DCI format may not include a CIF.

In a third option for the second approach, a UE can implicitly determine indexes for co-scheduled cells without need for explicit gNB indication. For example, the UE can determine indexes for co-scheduled cells based on a PDCCH monitoring parameter, such as:
a CORESET index; or
a search space set index, or a carrier indicator parameter n_CI corresponding to the search space set index; or
a set of CCEs in the search space set or a first/last CCE in the search space set;
   where the UE received a PDCCH providing the DCI format for multi-cell scheduling.

According to the third option, the UE can be configured a mapping among values for PDCCH monitoring parameters, such as search space sets, and a number of co-scheduled cells or indexes of the co-scheduled cells. In one example, first and second values for parameter n_CI in a search space set can respectively indicate first and second subsets of co-scheduled cells. According to this example, the parameter n_CI can correspond to a single cell or can correspond to a group of cells, such as a subset/set of co-scheduled cells.

Receptions or transmissions on a respective subset of cells that are jointly scheduled by a single DCI format, or by using complementary methods such as in one or more embodiments described herein, can refer to PDSCHs or PUSCHs that may or may not overlap in time. For example, the UE can be indicated to receive PDSCHs or to transmit PUSCHs on respective co-scheduled cells wherein all receptions/transmissions are in a same slot or at least one reception/transmission is in a different slot than the remaining ones.

A UE that is configured for multi-cell scheduling can be provided a first set of cell-common parameters whose values apply for scheduling on all co-scheduled cells, and a second set of cell-specific parameters whose values apply for scheduling on each corresponding co-scheduled cell. The UE can determine cell-common and cell-specific scheduling information parameters based on the specifications of the system operation or based on higher layer configuration. For some cell-specific scheduling information parameters, the UE can be provided differential values compared to a reference value wherein the reference value can correspond, for example, to a first scheduled cell from a set of scheduled cells.

For a UE that is configured a number of sets of co-scheduled cells, a DCI format for multi-cell scheduling can provide complete or partial information for cell-common or cell-specific scheduling parameters, for multiple PDSCH receptions or multiple PUSCH transmissions on respective multiple co-scheduled cells. When the DCI format for multi-cell scheduling provides partial information for a scheduling parameter, the UE can determine remaining information from UE-specific RRC signaling or by other complementary methods.

In one embodiment, the UE can distinguish a single-cell scheduling DCI format from a multi-cell scheduling DCI format via various methods, such as a DCI format size, or an RNTI used for scrambling a CRC of a DCI format for multi-cell scheduling, or by an explicit indication by a field in the DCI format, or by a dedicated CORESET and associated search space sets.

For a UE that is configured a set of co-scheduled cells, a DCI format for multi-cell scheduling can provide full or partial information for values of cell-common and cell-specific fields for scheduling PDSCH receptions or PUSCH transmissions on respective two or more cells from the set of co-scheduled cells. When the DCI format provides partial information, the UE can determine remaining information from RRC signaling or by using other complementary methods.

In a first approach, referred to as concatenated DCI format for multi-cell scheduling, a DCI format for multi-cell scheduling can provide separate values of fields for each of the multiple co-scheduled cells. A first value corresponds to a first cell, a second value corresponds to a second cell, and so on. Therefore, DCI format fields for the multiple cells are concatenated, thereby referring to such DCI format as a concatenated DCI format for multi-cell scheduling. This approach can be beneficial, for example, for co-scheduling cells that have different channel characteristics or configurations, such as for inter-band CA operation, or for co-scheduling a PDSCH reception and a PUSCH transmission.

In a second approach, referred to as multi-cell scheduling via multi-cell mapping, a UE can be provided information for multi-cell scheduling of multiple PDSCHs/PDCCHs on multiple respective cells using a multi-cell mapping, wherein a field in a DCI format can be interpreted to provide multiple values for a corresponding scheduling parameter for the multiple co-scheduled cells. Such interpretation can be based on a configured one-to-many mapping/table or based on multiple configured offset values for respective cells that are applied to a reference value indicated by the DCI format. For example, the field can be an MCS field wherein a value indicated in the DCI format can be for a PDSCH reception on a first cell and a value for a PDSCH reception on a second cell can be determined from the first value and a configured offset value. This approach can be beneficial, for example, for co-scheduling cells that have several similar physical channel characteristics or configurations, such as for intra-band CA operation.

In a third approach, referred to as single-cell DCI pointing to a PDSCH with multi-cell scheduling, a UE can be provided information for multi-cell scheduling using a single-cell scheduling DCI format, namely a DCI format that schedules a first PDSCH on a first cell, wherein the first PDSCH includes scheduling information for reception of second PDSCH(s) or transmission of second PUSCH(s) on a subset from one or more sets of co-scheduled cells. This approach can be beneficial, for example, for co-scheduling several (such as 4-8) cells that have different channel characteristics or configurations, such as for inter-band CA operation.

In a first option for the third approach, the first PDSCH includes a MAC CE that provides scheduling information for the number of PDSCH(s) or PUSCH(s). Accordingly, the MAC CE can include a number of modified DCIs (M-DCIs), wherein each M-DCI includes full or partial scheduling information for a PDSCH/PUSCH from the number of PDSCH(s)/PUSCH(s).

In a second option for the third approach, multi-cell scheduling information is multiplexed as M-DCI in a PDSCH. The UE receives a first PDSCH that is scheduled by a single-cell scheduling DCI format and the UE receives additional scheduling information for one or more PDSCH(s)/PUSCH(s) on one or more respective co-scheduled cell(s). The UE allocates the coded modulation symbols for M-DCIs to time/frequency resources within the first PDSCH, for example in a frequency-first, time-second manner, except for reserved resources corresponding to reference signals or other cell-level broadcast transmissions. The UE can start receiving the M-DCIs in a first symbol of the first PDSCH, or in a first symbol after first symbols with DM-RS REs, in the first PDSCH. The M-DCIs can be jointly coded and include a single CRC.

In the second option, physical layer processing of M-DCI(s) that are included in the first PDSCH can be same as that for a DCI in a PDCCH, such as for the DCI scheduling the first PDSCH, or can be same as that for data information/transport block in the first PDSCH. For example, physical layer processing refers to, for example, modulation, coding, scrambling, and so on. In addition, the UE can determine a number of coded modulation symbols corresponding to multi-scheduling information, such as M-DCIs, that are multiplexed in a first PDSCH scheduled by a single-cell scheduling DCI format, based on a scaling factor β_{offset}^{PDSCH}=β_{offset}^{M-DCI} applied to a total (coded) payload size for the M-DCIs. Such scaling factor determines an effective channel coding rate of M-DCIs multiplexed on the first PDSCH for flexible link adaptation and improved reliability of the M-DCIs according to physical channel conditions.

In a fourth approach, referred to as multi-stage PDCCHs/DCIs for multi-cell scheduling, a UE can be provided information for multi-cell scheduling of multiple PDSCHs/PDCCHs on multiple respective cells using a multi-stage DCI method, such as a 2-stage DCI wherein a first-stage DCI format includes a set of cell-common fields, and a second-stage DCI format includes cell-specific fields. The UE receives the first-stage DCI format in a first PDCCH and the second-stage DCI format in a second PDCCH. This approach can be beneficial, for example, for co-scheduling several cells that have several common physical characteristics, such as a time-domain resource allocation or a frequency-domain resource allocation, without incurring latency and without having a DCI format size that is too large (that would result if the first-stage and second-stage DCI formats were combined into a single DCI format) for receiving cell-specific parameters when the second PDCCH is received in a same slot as the first PDCCH. The first-stage DCI format can also indicate a location for a PDCCH providing the second-stage DCI format, such as a PDCCH candidate for a corresponding CCE aggregation level, so that the UE can interpret the contents of the second-stage DCI format or reduce a number of PDCCH receptions. A UE can determine an association among a number of linked multi-stage PDCCHs/DCIs, such as two PDCCHs/DCIs, that provide multi-cell scheduling information based on parameters of the linked DCI formats, such as size(s) of the DCI format(s), or RNTI(s) associated with the DCI format(s), or by an explicit indication in some field(s) in the DCI format(s), or based on PDCCH monitoring parameters, such as CORESET, search space, CCEs, or monitoring occasions in which the UE receives the first and the second linked PDCCHs.

In one embodiment, the UE can distinguish a single-cell scheduling DCI format from a multi-cell scheduling DCI format via various methods, such as a DCI format size, or an RNTI used for scrambling a CRC of a DCI format for multi-cell scheduling, or by an explicit indication by a field in the DCI format, or by a dedicated CORESET and associated search space sets. There can be two cases for monitoring a DCI format for multi-cell scheduling: a first case based on search space set(s) dedicated to multi-cell scheduling, and a second case based on search space set(s) shared by both single-cell scheduling and multi-cells scheduling.

In a first case, a search space set for multi-cell scheduling is associated only with DCI format(s) for multi-cell scheduling on a set of co-scheduled cells. Such search space sets can correspond to a set-level n_CI value, which can be separate from n_CI values corresponding to search space sets for single-cell scheduling. By monitoring the search space set, the UE can detect a DCI format for scheduling on all scheduled cells or only a subset of scheduled cells from the set of co-scheduled cells. Accordingly, the detected DCI format can include a CIF value that is same as or different from an n_CI value corresponding to the search space set for multi-cell scheduling. The search space set can be commonly configured, thereby linked, on the scheduling cell and on all scheduled cells from the set of co-scheduled cells. The UE can monitor the search space set for multi-cell scheduling when linked search spaces sets on the scheduling cell and at least one scheduled cell from the set co-scheduled cells are configured on corresponding active DL BWPs of the scheduling cell and the at least one scheduled cell.

In a second case, a search space set for multi-cell scheduling is associated with DCI format(s) both for multi-cell scheduling on a set of co-scheduled cells and for single-cell scheduling on a first scheduled cell from the set of co-scheduled cells. Such search space sets correspond to an existing cell-level n_CI value corresponding to the first scheduled cell. By monitoring the search space set, the UE can detect a DCI format for single-cell scheduling on the first scheduled cell with a CIF value that is same as the n_CI value corresponding to the first scheduled cell, or can detect a DCI format for multi-cell scheduling on all scheduled cells or only a subset of scheduled cells from the set of co-scheduled cells, with a set-level CIF value that is different from the n_CI value corresponding to the first scheduled cell. The search space set is commonly configured, thereby linked, on the scheduling cell and only the first scheduled cell, and the UE monitors the linked search space sets when both are configured on active DL BWPs of the scheduling cell and the first scheduled cell.

In one example, a UE can be configured multiple sets of cells for multi-cell scheduling of PDSCHs/PUSCHs by a DCI format 0_3/1_3. For example, each set of cells, from the multiple sets of cells, can include one or more cells. For example, the UE expects that different sets of cells are mutually exclusive, so a cell in a first set of cells cannot be included in a second set of cells. In another example, the UE can be configured two sets of cells that include a same cell. For example, the latter example can be conditioned to occur (only) when the two sets of cells include a same number of cells or correspond to a same maximum number of TBs across different cells or across different cell combinations configured for the set of cells.

For example, the UE can report a capability for a maximum number of sets of cells for multi-cell scheduling. For example, different sets of cells for multi-cell scheduling can correspond to same or different scheduling cell. In one example, each set of cells corresponds to a different scheduling cells, so the UE is configured a single set of cells for each scheduling cell. The latter example can be based on a UE capability that does not support multiple sets of cells for a same scheduling cell. In one example, the UE can be configured a scheduling cell that corresponds to more than one sets of cells. The latter example can be based on a UE capability that supports multiple sets of cells for a same scheduling cell. For example, the UE can report a maximum number of sets of cells that can correspond to each/any scheduling cell.

In one example, when a UE is configured first and second sets of cells for multi-cell scheduling from a same scheduling cell, mixture scheduling among different sets of cells is not supported. For example, a DCI format 0_3/1_3 can schedule PUSCHs/PDSCHs on cells from (only) one set of cells, wherein the UE can determine the one set of cells, for example, based on a cell set indicator field (CSIF or SIF for short) in the DCI format 1_3/0_3. A bit-width of the CSIF is ceil(log 2(N set)), wherein N set is a number of sets of cells for multi-cell scheduling associated with a same scheduling cell. For example, a first DCI format 0_3/1_3 can schedule first PUSCHs/PUSCHs on first cells (only) from a first set of cells and a second DCI format 0_3/1_3 can schedule second PUSCHs/PUSCHs on second cells (only) from a second set of cells. In another example, mixture scheduling among different sets of cells may be supported, for example, subject to LIE capability. For example, a DCI format 0_3/1_3 can schedule both first PUSCHs/PDSCHs on first cells from a first set of cells and second PUSCHs/PDSCHs on second cells from a second set of cells. For example, the DCI format 0_3/1_3 can include two CSIF values with a first CSIF value indicating the first set of cells and a second CSIF value indicating the second set of cells.

In one example, when the UE is configured only a single set of cells associated with a scheduling cell, N set=0, a CSIF is not present in the DCI forma 0_3/1_3 and the UE can determine that any DCI format 0_3/1_3 provided by a PDCCH on the scheduling cell corresponds to the single set of cells.

For example, a DCI format 0_3/1_3 can schedule any cell combination (that is, any subset of cells), from a set of cells, and the UE can determine a co-scheduled cell combination based on, for example, a cell-specific field in DCI format 0_3/1_3, such as an frequency domain resource assignment (FDRA) field, that provides separate values for each cell in the set of cells. For example, a DCI format can schedule only cell combinations (that is, only subset of cells), from a set of cells, that is provided by higher layers for the set for the set of cells. For example, the UE can be configured, for the set of cells, a table/list of cell combinations along with corresponding IDs for the respective cell combinations, and a co-scheduled cell combination indicator field in the DCI format 0_3/1_3 indicates a cell combination for scheduling PUSCHs/PDSCHs by providing an ID corresponding to the cell combination. For example, the co-scheduled cell combination indicator field includes ceiling(log 2(N_cell_combo,s)), wherein N_cell_combo,s is a number of configured cell combinations (or a number of corresponding IDs) for a set of cells with set index s. For example, the UE can be configured separate table/list of cell combinations for DCI format 0_3 for scheduling PUSCHs and for DCI format 1_3 for scheduling PDSCHs. For example, a first set of cells can be configured for DCI format 1_3 and no DCI format 0_3 applies to the set of cells. For example, a second set of cells can be configured for DCI format 0_3 and no DCI format 1_3 applies to the set of cells. For example, a set of cells can be configured both DCI format 0_3 and DCI format 1_3. For example, the UE expects that all sets of cells can be configured both DCI format 0_3 and 1_3.

For example, the UE determines a size of DCI format 0_3 separately for each set of cells for multi-cell scheduling. For example, the UE can determine a first size for a first DCI format 0_3 scheduling PUSCHs on cells from a first set of cells and a second size for a second DCI format 0_3 scheduling PUSCHs on cells from a second set of cells.

For example, the UE determines a size of DCI format 1_3 separately for each set of cells for multi-cell scheduling. For example, the UE can determine a first size for a first DCI format 1_3 scheduling PDSCHs on cells from a first set of cells and a second size for a second DCI format 1_3 scheduling PDSCHs on cells from a second set of cells.

In one example, the UE counts sizes of DCI formats 0_3 and 1_3 corresponding to a set of cells towards a DCI size budget (referred to as, the “3+1” rule) for a reference cell from the set of cells. For example, the reference for the set of cells cell can be the scheduling cell when the scheduling cell is included in the set of cells and search space sets of the DCI format 0_X/1_X is configured only on the scheduling cell. For example, when the search space sets of the DCI format 0_X/1_X are configured on a cell from the set of cells, in addition to the scheduling cell, the reference cell can be the cell on which (linked) search space sets of DCI format 0_X/1_X are configured and are associated with the search space sets of the scheduling cell with the same search space IDs. For example, when the scheduling cell is not included in a set of cells, the UE expects to be configured (linked) search space sets of DCI format 0_X/1_X on (only) one cell from the set of cells.

In one example, the UE can determine a first size for a DCI format 0_3 and a second size for a DCI format 1_3, with the first size different from the second size, when both DCI formats 0_3 and 1_3 correspond to a same set of cells. In one example, the UE applies size alignment between DCI formats 0_3 and 1_3 corresponding to a same set of cells when the DCI size budget (“3+1”) on a reference cell is exceeded after applying DCI size alignment to all single-cell scheduling DCI formats.

In one example, different sets of cells for multi-cell scheduling can correspond to one or more of the following:
separate n_CI values, wherein an n_CI value for the set of cells is same as a value provided as the cell set indicator field (CSIF or SIF) in the DCI format 0_3/1_3; When multiple sets of cells correspond to a same scheduling cell, the UE expects unique/different n_CI values (equivalently, unique/different CSI values) for each set of cells;
separate search space sets (for example, USS sets) for monitoring one or both of DCI formats 0-3/1-3; and/or
separate reference cells for counting DCI format sizes for DCI formats 0_3/1_3, or for counting a number of PDCCH candidates or non-overlapping CCEs corresponding to (search space sets for monitoring) DCI formats 0_3/1_3.

In one example, when a UE is configured multiple set of cells for multi-cell scheduling from a same or different scheduling cells, the UE can monitor a first PDCCH in a first monitoring occasion (MO) for detection of a first DCI format for multi-cell scheduling and can monitor a second PDCCH in the same MO for detection of a second DCI format for multi-cell scheduling, wherein the first and the second DCI formats correspond to cells from same or different sets of cells.

In one example, the UE can receive first and second PDCCHs on first and second scheduling cells in a same PDCCH monitoring occasion (MO), providing first and second DCI formats for multi-cell scheduling, such as first and second DCI formats 13, that schedule first PDSHCs and second PDSCHs on first cells from a first set of cells and second cells from a second set of cells, respectively, such that:
in a first example, the first set and the second set of cells are separate (the corresponding scheduling cells can be same or different); or
in a second example, the first set and the second set of cells are the same (so the corresponding scheduling cell is the same) and the first cells and the second cells are separate; or
in a third example, the first set and the second set of cells are the same (so the corresponding scheduling cell is the same) and the first cells and the second cells share at least one cell.

At least the second and third examples can be based on corresponding UE capabilities.

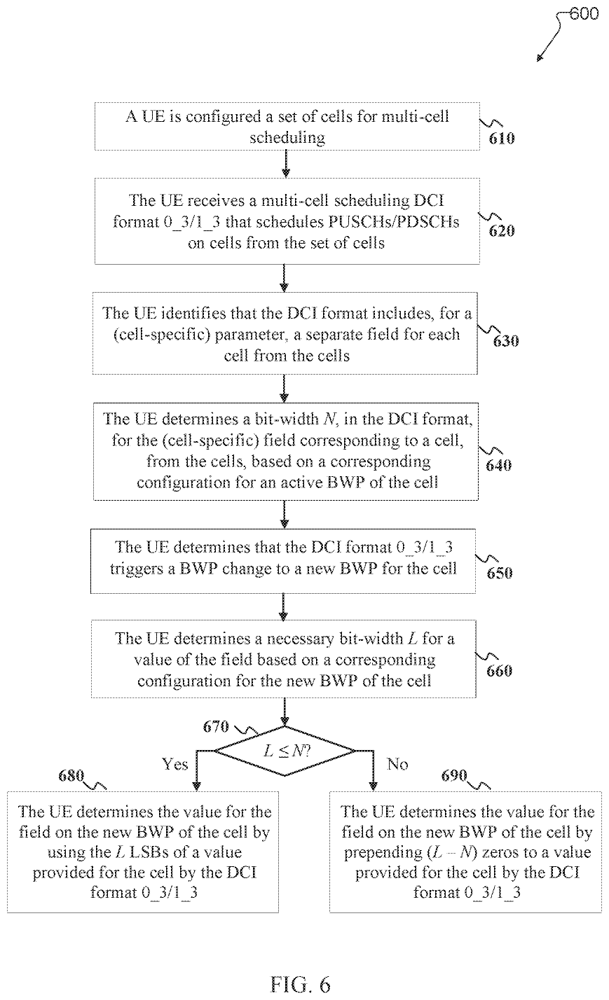

FIG. 6 illustrates a flowchart of an example UE procedure 600 for determining a value for the field on the new BWP of the cell according to embodiments of the present disclosure. For example, procedure 600 for determining a value for the field on the new BWP of the cell can be performed by any of the UEs 111-116 of FIG. 1. This example is for illustration only and other embodiments can be used without departing from the scope of the present disclosure.

The procedure begins in 610, a UE is configured a set of cells for multi-cell scheduling. In 620, the UE receives a multi-cell scheduling DCI format 0_3/1_3 that schedules PUSCHs/PDSCHs on cells from the set of cells. In 630, the UE identifies that the DCI format includes, for a (cell-specific) parameter, a separate field for each cell from the cells. In 640, the UE determines a bit-width N, in the DCI format, for the (cell-specific) field corresponding to a cell, from the cells, based on a corresponding configuration for an active BWP of the cell. In 650, the UE determines that the DCI format 0_3/1_3 triggers a BWP change to a new BWP for the cell. In 660, the UE determines a necessary bit-width L for a value of the field based on a corresponding configuration for the new BWP of the cell. In 670, the UE determines whether or not L≤N. In 680, when the UE determines L≤N, the UE determines the value for the field on the new BWP of the cell by using the L LSBs of a value provided for the cell by the DCI format 0_3/1_3. In 690, when the UE determines L>N, the UE determines the value for the field on the new BWP of the cell by prepending (L−N) zeros to a value provided for the cell by the DCI format 0_3/1_3.

In one embodiment, a size/bit-width of a cell-specific field (also known as, a “Type-2” field), for each cell from cells that are co-scheduled by a multi-cell scheduling DCI format 0_3/1_3, can be a size/bit-width of the field for the active BWP of the cell, or can be a maximum size/bit-width of the field across different configured BWPs of the cell. When the DCI format 0_3/1_3 triggers a BWP change for the cell, the UE determines a value of the field for the new BWP of the cell by using a value of the field that is provided in the DCI format 0_3/1_3 for the active BWP of the cell and truncating from the left (or from the right) or prepending zeros if a corresponding size/bit-width is larger than or smaller than a size/bit-width needed for the new BWP of the cell, respectively.

A cell-specific (or Type-2) field refers to a field in the multi-cell scheduling DCI format 0_3/1_3, wherein the DCI format provides a separate field for each cell from the cell that are scheduled by the DCI format 0_3/1_3. Cell-specific/Type-2 fields include, for example, one or more of: new data indicator (NDI), redundancy version (RV), HARQ process number (HPN), modulation and coding scheme (MCS), FDRA, transmit power control (TPC) command for scheduled PUSCH, and phase tracking reference signal (PTRS)-DMRS association. In addition, one or more of the following fields can be configured to be a cell-specific/Type-2 field: Antenna port(s), SRS resource indicator (SRI), and transmit precoding matrix indicator (TPMI).

In one example, when L is a size/bit-width of the cell-specific/Type-2 field in the DCI format 0_3/1_3 for a cell (based on the configuration provided for the active BWP of the cell) and when Nis a necessary size/bit-width of the cell-specific/Type-2 field for the new BWP of the cell (based on the configuration provided for the new BWP of the cell):
When N=L, the UE uses for the new BWP of the cell the same value that is provided for the cell in the DCI format.
When N>L, the UE truncates from the left (or from the right) the value that is provided for the cell in the DCI format and uses for the new BWP of the cell the L least significant bits (LSBs) (or the L MSBs) of the value that is provided for the cell in the DCI format.
When N<L, the UE prepends (or appends) a number (N−L) of zeros to the value that is provided for the cell in the DCI format and uses the resulting value for the new BWP of the cell.

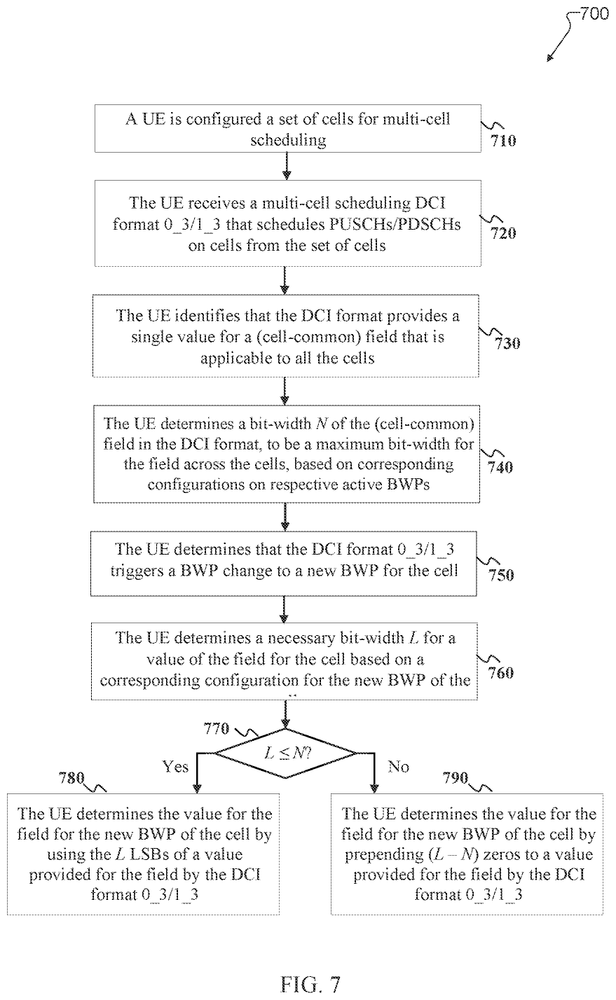

FIG. 7 illustrates a flowchart of an example UE procedure 700 for determining a value for the field on the new BWP of the cell according to embodiments of the present disclosure. For example, procedure 700 for determining a value for the field on the new BWP of the cell can be performed by the UE of FIG. 3. This example is for illustration only and other embodiments can be used without departing from the scope of the present disclosure.

The procedure begins in 710, a UE is configured a set of cells for multi-cell scheduling. In 720, the UE receives a multi-cell scheduling DCI format 0_3/1_3 that schedules PUSCHs/PDSCHs on cells from the set of cells. In 730, the UE identifies that the DCI format provides a single value for a (cell-common) field that is applicable to all the cells. In 740, the UE determines a bit-width N of the (cell-common) field in the DCI format, to be a maximum bit-width for the field across the cells, based on corresponding configurations on respective active BWPs. In 750, the UE determines that the DCI format 0_3/1_3 triggers a BWP change to a new BWP for the cell. In 760, the UE determines a necessary bit-width L for a value of the field for the cell based on a corresponding configuration for the new BWP of the cell. In 770, the UE determines whether or not L≤N. In 780, when the UE determines L≤N, the UE determines the value for the field for the new BWP of the cell by using the L LSBs of a value provided for the field by the DCI format 0_3/1_3. In 790, when the UE determines L>N, the UE determines the value for the field for the new BWP of the cell by prepending (L−N) zeros to a value provided for the field by the DCI format 0_3/1_3.

In one embodiment, a size/bit-width of a cell-common field (also known as, a “Type-1A” field) in a multi-cell scheduling DCI format 0_3/1_3 that is associated with a set of cells for multi-cell scheduling can be based on a maximum size/bit-width of the field across respective active BWPs of different cells in the set of cell, or based on a maximum field size among all configured BWPs of different cells in the set of cells. In addition, when the DCI format triggers a BWP change for a cell, from cells that are co-scheduled by the DCI format 0_3/1_3 (or from cells in the set of cells), the UE determines a value of the cell-common/Type-1A field for the new BWP of the cell, in one option, by using a number of LSBs from the value provided in the DCI format for the cell-common/Type-1A field, wherein the number is equal to a size/bit-width of the field for the new BWP of the cell. In another option, the UE uses a value of the cell-common/Type-1A field that is determined for the active BWP of the cell, which can be truncated from the right or prepended zeros if a corresponding size/bit-width is larger than or smaller than a size/bit-width needed for the new BWP of the cell. Similar methods also apply to “Type-IC” fields in the DCI format 0_3/1_3, namely fields for which the DCI format 0_3/1_3 provides a single value that is applicable to only one cell from the cells that are co-scheduled by the DCI format 0_3/1_3 (or from the set of cells).

A cell-common/Type-1A field refers to a field for which the multi-cell scheduling DCI format 0_3/1_3 provides a single value that is commonly applicable to all cells that are co-scheduled by the DCI format 0_3/1_3.

In one example, for a parameter corresponding to a cell-common/Type-1A field, a single configuration is provided for/per the set of cells for multi-cell scheduling, or all cells in the set of cells are (expected to be) provided a same configuration for a corresponding parameter (in all BWPs or in respective BWPs with same BWP index). Accordingly, the UE determines a single size/bit-width for the cell-common/Type-1A field for all cells, and all bits of the value apply commonly to all co-scheduled cells.

In another example, the UE can be provided different configurations for the corresponding parameter for different cells in the set of cells. For example, the UE can determine a size/bit-width of a field that is cell-common (also referred to as Type-1A) in a multi-cell scheduling DCI format 0_3/1_3 associated with a set of cells for multi-cells scheduling to be:
in one option, a maximum field size among respective active BWPs of different cells in the set of cells.
in another option, a maximum field size among all configured BWPs of different cells in the set of cells.

For example, the UE reads only N least significant bits (LSBs) of the value provided for the cell-common/Type-1A field, where Nis a size of the corresponding field in a single-cell scheduling DCI format, such as DCI format 0_1/1_1 or 0_2/1_2, for the cell, or is a size of the field needed for the cell based on the configuration provided, to the cell, for the multi-cell scheduling DCI format 0_3/1_3. For example, the UE determine N based on a corresponding configuration provided for a respective active BWP of the respective cell.

In one example, when a DCI format 0_3/1_3 triggers a BWP change for a cell from a cell combination that is scheduled by the DCI format 0_3/1_3, the UE can determine a value of a cell-common/Type-1A field in the multi-cell scheduling DCI format 0_3/1_3 for the cell from the value provided by the DCI format as follows:
In one option, the UE determines a value N′ based on a corresponding configuration that is provided on/for the new BWP on the cell and uses for the new BWP of the cell the N′ LSBs from the field value that is provided by the DCI format 0_3/1_3.
   When N′>L, where L is a size/bit-width determined for the cell-common/Type-1A field, the UE prepends (or appends) a number (N′−L) of zeros to the field value, and uses the resulting value for the cell.
In another option, the UE reads NLSBs of the value provided for the cell-common/Type-1A field in the DCI format 0_3/1_3, wherein the UE determine N based on a configuration of a corresponding parameter that is provided for a (current) active BWP of the cell. The UE also determines a value N′ based on a corresponding configuration that is provided on the new BWP on the cell.
   When N′=N, the UE uses, for the new BWP of the cell, a value determined from the NLSBs of the field value.
   When N′<N, in one example, the UE truncates the determined NLSBs from the right (or from the left), and uses for the new BWP of the cell N′ most significant bits (MSBs) from the determined NLSBs of the field value.
   When N′>N, in one example, the UE prepends (or appends) a number (N′−N) of zeros to the value determined from the N LSBs of the field value and uses the resulting value for the new BWP of the cell.

In one example, a value of a cell-common/Type-1A field provided by a multi-cell scheduling DCI format 0_3/1_3 that is associated with a set of cells for multi-cell scheduling applies only to co-scheduled cell, in the set of cells, by the DCI format 0_3/1_3, and does not apply to cells, from the set of cells, that are not scheduled by the DCI format 0_3/1_3.

In another example, a value of a cell-common/Type-1A field is applicable to all cells in the set of cells for multi-cell scheduling, including cells that are not scheduled by the DCI format 0_3/1_3. Accordingly, the methods for determination of values of cell-common/Type-1A fields can also apply when the DCI format 0_3/1_3 triggers a BWP change for a cell from the cells, in the set of cells, that are not scheduled by the DCI format 0_3/1_3.

Cell-common/Type-1A fields in a multi-cell scheduling DCI format 0_3/1_3 include, for example, one or more of: Identifier for DCI formats, BWP indicator, VRB-to-PRB mapping, PRB bundling size indicator, Downlink assignment index (DAI), TPC for scheduled PUCCH, PUCCH resource indicator (PRI), PDSCH-to-HARQ timing indicator (K1), One-shot HARQ-ACK request, Frequency hopping flag, DMRS sequence initialization, Open-loop power control parameter set indication, Enhanced Type-3 codebook indicator, HARQ-ACK retransmission indicator, PUCCH Cell indicator, Priority indicator, ChannelAccess-Cpext (CAPC), Beta_offset indicator, SCell dormancy indication, PDCCH monitoring adaptation indication, and minimum applicable scheduling offset indication. For example, some fields can be configured as cell-common/Type-1A fields, such as one or more of: Antenna port(s), SRI, and TPMI.

Similar methods apply to Type-1C fields in a multi-cell scheduling DCI format 0_3/1_3. A Type-1C field refers to a field that provides a single value that is applicable to only one cell (from the corresponding set of cells for multi-cell scheduling). For example, Type-1C fields can include one or more of: CSI request, UL-SCH indicator. For example, the field is applied to the cell with smallest serving cell index among the co-scheduled cells.

For example, the UE determines a size/bit-width of a Type-1C field based on a configuration on an active BWP of the cell to which the Type-1C field applies.

For example, when a multi-cell scheduling DCI format 0_3/1_3 triggers a BWP change for the cell to which a Type-1C field applies, the UE uses, for the new BWP on the cell, N′ LSBs from the value provided in the DCI format 0_3/1_3 for the Type-1C field. The UE determines a value N′ based on a corresponding configuration that is provided on/for the new BWP of the cell. When N′>L, where L is a size/bit-width of the Type-1C field, the UE prepends (or appends) a number (N′−L) of zeros to the field value and uses the resulting value for the new BWP of the cell.

Various methods concerning BWP switching apply when a respective DL or UL BWP change is triggered. For example, a DL BWP change indicated by a DL DCI format 1_3 may not change an interpretation of UL-BWP-based parameters, such as SRS request or SRS offset indication.

In one example, a DCI field, such as a DCI field Type-1A, in an MC-DCI format, such as DCI format 0_3/1_3, can indicate a single common value for more than one cells, while the indicated value may not be applicable to a cell (or an active BWP of a cell) from the more than one cells. For example, the UE can be configured with 3 values with corresponding indexes {00, 01, 10} for a certain DCI field, and the DCI format can include value ‘ii’ for the corresponding DCI field. For example, the UE is configured 3 BWPs with BWP indexes {0, 1, 2} for a cell, while a BWP indicator field in a DCI format 0_3/1_3 can indicate value ‘11’ corresponding to BWP index 3, which is not configured for the cell. For example, the UE is configured a number of SRS resources on the active BWP f a cell corresponding to SRI values {0, 1, 2, 3, 4, 5}, while an SRI field in a DCI format 0_3 can indicate value ‘111’ corresponding to an SRI value 7, which is not configured for the active BWP of the cell. In another example, the SRI field in DCI 1_3 can be configured as a Type-1A field and provide a value ‘11’=3, which is well-defined for a cell #1 that is configured with N_{SRS}=4, while for a cell #2 with N_{SRS}=2, only SRI values {0, 1, 2} are applicable and SRI=3 is “reserved” for the cell. In one example, a default UE behavior can be to use a reference value for the PUSCH transmission on the cell, such as SRI=0.

There can be a number of options for the UE behavior:
In a first option, the UE does not expect such value to be provided by the (Type-1A) DCI field, for example it is an error case that can be avoided by the gNB 102 implementation.
In a second option, the UE ignores the DCI field when such value is provided; for example, the UE does not apply the corresponding UE behavior, such as no BWP switching or no frequency hopping or no priority applicable to any PUSCHs.
In a third option, the UE applies a default/reference value or a default/reference behavior when such value is provided.
   For example, the default value can be all 0s or all 1s.
   For example, the default value can be to apply the configured parameter corresponding to index equal to 0 or equal to all 0s or a smallest configured index (in the current active BWP), such as AP=all 0s or SRI=all 0s, or TPMI=all 0s.
   For example, the default value can be to apply the configured parameter corresponding to index equal to 1 or equal to all 1s or a largest configured index (in the current active BWP), such as AP=all 1s or SRI=all 1s, or TPMI=all 1s.
   For example, the default value can be predetermined in the specifications of system operation.
   For example, the default value can be same as a value configured/activated for a SPS PDSCH or CG PUSCH on the current/new active BWP (with smallest index configuration, if there are more than one SPS PDSCH or CG PUSCH configurations on the current/new active BWP) of the corresponding cell.
   For example, the default value can be same as a value configured/activated for PDCCH/CORESET or PUCCH with smallest index on the current/new active BWP of the corresponding cell.
   For example, the default value can be provided by higher layers (separately for each cell or commonly for the set of cells).
   For example, a reference UL BWP can be one of: a current active UL BWP, or a First UL Active BWP (firstActiveUpinkBWP-Id), or an initial UL BWP (initialUplinkBWP), or an UL BWP with index=0 or with a smallest UL BWP index.
   For example, a reference DL BWP can be one of: a current active DL BWP, or a DL BWP configured withfirstWithinActiveTimeBWP-Id, or a DL BWP configured with firstOutsideActiveTimeBWP-Id, or a First DL Active BWP (firstActiveDowninkBWP-Id), or an initial DL BWP (initialDowninkBWP) or a default DL BWP, or a DL BWP with index=0 or with a smallest DL BWP index.
   For example, a default/reference value can be one of the default values as previously described on a reference UL/DL BWP as previously described.
In a fourth option, the PUSCH/PDSCH scheduled on the cell is discarded when such value is provided, while other PUSCHs/PDSCHs scheduled on the other cells can be transmitted/received.
In a fifth option, the UE evaluates the DCI format to provide inconsistent information and discards the entire DCI format, so the UE does not transmit any PUSCHs on any cells or does not receive any PDSCHs on any cell.

Similar behavior applies to Type-1B fields, wherein a DCI format 0_3/1_3 provides an entry from a list of entries, where the entry includes a number of indexes for a number of cells in corresponding set of cells and the indexes are indexes or values for the UE operation associated with the DCI field. For example, the number of cells includes cells from the set of cells that are configured with the corresponding DCI parameter/UE operation. For example, the number of cells includes all cells in a corresponding set of cells. For example, an entry provided for a Type-1B field can include a single index for each cell that is applicable to all configured BWPs of the cell. For example, similar options and examples apply when an index, corresponding to a cell, included in an entry that is provided for a Type-1B field is not applicable to a BWP, such as the active BWP, for the cell. For example, a rate-matching field or a zero power (ZP) CSI-RS field or a TCI state field of a DCI format 1_3 includes an index ‘11’ for a cell, while an active BWP of the cell is configured only rate matching resource sets or ZP CSI-RS resources (sets) or TCI states corresponding to indexes {0, 1, 2}.

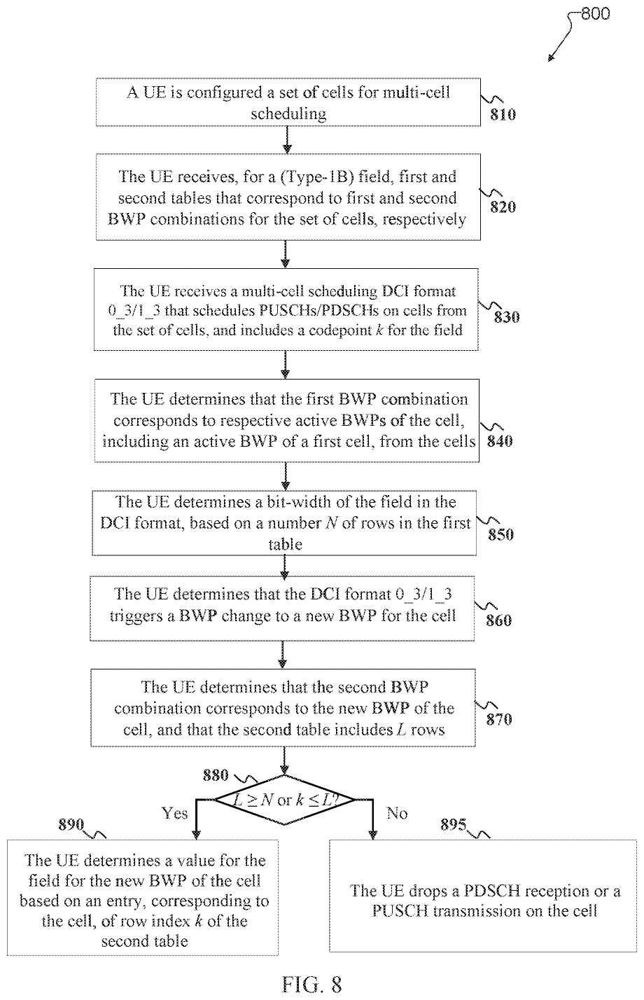

FIG. 8 illustrates a flowchart of an example UE procedure 800 for determining a value for the field on the new BWP of the cell according to embodiments of the present disclosure. For example, procedure 800 for determining a value for the field on the new BWP of the cell can be performed by the UE 111 of FIG. 1. This example is for illustration only and other embodiments can be used without departing from the scope of the present disclosure.

The procedure begins in 810, a UE is configured a set of cells for multi-cell scheduling. In 820, the UE receives, for a (Type-1B) field, first and second tables that correspond to first and second BWP combinations for the set of cells, respectively. In 830, the LIE receives a multi-cell scheduling DCI format 0_3/1_3 that schedules PUSCHs/PDSCHs on cells from the set of cells and includes a codepoint k for the field. In 840, the UE determines that the first BWP combination corresponds to respective active BWPs of the cell, including an active BWP of a first cell, from the cells. In 850, the UE determines a bit-width of the field in the DCI format, based on a number N of rows in the first table. In 860, the UE determines that the DCI format 0_3/1_3 triggers a BWP change to a new BWP for the cell. In 870, the UE determines that the second BWP combination corresponds to the new BWP of the cell, and that the second table includes L rows. In 880, the UE determines whether L≥N or k≤L. In 890, when the UE determines L≥N or k≤L, the UE determines a value for the field for the new BWP of the cell based on an entry, corresponding to the cell, of row index k of the second table. Otherwise, in 895, the UE drops a PDSCH reception or a PUSCH transmission on the cell.

In one embodiment, a size/bit-width of a Type-1B field in a multi-cell scheduling DCI format 0_3/1_3 (that provides a codepoint indicating a row of a joint multi-cell encoding table, with entries of the row corresponding to cells in a set of cells for multi-cell scheduling) is based on a number of rows configured in the table. For each Type-1B field, in one option, the UE can be configured multiple separate tables corresponding to different BWP combinations for the set of cells, wherein a BWP combination corresponds to a collection of a first configured BWP for a first cell, and a second configured BWP for a second cell, and so on. When a DCI format 0_3/1_3 triggers a BWP change to a new BWP for a cell, from the cells that are co-scheduled by the DCI format 0_3/1_3 (or from the set of cells), the LIE uses for the new BWP of the cell, a value/entry corresponding to the cell in a row, as indicated by the codepoint in the DCI format 0_3/1_3, from a table associated with a new BWP combination that corresponds to the new BWP of the cell. When the codepoint in the DCI format 0_3/1_3 indicates a row index that is not present in (i.e., outside range of) the table, the UE transmits the corresponding PUSCH or receive the corresponding PDSCH on the cell by applying a default behavior for the field, or the UE drops the corresponding PUSCH transmission or PDSCH reception on the cell. In another option, for each Type-1B field, the UE can be configured a single table that corresponds to all different BWP combinations for the set of cells. When a DCI format 0_3/1_3 triggers a BWP change for a cell, from the co-scheduled cells (or from the set of cells), and an entry, corresponding to the cell, in a row of the table provides a value (or ID of a value) that is not configured or activated for the new BWP of the cell, the UE transmits the corresponding PUSCH or receive the corresponding PDSCH on the cell by truncating or zero-padding the value (or ID of the value) provided by the table, or by applying a default behavior for the field, or the UE drops the corresponding PUSCH transmission or PDSCH reception on the cell.

A Type-1B field refers to a field for which a multi-cell scheduling DCI format 0_3/1_3 provides a single value/codepoint that indicates a separate value for each cell from the cell combination that is co-scheduled by the DCI format 0_3/1_3 or for each cell from all cells in a set of cells for multi-cell scheduling that is associated with the DCI format 0_3/1_3. For example, the UE is configured, for a parameter corresponding to the respective Type-1B field, a joint multi-cell table with a number of rows, wherein each row of the table provides a number of entries (equal to a number of cells in the corresponding set of cells), with each entry providing a value for the parameter for a cell in the set of cells. For example, the value provided by an/each entry/cell is a value (or ID of a value) from a respective set of values that are RRC configured (or activated by a MAC-CE) for a respective cell. A size/bit-width of a Type-1B field in a multi-cell scheduling DCI format 0_3/1_3 is ceiling(log 2(N)), wherein N is the number of rows in the corresponding joint multi-cell table. For example, a value/codepoint provided by a multi-cell scheduling DCI format 0_3/1_3 indicates a row index from the corresponding table.

For example, Type-1B fields include one or more of: TDRA, rate matching indicator, ZP CSI-RS trigger, TCI, SRS request, and SRS offset indicator.

In one example, for each Type-1B field, the UE can be configured a separate table for each combination of BWPs of the set of cells for multi-cell scheduling. A combination of BWPs of the set of cells is a collection of one BWP for each cell from the set of cells. For example, for a set of cells with 4 cells, a combination of BWPs for the set of cells includes a first BWP for a first cell, and a second BWP for a second cell and a third BWP for a third cell, and a fourth BWP for a fourth cell. For example, a BWP combination with index #1 can include BWP #1 for cell #1, BWP #2 for cell #2, BWP #1 for cell #3, and BWP #0 for cell #4. For example, when a UE is configured 4 BWP for each cell in a set of cells with 4 cells, there exist 4∝=256 different BWP combinations for the set of cells.

For example, for each Type-1B field, the UE can be configured a number of tables for a set of cells, wherein each table is associated with a BWP combination, from the number of BWP combinations, for the set of cells. For example, for each Type-1B field, the UE can be configured a first table for a first BWP combination, a second table for a second BWP combination, and so on.

For example, the UE uses a table (say with index j), from the number of tables, when respective active BWPs of the cells in the set of cells correspond to a BWP combination #j. The UE uses, for cells that are co-scheduled by a multi-cell scheduling DCI format 0_3/1_3, values that are provided in respective entries of a row of the table index #j, wherein the row index is provided by the codepoint/value in the multi-cell scheduling DCI format 0_3/1_3. For example, the UE expects that the entries of any row of the table index #j point to values (or IDs of values) that are configured or activated for respective active BWPs the respective cells (that correspond to the BWP combination index #j). For example, the UE does not expect to be provided an entry in any row of the table index #j that points to a value (or ID of a value) for a cell that is not configured or activated for the respective BWP of the cell.

For example, the UE determines a size/bit-width of the Type-1B field in the multi-cell scheduling DCI format 0_3/1_3 to be ceiling(log 2(N_j)), wherein N_j is a number of rows in the joint multi-cell table index j corresponding to the BWP combination #j for the set of cells.

For example, when a BWP indicator field in a multi-cell scheduling DCI format 0_3/1_3 indicates a new BWP, that is different from the current active BWP, for a cell from the cells that are co-scheduled by the DCI format 0_3/1_3, the UE uses, for a Type-1B field, a table with index #k, from the number of tables, associated with a BWP combination index #k, that corresponds to the new BWP for the cell. For example, the BWP combination index #k is different from the BWP combination index #j. For example, the table with index #k is separate/different from the table with index #j.

For example, for each Type-1B field, when a corresponding table index #k (corresponding to the new BWP of the cell) includes N_k rows and a corresponding table index #j (corresponding to the current active BWP of the cell) includes N_j rows:
when N_k≥N_j, the UE uses entries provided by a row, from the table with index #k, that is indicated by the codepoint for the Type-1B field in the DCI format 0_3/1_3.
when N_k<N_j, if the codepoint for the Type-1B field in the DCI format indicates a row index not exceeding N_k, the UE uses entries provided by the corresponding row, from the table with index #k. If the codepoint for the Type-1B field in the DCI format indicates a row index that exceeds N_k (e.g., table index #k includes 4 rows, while the codepoint in the DCI format indicates a row index 10, as the table index #j included 10 or more rows), the UE can operate based on of the following options:
   in a first option, the UE discards the value provided by the Type-1B field and receives the corresponding PDSCH or transmits the corresponding PUSCH on the cell with BWP change without application of the parameter associated with the Type-1B field or by applying a default behavior for the parameter. For example, when the Type-1B field is rate matching indicator or ZP CSI-RS trigger, the UE receives the PDSCH on the cell with BWP change without applying any rate matching for the PDSCH reception. For example, when the Type-1B field is SRS request or SRS offset indicator, the UE does not trigger any (aperiodic) SRS transmission on the cell with BWP change. For example, when the Type-1B field is TCI, the UE receives the PDSCH (or transmits the PUSCH) on the cell with BWP change using an indicated beam for the cell (that is previously provided), or using a default beam, such as a configured/activated TCI state with lowest ID applicable to PDSCH in the active BWP (or the new BWP) of the cell, or using (a first TCI state corresponding to) a QCL assumption of a CORESET with lowest ID of the active BWP (or the new BWP) of the cell. For example, when the Type-1B field is TDRA, the UE receive the PDSCH or transmits the PUSCH on the cell according to a first row (or a last row or a configured row index) of a default TDRA table.
   in a second option, the UE determines a new/second row index from table index #k, based on a value of the codepoint provided in the DCI format, by truncating (from left or right) or by prepending or appending zeros to a value of the codepoint so that a resulting value of the codepoint has sufficient number of bits to indicate a valid row index from the table index #k.
   in a third option, the UE drops the corresponding PDSCH reception or PUSCH transmission on the cell with BWP change; For example, when the Type-1B field is TDRA or TCI, the UE does not receive the PDSCH or does not transmit the PUSCH on the cell with BWP change. In such case, the UE reports an ACK (alternatively, NACK) for the PDSCH.
   in a fourth option, the UE discard the entire DCI format and does not receive any of the PDSCHs or does not transmit any of the PUSCHs on any of the cells that are scheduled by the DCI format 0_3/1_3. In such case, the UE reports ACKs (alternatively, NACK) for the PDSCHs.

In one example, for each Type-1B field in a multi-cell scheduling DCI format 0_3/1_3 that is associated with a set of cells for multi-cell scheduling, the UE can be configured a single table that applies to all BWP combinations of the set of cells. Accordingly, the UE uses the table for any BWP of any cell in the set of cells. For example, the UE uses the table regardless of any BWP change indicated by the DCI format 0_3/1_3 for any cell in the set of cells. For example, a codepoint provided by a DCI format 0_3/1_3 indicates a valid/present row from the table. For example, a size/bit-width of the Type-1B field in the DCI format is ceiling(log 2(N)), regardless of any BWP change for any cell from the set of cells, wherein N is a number of rows of a corresponding table.

In one example, for each Type-1B field, the UE expects to be provided same configuration for a corresponding parameter on different BWPs of different cells in the set of cells. Accordingly, any entry in any row of the corresponding table includes a value (or ID of a value) that is configured or activated for the respective active/new BWP of the respective cell.

In one example, for each Type-1B field, the UE can be provided different configurations for a corresponding parameter on different BWPs of different cells in the set of cells.

When an entry in a row of a table corresponding to a Type-1B field includes a value (or ID of a value) that is not configured or activated on the respective active/new BWP of the respective cell (or when there is no configuration for the parameter on the respective active/mew BWP of the respective cell), the UE can operate based on one of the following options:
In a first method, the UE discards the value provided by the entry indicated by the Type-1B field and receives the corresponding PDSCH or transmits the corresponding PUSCH on the cell with BWP change without application of the parameter associated with the Type-1B field or by applying a default behavior for the parameter. For example, default behaviors can be as previously described in the first option.
In a second method, the UE determines a value for the parameter based on the value that is provided by the entry in the indicated row of the table. For example, when a bit-width of the value (or ID of the value) provided by the entry in the indicated row of the table is L bits and a necessary bit-width for the field on the respective active/new BWP of the respective cell is L′ bits, the UE determines a value (or ID of the value) for the field on the respective active/new BWP of the respective cell:
   When L>L′, by using the L′ LSBs (or the L′ MSBs) of the value (or ID of the value) provided by the entry in the indicated row of the table. For example, for the rate matching indicator field, when an entry in a row of the table indicates a value ‘11’ for a cell and the UE is configured only rate matching pattern group 1 on the active/new BWP of the cell (and is not configured rate matching pattern group 2 on the active/new BWP of the cell), the UE discard the LSB (corresponding to the rate matching pattern group 2) and uses only the MSB (i.e., value ‘1’, corresponding to the rate matching pattern group 1). Therefore, the UE receives the PDSCH on the cell by rate matching the PDSCH around the resources provided by the rate matching pattern group 1.
   When L<L′, by prepending (or appending) L′−L zeros to the value (or ID of the value) provided by the entry in the indicated row of the table. For example, for the rate matching indicator field, when an entry in a row of the table indicates a value ‘1’ for a cell and the UE is configured both rate matching pattern group 1 and rate matching pattern group 2 on the active/new BWP of the cell, the UE determines a value for the respective active/new BWP of the cell to be ‘10’, so the UE receives the PDSCH on active/new BWP of the cell by rate matching the PDSCH around the resources associated with the rate matching pattern group 1 (and no rate matching the PDSCH around resources associated with the rate matching pattern group 2).
In a third method, the UE drops the corresponding PDSCH reception or PUSCH transmission on the cell with BWP change. For example, when the Type-1B field is TDRA or TCI, the UE does not receive the PDSCH or does not transmit the PUSCH on the cell with BWP change. In such case, the UE reports an ACK (alternatively, a NACK) for the PDSCH.
In a fourth method, the UE discard the entire DCI format and does not receive any of the PDSCHs or does not transmit any of the PUSCHs on any of the cells that are scheduled by the DCI format 0_3/1_3. In such case, the UE reports ACKs (alternatively, NACK) for the PDSCHs.

Various methods concerning BWP switching apply (only) when a respective DL or UL BWP is changed. For example, a DL BWP change by a DL DCI format 0_3 does not change an interpretation of UL-based parameters, such as SRS request or SRS offset indication.

In one example, the UE can be provided no configuration for a parameter corresponding to a Type-1B DCI field for a cell from a set of cells for multi-cell scheduling. For example, the UE is not provided any configuration for the ZP CSI-RS resource sets or for rate matching (RM) pattern groups or for SRS request offset values for the cell. In one example, the UE is not provided any such configuration on an active BWP of the cell, such as the active BWP of the cell at the time of receiving the DCI format 0_3/1_3 or the new active BWP of the cell as indicated by the BWP indicator field of the DCI format 0_3/1_3. In another example, the UE is not provided any such configuration on any of the configured BWPs of the cell.

In one example, a combination of entries corresponding to a row from a joint multi-cell table configured for a Type-1B field can include a number of entries that is equal to a number of cells in the set of cells. For example, the combination of entries can include zero-bit entries, such as, for cells for which a configuration is not provided for the Type-1B field. For example, abstract syntax notation.1 (ASN.1) coding can include zero-bit values. For example, a zero-bit entry can be indicated via zero encoding. For example, a special character or symbol or value, such as NULL, may be used to indicate a zero-bit value.

For example, a default non-zero-bit value can be used to indicate a no-configuration status, such as ‘0’ or ‘00’ and so on. For example, when the UE is provided, for a cell, a default value such as ‘0’ or ‘00’ in a combination of values that correspond to a row of the joint multi-cell table:
If the UE is not provided a configuration for the corresponding Type-1B parameter for the cell (or for a new/target active BWP of the cell, as indicated by the BWP indicator field of the DCI format 0_3/1_3), the UE interprets the entry ‘0’ or ‘00’ (as if a null or a zero-bit entry) to indicate that the UE does not apply the parameter to the cell, for example, no ZP CSI-RS trigger, or no rate matching applied, or no SRS request offset applicable to the cell.
If the UE is provided a configuration for the corresponding Type-1B parameter for the cell (or for a new/target active BWP of the cell), the UE interprets the entry ‘0’ or ‘00’ to indicate a certain corresponding index, such as index 0, associated with the corresponding Type-1B field configuration. For example, for RM indicator, a value ‘0’ or ‘00’ can indicate that the resource sets within the list of RateMatchPattern(s) included in rateMatchPatternGroup1 or rateMatchPatternGroup2 are available for PDSCH reception (i.e., no rate matching). For example, for ZP CSI-RS trigger, a value ‘0’ or ‘00’ can indicate no ZP CSI-RS trigger, so that any REs corresponding to configured resources in aperiodic-ZP-CSI-RSResourceSetsToAddModList are available for PDSCH reception. For example, for SRS offset indicator, a value ‘0’ or ‘00’ can indicate a value of slot offset, with index 0 (e.g., a first value), from a list of slot offset values configured in availableSlotOffsetList.

In one example, a size/bit-width of an entry in a row of a joint multi-cell table for a Type-1B DCI field, wherein the entry corresponds to a cell from a set of cells for multi-cell scheduling, can be equal to a maximum bit-width among bit-widths for different configured BWPs of the cell. For example, for a cell with two configured BWPs, when a bit-width for the Type-1B field for a first BWP of the cell is equal to 1 bit (for example, based on the configuration provided for the first BWP), and a bit-width for the Type-1B field for a second BWP of the cell is equal to 2 bits (for example, based on the configuration provided for the second BWP), the entry includes 2 bits (which is the maximum of 1 and 2 bits). For example, when interpreting the entry for the first BWP, only an LSB (or MSB) of the entry is used and the MSB (or respectively, LSB) is discarded.

In one example, a value of a Type-1B field provided by a multi-cell scheduling DCI format 0_3/1_3 that is associated with a set of cells for multi-cell scheduling applies only to co-scheduled cell, in the set of cells, by the DCI format 0_3/1_3, and does not apply to cells, from the set of cells, that are not scheduled by the DCI format 0_3/1_3. For example, the UE does not apply indicated TCI states or SRS request for the non-scheduled cells, even though a row, with index that is indicated by the corresponding codepoint in the DCI format 0_3/1_3, provides entries/values for TCI state indication or SRS request that correspond to non-scheduled cells.

In another example, a value of a Type-1B field is applicable to all cells in the set of cells for multi-cell scheduling, including cells that are not scheduled by the DCI format 0_3/1_3. For example, when the Type-1B field is TCI, the UE can determine and use TCI state for all cells in the set of cells (by reading corresponding entries in a row with an index that is indicated by the corresponding DCI codepoint), including cells that are not scheduled for PDSCH reception by the DCI format 0_3. For example, when the Type-1B field is SRS request or SRS offset indication, the UE can determine and apply SRS request with corresponding offset for all cells in the set of cells (by reading corresponding entries in a row with an index that is indicated by the corresponding DCI codepoint), including cells that are not scheduled for PDSCH reception or PUSCH transmission by the DCI format 0_3/1_3. In one example, a DCI format may not schedule any PDSCH receptions or PUSCH transmissions on any cell from the set of cells (as determined by a verification procedure on certain field values), and the DCI format can be used only for TCI state indication or for SRS request for cells in the set of cells. For example, the UE can receive a multi-cell scheduling DCI format 1_3 that schedules no information/PDSCH on any cell, from a set of cells for multi-cell scheduling, and the DCI format 1_3 provides configured or activated TCI state IDs for all cells that scheduled by the DCI format 1_3.

Accordingly, the methods for determination of size/bit-width and values of the Type-1B field can also apply when the DCI format 0_3/1_3 triggers a BWP change for a cell, in the set of cells, that is not scheduled by the DCI format 0_3/1_3.

If a bandwidth part indicator field is configured in a DCI format, the bandwidth part indicator field value indicates the active DL BWP, from the configured DL BWP set, for DL receptions. If a bandwidth part indicator field is configured in a DCI format, the bandwidth part indicator field value indicates the active UL BWP, from the configured UL BWP set, for UL transmissions.

If a bandwidth part indicator field is configured in a DCI format 1_3, for an information field except a TDRA field that provides an entry from a higher layer list of entries, with the entry containing one or more (information) indexes for respective one or more cells, the bandwidth part indicator field value indicates the active DL BWP, from the configured DL BWP set, applicable for the one or more (information) indexes for respective one or more DL receptions on the respective one or more cells.

If a bandwidth part indicator field is configured in a DCI format 0_3, for an information field (except a TDRA field) that provides an entry from a higher layer list of entries, with the entry containing one or more (information) indexes for one or more cells, the bandwidth part indicator field value indicates the active UL BWP, from the configured UL BWP set, (applicable) for the one or more (information) indexes for respective one or more UL transmissions on the respective one or more cells.

If a bandwidth part indicator field is configured in a DCI format 1_3, for a TDRA field, the bandwidth part indicator field value indicates the active DL BWP, from the configured DL BWP set, and one or more applicable TDRA indexes for respective one or more DL receptions on the respective one or more cells.

If a bandwidth part indicator field is configured in a DCI format 0_3, for a TDRA field, the bandwidth part indicator field value indicates the active UL BWP, from the configured UL BWP set, and one or more applicable TDRA indexes for respective one or more UL transmissions on the respective one or more cells.

If a bandwidth part indicator field is configured in a DCI format and indicates an UL BWP or a DL BWP different from the active UL BWP or DL BWP, respectively, the UE can:
for each information field in the DCI format:
   if the size of the information field is smaller than the one required for the DCI format interpretation for the UL BWP or DL BWP, for the cell, that is indicated by the bandwidth part indicator, the UE prepends zeros to the information field until its size is the one required for the interpretation of the information field for the UL BWP or DL BWP prior to interpreting the DCI format information fields, respectively.
   if the size of the information field is larger than the one required for the DCI format interpretation for the UL BWP or DL BWP, for the cell, that is indicated by the bandwidth part indicator, the UE uses a number of least significant bits of the information field/DCI format equal to the one required for the UL BWP or DL BWP indicated by bandwidth part indicator for the cell prior to interpreting the DCI format information fields, respectively.
set the active UL BWP or DL BWP of the cell to the UL BWP or DL BWP indicated by the bandwidth part indicator in the DCI format.

If a bandwidth part indicator field is configured in a DCI format 1_3 or 0_3 and indicates or implies an UL BWP or a DL BWP different from the active UL BWP or DL BWP of a cell, respectively, the UE can:
for an information block, corresponding to the cell, from a number of information blocks that are provided by a Type-2 information field in the DCI format 0_3 or 1_3:
   if the size of the information block is smaller than the one required for the DCI format interpretation for the UL BWP or DL BWP, for the cell, that is indicated or implied by the bandwidth part indicator, the UE prepends zeros to the information block until its size is the one required for the interpretation of the information block for the UL BWP or DL BWP prior to interpreting the DCI format information fields, respectively.
   if the size of the information block is larger than the one required for the DCI format interpretation for the UL BWP or DL BWP, for the cell, that is indicated by the bandwidth part indicator, the UE uses a number of least significant bits of the information block in DCI format equal to the one required for the UL BWP or DL BWP indicated by bandwidth part indicator prior to interpreting the DCI format information fields, respectively.
set the active UL BWP or DL BWP of the cell to the UL BWP or DL BWP indicated by the bandwidth part indicator in the DCI format.

If a bandwidth part indicator field is configured in a DCI format 1_3 or 0_3 and indicates or implies an UL BWP or a DL BWP different from the active UL BWP or DL BWP of a cell, respectively, the UE can:
for an information index, corresponding to the cell, from a number of information indexes that are provided by an entry, from a list of entries, indicated by a Type-1B information field in the DCI format 0_3 or 1_3:
   if the size of the information index is smaller than the one required for the DCI format interpretation for the UL BWP or DL BWP, for the cell, that is indicated or implied by the bandwidth part indicator, the UE prepends zeros to the information index until its size is the one required for the interpretation of the information index for the UL BWP or DL BWP for the cell prior to interpreting the DCI format information fields, respectively.
   if the size of the information index is larger than the one required for the DCI format interpretation for the UL BWP or DL BWP, for the cell, that is indicated by the bandwidth part indicator, the UE uses a number of least significant bits of the information index in DCI format equal to the one required for the UL BWP or DL BWP indicated by bandwidth part indicator for the cell prior to interpreting the DCI format information fields, respectively.
set the active UL BWP or DL BWP of the cell to the UL BWP or DL BWP indicated by the bandwidth part indicator in the DCI format.

If a bandwidth part indicator field is configured in a DCI format 1_3 or 0_3 and indicates an UL BWP or a DL BWP same as the active UL BWP or DL BWP of a cell, respectively, and if a size of a cell-common or Type-1A information field, that provides a single common value for all cells that are co-scheduled by a DCI format 0_3/1_3, is larger than the one required for the DCI format interpretation for the UL BWP or DL BWP of the cell that is indicated by the bandwidth part indicator, the UE can use a number of least significant bits of the information field of DCI format equal to the one required for the UL BWP or DL BWP indicated by bandwidth part indicator for the cell prior to interpreting the DCI format information fields, respectively.

If a bandwidth part indicator field is configured in a DCI format 1_3 or 0_3 and indicates an UL BWP or a DL BWP different from the active UL BWP or DL BWP of a cell, respectively, the UE can:
for a cell-common or Type-1A information field, that provides a single common value for all cells that are co-scheduled by the DCI format 1_3/0_3:
   if the size of the information field is smaller than the one required for the DCI format interpretation for the UL BWP or DL BWP, of the cell, that is indicated by the bandwidth part indicator, the UE prepends zeros to the information field until its size is the one required for the interpretation of the information field for the UL BWP or DL BWP for the cell prior to interpreting the DCI format information fields, respectively.
   if the size of the information field is larger than the one required for the DCI format interpretation for the UL BWP or DL BWP, of the cell, that is indicated by the bandwidth part indicator, the UE uses a number of least significant bits of the information field of DCI format equal to the one required for the UL BWP or DL BWP indicated by bandwidth part indicator for the cell prior to interpreting the DCI format information fields, respectively.
set the active UL BWP or DL BWP to the UL BWP or DL BWP indicated by the bandwidth part indicator in the DCI format.

If a bandwidth part indicator field is configured in a DCI format 0_3 and indicates an active UL BWP with different SCS configuration μ, or with different number N_{RB-set}^{BWP} of RB sets, for a cell, than a current active UL BWP of the cell, the UE determines an uplink frequency domain resource allocation Type 2 for the cell based on X′ bits and Y′ bits that are generated by independently truncating or padding the X MSBs and the Y LSBs [6, TS 38.214] of the FDRA block, corresponding to the cell, of the frequency domain resource assignment field of DCI format 03, where truncation starts from the MSBs of the X bits or the Y bits, zero-padding prepends zeros to the X bits or the Y bits, and
if the indicated active UL BWP for the cell has SCS configuration μ=1 and the current active BWP of the cell has SCS configuration μ=0, the X MSBs are truncated to X′=X−1 bits; or
if the indicated active UL BWP for the cell has SCS configuration μ=0 and the current active BWP of the cell has SCS configuration μ=1, the X MSBs are zero-padded to X′=X+1 bits;
otherwise, the X MSBs are unchanged;
   and
the Y LSBs are truncated or zero-padded to

$${Y}^{′} = ⌈ {log}_{2} ( \frac{{N}_{R B - set , UL ( {N}_{R B - set , UL}^{BWP} + 1 )}^{BWP}}{2} ) ⌉$$

bits where N_{RB-set,UL}^{BWP} is a number of RB sets configured for the indicated active UL BWP for the cell.

In one example, when a cell is non-dormant (i.e., has an active DL BWP that is not a dormant BWP), a BWP indicator field of a DCI format 0_3/1_3, which is a cell-common/Type-1A DCI field, can indicate a dormant BWP for the cell. For example, a DCI format 0_3/1_3 schedules cells {1, 2, 3, 4} and indicates a BWP index #1 for the cells, which is a non-dormant BWP for cells {1, 2, 3} while it is a dormant BWP for cell #4. For example, the FDRA can be valid for cell #4. For example, valid FDRA for cell #4 is not expected or is ignored when received. For example, the UE switches cell #4 to the indicated dormant BWP. For example, the UE ignores the indicated BWP and performs no BWP switching.

In one example, a UE does not expect a BWP indicator field of a DCI format 0_3/1_3 to indicate a BWP index that is a dormant BWP for a cell, from the co-scheduled cell (e.g., with valid FDRA). In another example, the UE may receive a DCI format 0_3/1_3 with a BWP indicator field that indicates a BWP index that is a dormant BWP for a cell, and an FDRA block corresponding to the cell is invalid/reserved, or an FDRA block corresponding to the cell is valid/non-reserved while the UE does not transmit a scheduled PUSCH or receive a scheduled PDSCH (on the indicated dormant BWP of the cell). For example, the UE evaluates the DCI format 0_3/1_3 as having inconsistent information, and discards the entire DCI format, for example, not transmitting any PUSCHs or not receiving any PDSCHs on any of the co-scheduled cells, or only inconsistent information for the corresponding cell and not transmitting a PUSCH or not receiving a PDSCH on the cell. For example, the UE does not expect a DCI format 0_3 or 1_3 to switch an active BWP of a cell from a non-dormant BWP to dormant BWP. For example, the UE transmits the scheduled PUSCH or receives the scheduled PDSCH on the cell without applying any BWP switching. For example, the UE transmits the PUSCH on one of: a current active (non-dormant) UL BWP, or a First UL Active BWP (firstActiveUpinkBWP-Id), or an initial UL BWP (initialUplinkBWP). For example, the UE receives the PDSCH on one of: the current active (non-dormant) DL BWP or a DL BWP configured with firstWithinActiveTimeBWP-Id or a DL BWP configured with firstOutsideActiveTimeBWP-Id or a First DL Active BWP (firstActiveDowninkBWP-Id) or an initial DL BWP (initialDowninkBWP) or a default DL BWP. In another example, the UE switches the cell to the dormant BWP at least when the FDRA value is valid/non-reserved. In another example, the UE switches the cell to the dormant BWP additionally/alternatively when the FDRA value is invalid/reserved. In one example, at least when a corresponding FDRA value is invalid/reserved, UE discards the BWP index for the cell (e.g., no BWP switching). In another example, the UE discards the BWP index for the cell (e.g., no BWP switching) additionally/alternatively when the FDRA value is valid/non-reserved. In one example, the DCI fields corresponding to the cell can be used for other operations, such as validation or indication of SCell dormancy, (enhanced) Type-3 HARQ-ACK CB trigger, HARQ-ACK CB retransmission, CG/semi-persistent scheduling (SPS) activation or release, TCI state indication, and so on. In one example, a valid FDRA for the cell is regarded as error case, and UE behavior is undefined. For example, the UE does not expect valid FDRA for such cell.

In one example, invalid FDRA values for DCI format 1_3 can be only used when ScheduledCellCombo-ListDCI-1-3 is not configured. In another example, a DCI 1_3 can include invalid FDRA value even though ScheduledCellCombo-ListDCI-1-3 is configured, such as for validation or indication of other UE operations such as enhanced Type-3 HARQ-ACK CB trigger or HARQ-ACK CB retransmission, or SCell dormancy, or TCI state indication, or CS/SPS activation or release, and so on. For example, invalid FDRA values can be present in DCI format 1_3 regardless of whether or not ScheduledCellCombo-ListDCI-1-3 is configured.

In one example, determination of a non-scheduled cell is based on invalid/reserved FDRA. For example, any cell with invalid/reserved FDRA value in DCI 0_3/1_3 is regarded as not scheduled. In another example, a combination of DCI fields can be used to indicate different UE operations. For example, when FDRA is invalid and NDI=0 for a cell, the cell is not scheduled, and corresponding DCI fields are not used for SCell dormancy indication. For example, when the FDRA is invalid and NDI=1 for a cell, the cell is not scheduled, and corresponding DCI fields are used for SCell dormancy indication. For example, other DCI fields can be used for such validation, such as one-shot HARQ-ACK field or HARQ-ACK retransmission field.

In one example, if a bandwidth part indicator field is configured in a DCI format and indicates an UL BWP or a DL BWP different from the active UL BWP or DL BWP, respectively, the UE shall
for each information field in the DCI format
   if the size of the information field is smaller than the one required for the DCI format interpretation for the UL BWP or DL BWP that is indicated by the bandwidth part indicator, the UE prepends zeros to the information field until its size is the one required for the interpretation of the information field for the UL BWP or DL BWP prior to interpreting the DCI format information fields, respectively
   if the size of the information field is larger than the one required for the DCI format interpretation for the UL BWP or DL BWP that is indicated by the bandwidth part indicator, the UE uses a number of least significant bits of the DCI format equal to the one required for the UL BWP or DL BWP indicated by bandwidth part indicator prior to interpreting the DCI format information fields, respectively
   for a DCI format 0_3, or for a DCI format 1_3, and for an information field that includes a number of blocks [5, TS 38.212], the above procedures apply separately for each block of the information field
   for a DCI format 0_3, or for a DCI format 1_3, and for an information field (except for TDRA field) that indicates an entry, in a higher layer parameter list, that contains a corresponding index for each cell in the scheduled cell set [5, TS 38.212], the above procedures apply separately for each index of the entry indicated by the information field
set the active UL BWP or DL BWP to the UL BWP or DL BWP indicated by the bandwidth part indicator in the DCI format

In one example, if the higher layer parameter ScheduledCellCombo-ListDCI-1-3 for the scheduled cell set is not configured or if DCI format 1_3 is used for any of the indications as described in Clauses 9.1.4, 9.1.5, and 10.3 of [5, TS 38.213], each block of the FDRA field of a DCI format 1_3 is also used to indicate whether the corresponding cell is scheduled or not as follows:
if all bits of a block are set to 0 for resource allocation type 0 or set to 1 for resource allocation type 1 or set to 0 or 1 for dynamic switch resource allocation type, the cell corresponding to the block is not scheduled;
otherwise, the cell corresponding to the block is scheduled.

In one example, when tci-PresentInDCI is set as ‘enabled’ or tci-PresentDCI-1-2 is configured for the CORESET, a UE configured with dl-OrJointTCI-StateList with activated TCI-State or ul-TCI-StateList with activated TCI-UL-State receives DCI format 1_1/1_2/1_3 providing indicated TCI-State(s) and/or TCI-UL-State(s) for a CC or all CCs in the same CC list configured by simultaneousU-TCI-UpdateList1-r17, simultaneousU-TCI-UpdateList2-r17, simultaneousU-TCI-UpdateList3-r17, simultaneousU-TCI-UpdateList4-r17. The DCI format 1_1/1_2 can be with or without, if applicable, DL assignment. If the DCI format 1_1/1_2/ is without DL assignment, the UE can assume the following:
CS-RNTI is used to scramble the CRC for the DCI
The values of the following DCI fields are set as follows:
   RV=all ‘1’s
   MCS=all ‘1’s
   NDI=0
   Set to all ‘0’s for FDRA Type 0, or all ‘1’s for FDRA Type 1, or all ‘0’s for dynamicSwitch (same as in Table 10.2-4 of [6, TS 38.213]).

If the DCI format 1_3 is without DL assignment for one or more cells from an indicated scheduled cell set scheduledCellListDCI-1-3-r18, the UE can assume the following:
C-RNTI is used to scramble the CRC for the DCI, and
FDRA blocks corresponding to the one or more cells are set to all ‘0’s for FDRA Type 0, or all ‘1’s for FDRA Type 1, or all ‘0’s or all ‘1’s for dynamicSwitch, or
the one or more cells are not included in the cell combination ScheduledCellCombo-ListDCI-1-3 indicated by the Scheduled cells indicator field.

In one example, an open-loop power control (OLPC) parameter set indication field in DCI format 0_3 is defined as follows:
Open-loop power control parameter set indication—

$${max}_{r ∈ \{ 1 , 2 , … , {N}_{c e l l}^{UL , 2} \}} {M}_{o} ( r )$$

bits applying to the scheduled cells with Mₒ(r)>0 independently, where r is mapped to the cells according to an ascending order of a serving cell index with r=1 corresponding to the cell with the smallest serving cell index, and Mₒ(r) is defined by the following:
   0 bit if the higher layer parameter p0-PUSCH-SetList is not configured;
   1 or 2 bits otherwise,
      1 bit if Mₛ(r)>0 corresponding to serving/scheduled cell index with r for the case of SRI-DCI0-3=type1a or SRI block corresponding to serving/scheduled cell index with r for the case of SRI-DCI0-3=type2 is present in the DCI format 0_3;
1 or 2 bits as determined by higher layer parameter olpc-ParameterSetDCI-0-1 if Mₛ(r)=0 corresponding to serving/scheduled cell index with r for the case of SRI-DCI0-3=type1a or SRI block corresponding to serving/scheduled cell index with r for the case of SRI-DCI0-3=type2 is not present in the DCI format 0_3.

For example, for determination of a transmission power for and corresponding power control parameters of one or more PUSCHs on one or more cells scheduled by a DCI format 0_3, the following method can be applied.
If the DCI format also includes an open-loop power control parameter set indication field and a value of the open-loop power control parameter set indication field is ‘1’ and if the DCI format scheduling the PUSCH transmission includes an SRI field [or provides an SRI index] for the corresponding serving cell, the UE determines a value of P_{O_UE_PUSCH,b,f,c}(J) from a first value in P0-PUSCH-Set with a p0-PUSCH-SetId value mapped to the SRI field value.

For example, SRI field/index and corresponding parameters can be defined as follows: SRS resource indicator−number of bits determined by the following:
If SRI-DCI0-3=type1a is configured by higher layer,

$${max}_{r ∈ \{ 1 , 2 , … , {N}_{c e l l}^{UL , 2} \}} {M}_{s} ( r )$$

bits applying to the scheduled cells with Mₛ(r)>0 independently, where N_{cell}^{UL,2} is the number of cells configured by higher layer parameter ScheduledCell-ListDCI-0-3 in the scheduled cell set, r is mapped to the cells according to an ascending order of a serving cell index with r=1 corresponding to the cell with the smallest serving cell index, and Mₛ(r) is defined below.
If SRI-DCI0-3=type2 is configured by higher layer,
   block number 1, block number 2, . . . , block number N_{cell}^{UL}
Each block corresponds to the SRS resource indicator for a scheduled cell, and the blocks are placed according to an ascending order of a serving cell index, with block number 1 corresponding to the SRS resource indicator for the cell with the smallest serving cell index. Each block is defined below.
Mₛ(r) above for the case of SRI-DCI0-3=type1a or each block above for the case of SRI-DCI0-3=type2 is defined by the following:

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉$$

bits according to Tables 7.3.1.1.2-28/29/30/31 if the higher layer parameter txConfig=nonCodebook, where N_{SRS} is the number of configured SRS resources in the first SRS resource set configured by higher layer parameter srs-ResourceSetToAddModList, and associated with the higher layer parameter usage of value ‘nonCodeBook’ and
   if UE supports operation with maxMIMO-Layers and the higher layer parameter maxMIMO-Layers of PUSCH-ServingCellConfig of the serving cell is configured, Lₘₐₓ is given by that parameter
   otherwise, Lₘₐₓ is given by the maximum number of layers for PUSCH supported by the UE for the serving cell for non-codebook-based operation.
┌log₂(N_{SRS})┐ bits according to Tables 7.3.1.1.2-32, 7.3.1.1.2-32A and 7.3.1.1.2-32B if the higher layer parameter txConfig=codebook, where N_{SRS} is the number of configured SRS resources in the first SRS resource set configured by higher layer parameter srs-ResourceSetToAddModList, and associated with the higher layer parameter usage of value ‘codeBook’.

In one example for cell-common or Type-1A fields in a DCI format 0_3 or 1_3, it is possible that a Type-1A DCI field, even after the DCI field size matching (via truncation or zero-padding) provides a value that is invalid for a co-scheduled cell. For example, the SRI field in DCI 1_3 can be configured as a Type-1A field and provide a value ‘11’=3, which is well-defined for cell #1 that is configured with N_{SRS}=4 SRS resources, while for cell #2 with N_{SRS}=3 SRS resources, only SRI values {0, 1, 2} are applicable and SRI=3 is “reserved” for the cell. The UE behavior needs to be clarified in such cases. For example, a common SRI indication table can be applied to all co-scheduled cells. For example, the same columns or parameters for corresponding tables can be configured or applied for all co-scheduled cells, such as same max number of rank, number of layers, number of SRS resources, coherent or non-coherent or partial coherent parameter, codebook structure, and so on. In another example, such parameters can be different among different cells in a set of cells or among different co-scheduled cells. Similar examples and method can apply to one or more of other Type-1A fields, such as TPMI and CACP. For example, such Type-1A fields can have 2 or more bits. In another method, similar method can apply to other fields such as Type-2 or cell-specific fields or Type-1B fields based on multi-cell joint mapping, or Type-1C fields that apply to only one cell or only some cells from the set of cells for multi-cell scheduling, and so on.

In one example, when the DCI format 0_3 or 1_3 indicates a value that is invalid for a DCI field, such as a Type-1A or cell-common DCI field, such as one or more of SRI, TPMI, CACP, the UE ignores the DCI field and transmits the corresponding PUSCH or received the corresponding PDSCH without using the invalid information.

In one example, the UE expects that the corresponding configurations are common/same among the co-scheduled cells or among the cells in the corresponding set of cells, so that the DCI 0_3/1_3 does not include such invalid values.

In another example, the UE expects that only valid values are used, and invalid values are not expected. For example, the configurations for the corresponding parameters can be different, and the DCI 0_3/1_3 only indicates values that are result in valid values for all co-scheduled cells.

In another example, when the UE receives a DCI format 0_3/1_3 with such invalid values, the UE treats the corresponding information as inconsistent information. For example, the UE does not transmit a PUSCH or receive a PDSCH that corresponds to such invalid values.

In another example, the UE determines valid values from the indicated invalid values. For example, the UE transmits a PUSCH or receives a PDSCH corresponding to the indicated invalid value, based on a reference valid value, such as a parameter value equal to or corresponding to value or index 0, or a smallest configured/supported valid value or index, or a largest configured/supported valid value or index, and so on.

In another example, the UE uses a mapping among invalid values and valid values. For example, when the UE is provided N valid values for a parameter/field, the UE uses a modulo operation, such as {value mod N} to determine a valid value. Accordingly, the UE transmits the PUSCH or receives the PDSCH using such valid value.

In one example, the UE applies different methods for different DCI fields. For example, for CACP field, the UE expects a same configuration for different cells in the set of cells or different co-scheduled cells, so that invalid values in the DCI do not happen, while for SRI or TPMI, the UE determines a valid value from the invalid value or applies a reference values, such as a reference valid value.

In one example, a DCI format can indicate an invalid TCI state for a cell. For example, the invalid TCI state can be a TCI state for a cell that is not among the activated TCI states for the cell. For example, the cell can discard the invalid TCI state. For example, the UE does not consider the indicated TCI state as an “indicated” TCI state. For example, the UE determines the DCI information as inconsistent information, and discards the scheduling information for the cell or for all cells scheduled by the DCI format. For example, the UE does not receive a PDSCH that corresponds to the indicated invalid TCI state.

For example, the UE determines a valid TCI states from the invalid TCI state provided by the DCI format. For example, the UE uses a mapping from invalid TCI states to valid TCI states, such as activated TCI states for the cell. For example, when the UE is provided N valid/activated TCI states for a cell, the UE uses a modulo operation, such as {TCI state index mod N} to determine a valid/activated TCI state. For example, the UE receives the PDSCH using such valid/activated TCI state. For example, the UE determines such valid TCI state as an “indicated” TCI state for the cell.

For example, when the UE receives such an invalid TCI state, the UE can use a reference TCI state for the cell. For example, the UE receives the PDSCH using a reference TCI state. For example, the UE applies a reference TCI state as an “indicated” TCI state for the cell. For example, the reference TCI state can be a (configured or) valid/activated TCI states with lowest index, or with index 0, or a TCI state corresponding to a reference channel or signal, such as a TCI state corresponding to the lowest index CORESET in the corresponding (source or target) BWP, or in the active BWP, or in a lowest (or highest) index BWP. For example, the reference TCI state can be a TCI state corresponding to the lowest index PUCCH resource, such as common PUCCH or dedicated PUCCH, in a corresponding (source or target) BWP, or in the active BWP, or in a lowest (or highest) index BWP. For example, the reference TCI state can be a TCI state or QCL with SSB/CSI-RS corresponding to a last PRACH transmission. For example, a reference TCI state can be a default TCI state for the cell. For example, a reference/default TCI state for a cell can be configured to the UE. For example, the reference TCI state can be a TCI state for reception of the PDCCH that provides the scheduling DCI format.

In one example, determination of the UE behavior can be based on a UE capability or a gNB configuration for the UE. For example, the UE can apply a first method such as discarding the TCI state) for a first UE capability or gNB configuration, such as when operating with unified TCI states, and the UE can apply a second method such as determining a valid TCI state from the invalid TCI state or applying a reference TCI state for a second UE capability or gNB configuration, such as when operating with legacy Rel-15/16 non-unified TCI states. The first method and the second method can be any of the methods previously described.

In one example, the joint multi-cell table tci-ListDCI-1-3-r18 for configuration of TCI state combinations for DCI format 1_3 is provided by RRC signaling. For example, entries TCI-DCI-1-3-r18 of the joint multi-cell TCI table tci-ListDCI-1-3-r18 can be configured by RRC, or can be combinations/tuples of indexes of TCI states that are activated by MAC-CE commands for each cell from the set of cells. Accordingly, MAC-CE can update the underlying TCI states. For example, the MAC-CE update can render the RRC-configured entries TCI-DCI-1-3-r18 inapplicable or invalid.

For example, at time TO, the UE may have better channel conditions with a first set of MAC-CEs that activate a set of 8 TCI states, with codepoints 0-7, for each cell from a set of cells {1, 2, 3, 4}. Accordingly, RRC configures a joint multi-cell TCI table tci-ListDCI-1-3-r18 with up to 16 entries TCI-DCI-1-3-r18, with a certain entry, say entry #2, as follows: (7, 1, 2, 5). At a later time T1, the UE may have moved and/or experiencing degraded channel conditions, so a second MAC-CE updates the activated TCI states for cell #1 to include fewer, e.g., only 4 TCI states with codepoints 0-3. For example, any entry of the joint multi-cell TCI table that includes a TCI state index>3 for cell #1, including entry #2, may become invalid for the cell.

For example, when the UE supports or is configured to operate with unified TCI state framework for a cell, in one example, the UE discards the ‘TCI index’ of the DCI format 0_3 and does not consider that as an “indicated” TCI state for the scheduled cell. For example, the UE applies a previously indicate TCI state for the cell.

For example, when the UE does not support or is not configured to operate with the unified TCI state framework, the UE can determine a beam for the corresponding PDSCH reception, using for example, a Rel-15/16 default beam (e.g., a reference beam corresponding to PDCCH/CORESET), or a reference TCI state (e.g., with TCI state index=0).

In one embodiment, for a UE that is capable of multi-cell scheduling, the UE can report a capability for a number of unicast DCI formats that the UE can process per slot or per a number of consecutive slots. A unicast DCI format can be a single-cell scheduling DCI (SC-DCI) format such as DCI format 0_0/1_0/0_1/1_1/0_2/1_2 or a multi-cell scheduling DCI (MC-DCI) format 0_3/1_3. There can be various options in terms of processing only one of MC-DCI or SC-DCI or both of them and also in terms of counting the processed unicast DCI formats per scheduled cell or per set of cells for multi-cell scheduling.

In one option, the UE capability can be to process 1 (or 2) unicast DCI formats (SC-DCI or MC-DCI) per set of cells for multi-cell scheduling (for example, 1 unicast DCI scheduling DL, or 1 unicast DCI scheduling UL for FDD scheduling cell, or 2 unicast DCIs scheduling UL for TDD scheduling cell).

In another option, the UE capability can be to process either 1 (or 2) unicast MC-DCI formats per set of cells, or 1 (or 2) unicast SC-DCI formats per scheduled cell (in the set of cells). For example, when the UE detects a DL MC-DCI format 1_3 in a slot for a set of cells, the UE does not need to detect any DL SC-DCI for any cell in the set of cells in that slot (when scheduling cell has an SCS that is smaller than or equal to an SCS of the set of cells). For example, when the UE does not detect a DL MC-DCI format 1_3 in a slot for a set of cells, the UE capability can be to process 1 DL SC-DCI for each cell in the set of cells in that slot. For example, the UE capability can be processing either 1 UL MC-DCI for a set of cells for multi-cell scheduling in a slot; otherwise, 1 UL SC-DCI for each cell from the set of cells in the slot, for FDD scheduling cell. For example, the ULE capability can be processing either 2 UL MC-DCI for a set of cells for multi-cell scheduling in a slot; otherwise, 2 UL SC-DCIs for each cell from the set of cells in the slot, for TDD scheduling cell.

In another option, the UE capability can be to process 1 (or 2) unicast DCI formats (SC-DCI or MC-DCI) for a reference cell of a set of cells for multi-cell scheduling, and also process 1 (or 2) unicast SC-DCI formats for each non-reference cell from the set of cells.

In yet another option, the UE capability can be to process 1 (or 2) unicast MC-DCI formats per set of cells and also processes 1 (or 2) unicast SC-DCI formats per scheduled cell (in the set of cells).

In various options, the number of unicast MC-DCI/SC-DCI are per slot of scheduling cell when the scheduling cell has an SCS configuration that is smaller than or equal to an SCS configuration of the set of cells, or are per N consecutive slots of the scheduling cell when the scheduling cell has an SCS configuration that is N times larger than (e.g., N=2, 4, 8, . . . ) a SCS configuration of the set of cells.

In yet another option, the UE capability can be to process 1 (or 2) unicast DCI (MC-DCI or SC-DCI) per set of cells when the UE is configured to monitor a PDCCH for MC-DCI in the 1 slot or N consecutive slots of the scheduling cell and UE can process 1 (or 2) unicast SC-DCI per scheduled cell (in the set of cells) when the UE is not configured to monitor a PDCCH for MC-DCI in the 1 slot or N consecutive slots of the scheduling cell.

In a further option, the UE capability can be to process 1 (or 2) unicast MC-DCI per set of cells per 1 slot or per N consecutive slots of the scheduling cell and to process 1 (or 2) unicast SC-DCI for each cell from the set of cells that is not scheduled by the MC-DCI in the 1 or N slots.

In one example, the options for processing MC-DCI and SC-DCI can be conditioned on the UE supporting both a first UE capability for MC-DCI processing and also a second UE capability for SC-DCI processing. For example, for a UE that reports a first UE capability only for MC-DCI processing and does not report a second UE capability for SC-DCI processing, the first UE capability can be to process 1 (or 2) unicast MC-DCIs per set of cells per 1 slot or per N consecutive slots of the scheduling cell and no processing of any SC-DCI for any cell from the set of cells. In another example, the UE capability can be to process 1 (or 2) unicast MC-DCIs per set of cells per 1 slot or per N consecutive slots of the scheduling cell and no processing of any SC-DCI for any cell from the set of cells (regardless of support or no support for a second UE capability for SC-DCI processing).

In one example, a UE capability for processing both MC-DCI and SC-DCI can be restricted to certain cells and no SC-DCI processing may be supported for other cells in the set of cells. For example, the UE capability can be to process one or both of 1 (or 2) MC-DCI per set of cells and/or 1 (or 2) SC-DCI for one or more of a primary cell (PCell) or a PSCell or an sPCell or a PUCCH-SCell or a secondary PUCCH-SCell or a scheduling cell of the set of cells, or a reference cell of the set of cells (as described herein) per 1 slot or per N consecutive slots of the scheduling cell, while for other cells in the set of cells, the UE is not expected to process any SC-DCI in the 1 or N slots. For example, the UE does not process SC-DCI for such other cells regardless of whether or not the MC-DCI schedules a PDSCH/PUSCH on any cell from such other cells. For example, the UE processes 1 (or) unicast SC-DCI for each cell from the one or more of a primary cell (PCell) or a PSCell or an sPCell or a PUCCH-SCell or a secondary PUCCH-SCell or a scheduling cell of the set of cells, or a reference cell of the set of cells when the cell is not scheduled by the MC-DCI in the 1 or N slots.

In one example, the UE capability for processing SC-DCI in addition to/in parallel with MC-DCI can be restricted to certain DCI formats or certain RNTI. For example, a unicast SC-DCI in options and examples can refer (only) to DCI format 0_0/10, or (only) to DCI format 0_1/11, or (only) for SC-DCI formats with CRC scrambled by one or more of: system information RNTI (SI-RNTI), random access RNTI (RA-RNTI), paging RNTI (P-RNTI), configured scheduling RNTI (CS-RNTI), temporary cell RNTI (TC-RNTI), MsgB-RNTI, semi-persistent CS-RNTI (SP-CSI-RNTI), and so on.

In various options, the number “1 (or 2)” unicast SC-DCI/MC-DCI refers, for example, to 1 DCI scheduling DL, or 1 DCI scheduling UL from an FDD scheduling cell, or 2 DCIs scheduling UL from a TDD scheduling cell. In various options, separate (advanced) UE capabilities can be defined by replacing the number “1 (or 2)” with a number X, where X can have a value set such as {2} or {2, 4} or {2, 4, 6} or {2, 4, 8}, or {2, 4, 6, 8}, or {1, 2}, {1, 2, 4} or {1, 2, 4, 8}, {1, 2, 4, 6} or {1, 2, 4, 6, 8}. For example, parameter X for the advanced UE capabilities can be defined in terms of a parameter N that is the SCS ratio between the SCS of the scheduling cell and the SCS of the set of co-scheduled cells. For example, parameter X can take value from a value set {1, 2¹, 2², . . . , N} where N=2^{μ}^{₁}^{μ}^{₂} with μ₁ and μ₂ corresponding to SCS configurations of the (active BWPs) of the set of co-scheduled cells and the scheduling cell, respectively (or vice versa). For example, the advanced UE capability can be applicable (only) for the low-to-high SCS scenario, wherein the SCS configuration of the scheduling cell is smaller than or equal to an SCS configuration for the set of cells for multi-cell scheduling. For example, parameter X for the advanced UE capabilities can be defined in terms of a (maximum) number of cells in the set of cells. For example, parameter X can take value from a value set {1, 2, 3, 4} or a value set {1, 2, . . . , M} where M is a maximum number of cells in a set of cells that is supported by the UE or a maximum number of co-scheduled cells by an MC-DCI format 0_3/1_3 that is supported by the UE (for a corresponding band or band combination). In one example, a value set of X can be based on both the SCS ratio and the number of co-scheduled cells, so that parameter X can take value from a value set {1, 2¹, 2², . . . , N}×{1, 2, 3, 4} or {1, 2¹, 2², . . . , N}×{1, 2, . . . , M}, where M is as defined herein, and operation ‘x’ refers to cartesian product of two sets of cells. In one example, value 1 can be excluded from the value sets and only values>1 can be reported.

In one example, the advanced UE capabilities can be defined with certain restrictions. For example, the value X only refers to a number of unicast MC-DCI per set of cells per 1 or N consecutive slots and does not apply to a number of unicast SC-DCIs in the 1 or N slots that the UE can process. For example, the UE does not processes any unicast SC-DCI for any cell from the set of cells in the 1 or N slots, or the UE can process only 1 (or 2) unicast SC-DCI in the 1 or N slots for each cell from the set of cells or for each cell from the set of cells that is not scheduled by any of the X unicast MC-DCIs, or for each cell from the one or more of a primary cell (PCell) or a PSCell or an sPCell or a PUCCH-SCell or a secondary PUCCH-SCell or a scheduling cell of the set of cells, or a reference cell of the set of cells, and so on. For example, the UE can process more than 1 (or 2) unicast SC-DCIs in the 1 or N slots for a cell (as described herein) when the UE separately report an Advanced capability for processing multiple SC-DCIs in 1 or N slots.

In one example, the X unicast MC-DCIs in 1 or N slots can be for separate cell combinations/subsets from the set of cells. While in another example, the X unicast MC-DCIs in 1 or N slots can be for overlapping or identical cell combinations/subsets from the set of cells.

In one example, the Advanced UE capability for MC-DCI can be based on a maximum number of PDSCHs/PUSCHs that can be scheduled on a same cell per 1 slot or N consecutive slots using one or more MC-DCIs. For example, the UE capability can be to process Y unicast MC-DCI formats per 1 slot or N slots wherein the Y MC-DCI formats can be such that any cell from the set of cells can be scheduled up to X PDSCHs/PUSCHs per 1 slot or N consecutive slots. For example, Y≥X. For example, the value Y may not be reported by the UE and can be up to gNB scheduling or configuration implementation. For example, when the set of cells includes cells {1, 2, 3, 4} and UE reports X=2, the UE can process all of the following MC-DCI formats: a first MC-DCI format scheduling cells {1, 2, 3}, a second MC-DCI scheduling cells {1, 2, 4}, and a third MC-DCI format scheduling cells {3, 4}, so that Y=3; alternatively, the UE can process all of the following MC-DCI formats: a first MC-DCI scheduling cells {1, 2}, a second MC-DCI scheduling cells {2, 3}, a third MC-DCI scheduling cells {3, 4}, and a fourth MC-DCI scheduling cells {1, 4}, so that Y=4.

For example, a UE feature group (FG) 49-1 can refer to a UE capability for DL multi-cell scheduling via DCI format 1_3 when the scheduling cell has same SCS configuration as the set of cells for multi-cell scheduling. For example, FG 49-1b can refer to a UE capability for DL multi-cell scheduling via DCI format 1_3 when the scheduling cell has different SCS configuration than the set of cells for multi-cell scheduling. For example, FG 49-2 can refer to a UE capability for UL multi-cell scheduling via DCI format 0_3 when the scheduling cell has same SCS configuration as the set of cells for multi-cell scheduling. For example, FG 49-2b can refer to a UE capability for UL multi-cell scheduling via DCI format 0_3 when the scheduling cell has different SCS configuration than the set of cells for multi-cell scheduling.

For example, a component in FG 49-1 can be for a number of unicast DCI formats that the UE can process:
One unicast DCI (SC-DCI or MC-DCI) for scheduling DL per slot per reference cell of a set of cells configured for multi-cell scheduling & one unicast SC-DCI for scheduling DL per slot per non-reference cell of the set of cells, for FDD/TDD scheduling cell.

For example, a component in FG 49-2 can be for a number of unicast DCI formats that the UE can process:
One unicast DCI (SC-DCI or MC-DCI) for scheduling UL per slot per reference cell of a set of cells configured for multi-cell scheduling & one unicast SC-DCI for scheduling UL per slot per non-reference cell of the set of cells, for FDD scheduling cell.
Two unicast DCIs (SC-DCI or MC-DCI) for scheduling UL per slot per reference cell of a set of cells configured for multi-cell scheduling & two unicast SC-DCIs for scheduling UL per slot per non-reference cell of the set of cells, for TDD scheduling cell.

For example, a component in FG 49-1b can be for a number of unicast DCI formats that the UE can process:
For low-to-high SCS:
   One unicast DCI (SC-DCI or MC-DCI) for scheduling DL per slot of scheduling cell per reference cell of a set of cells configured for multi-cell scheduling & one unicast SC-DCI for scheduling DL per slot of scheduling cell per non-reference cell of the set of cells, for FDD/TDD scheduling cell.
For high-to-low SCS:
   One unicast DCI (SC-DCI or MC-DCI) for scheduling DL per N consecutive slots of scheduling cell per reference cell of a set of cells configured for multi-cell scheduling & one unicast SC-DCI for scheduling DL per N consecutive slots of scheduling cell per non-reference cell of the set of cells, for FDD/TDD scheduling cell.
   N=2 for (30, 15), (60, 30), (120, 60), (240, 120), and (480, 240); N=4 for (60, 15), (120, 30), (240, 60), and (480, 120); N=8 for (120, 15), (240, 30), and (480, 60); N=16 for (240, 15), (480, 30); N=32 for (480, 15).

For example, a component in FG 49-2b can be for a number of unicast DCI formats that the UE can process:
For low-to-high SCS:
   One unicast DCI (SC-DCI or MC-DCI) for scheduling UL per slot of scheduling cell per reference cell of a set of cells configured for multi-cell scheduling & one unicast SC-DCI for scheduling UL per slot of scheduling cell per non-reference cell of the set of cells, for FDD scheduling cell.
   Two unicast DCIs (SC-DCI or MC-DCI) for scheduling UL per slot of scheduling cell per reference cell of a set of cells configured for multi-cell scheduling & two unicast SC-DCIs for scheduling UL per slot of scheduling cell per non-reference cell of the set of cells, for TDD scheduling cell.
For high-to-low SCS:
   One unicast DCI (SC-DCI or MC-DCI) for scheduling UL per N consecutive slots of scheduling cell per reference cell of a set of cells configured for multi-cell scheduling & one unicast SC-DCI for scheduling UL per N consecutive slots of scheduling cell per non-reference cell of the set of cells, for FDD scheduling cell.
   Two unicast DCIs (SC-DCI or MC-DCI) for scheduling UL per N consecutive slots of scheduling cell per reference cell of a set of cells configured for multi-cell scheduling & two unicast SC-DCIs for scheduling UL per N consecutive slots of scheduling cell per non-reference cell of the set of cells, for TDD scheduling cell.
   N=2 for (30, 15), (60, 30), (120, 60), (240, 120), and (480, 240); N=4 for (60, 15), (120, 30), (240, 60), and (480, 120); N=8 for (120, 15), (240, 30), and (480, 60); N=16 for (240, 15), (480, 30); N=32 for (480, 15).

For example, a component in FG 49-1 (same SCS) for a baseline UE capability for a number of unicast DL DCI formats that the UE can process can be as follows:
The number of unicast DL DCI to process for each cell in a set of cells configured for multi-cell PDSCH scheduling by a DCI format 1_3:
   One unicast DCI per slot of scheduling cell for each cell in the set of cells for FDD/TDD scheduling cell.
   The unicast DCI can be either a legacy DCI format or a DCI format 1_3.
   A DCI format 1_3 can schedule more than one cell from the set of cells.

For example, a component in FG 49-2 (same SCS) for a baseline UE capability for a number of unicast UL DCI formats that the UE can process can be as follows:
The number of unicast UL DCI to process for each cell in a set of cells configured for multi-cell PUSCH scheduling by a DCI format 0_3:
   One unicast DCI per slot of scheduling cell for each cell in the set of cells for FDD scheduling cell.
   Two unicast DCI per slot of scheduling cell for each cell in the set of cells for TDD scheduling cell.
unicast DCI can be either a legacy DCI format or a DCI format 0_3.
A DCI format 0_3 can schedule more than one cell from the set of cells.

For example, a component in FG 49-1b (different SCS) for a baseline UE capability for a number of unicast DL DCI formats that the UE can process can be as follows:
For low-to-high SCS:
   One unicast DCI per slot of scheduling cell for each cell in the set of cells for FDD/TDD scheduling cell.
For high-to-low SCS:
   One unicast DCI per N consecutive slots of scheduling cell for each cell in the set of cell for FDD/TDD scheduling cell.
   N=2 for (30, 15), (60, 30), (120, 60), (240, 120), and (480, 240); N=4 for (60, 15), (120, 30), (240, 60), and (480, 120); N=8 for (120, 15), (240, 30), and (480, 60); N=16 for (240, 15), (480, 30); N=32 for (480, 15).
unicast DCI can be either a legacy DCI format or a DCI format 1_3.
A same DCI format 1_3 can schedule more than one cell from the set of cells.

For example, a component in FG 49-2b (different SCS) for a baseline UE capability for a number of unicast UL DCI formats that the UE can process can be as follows:
For low-to-high SCS:
The number of unicast UL DCI to process for each cell in a set of cells configured for multi-cell PUSCH scheduling by a DCI format 0_3
   One unicast DCI per slot of scheduling cell for each cell in the set of cells for FDD scheduling cell
   Two unicast DCI per slot of scheduling cell for each cell in the set of cells for TDD scheduling cell
For high-to-low SCS:
The number of unicast UL DCI to process for each cell in a set of cells configured for multi-cell PUSCH scheduling by a DCI format 0_3
   One unicast DCI per N consecutive slots of scheduling cell for each cell in the set of cells for FDD scheduling cell
   Two unicast DCI per N consecutive slots of scheduling cell for each cell in the set of cells for TDD scheduling cell
   N=2 for (30, 15), (60, 30), (120, 60), (240, 120), and (480, 240); N=4 for (60, 15), (120, 30), (240, 60), and (480, 120); N=8 for (120, 15), (240, 30), and (480, 60); N=16 for (240, 15), (480, 30); N=32 for (480, 15).
The unicast DCI can be either a legacy DCI format or a DCI format 0_3
A same DCI format 0_3 can schedule more than one cell from the set of cells

In one example, when a UE does not support cross-carrier scheduling (for same or different SCS), such as FG 6-10 or FG 18-5/18-5b, or when a UE does not support joint monitoring of SC-DCI formats and MC-DCI formats on any cell from a set of cell or when a UE supports joint monitoring of SC-DCI formats and MC-DCI formats only on certain cells, such as the scheduling cell only or the reference cell (for BD/control channel elements (CCE)/DCI size counting) only, the ULE can support processing of one DCI 1_3 for the set of cells and one unicast DL SC-DCI for the scheduling cell if DCI 1_3 does not schedule the scheduling cell (at least if the scheduling cell is in the set of cells).

For example:
if UE does not support FG6-10 (cross-carrier scheduling) for some bands in the BC where the UE supports multi-cell scheduling by DCI format 1_3 for a set of cells according to 49-1:
   If the scheduling cell is in the set:
      One DCI 1_3 for the set of cells that schedules at least the scheduling cell per slot of scheduling cell; or
      One unicast DL SC-DCI (for self-scheduling) and one DCI format 1_3 for the set of cells that schedules other than the scheduling cell per slot of scheduling cell.
      In other words: one DCI 1_3 for the set of cells, AND one unicast DL SC-DCI for the scheduling cell if DCI 1_3 does not schedule the scheduling cell.
   If the scheduling cell is NOT in the set:
      One DCI 1_3 per slot of scheduling cell for the set of cells.
      For example, for cells not included in any set of cells for multi-cell scheduling, the number of unicast DCIs are per FGs for single-cell scheduling.

In one example, not supporting FG 6-10 is not a default/baseline capability for a UE supporting FG 49-1. In another example, not supporting FG 6-10 is a default/baseline capability for a UE supporting FG 49-1.

In one example, “the UE does supports FG6-10 for some bands in the BC” can be replaced with “the UE does not support joint monitoring of SC-DCI and MC-DCI for any/some scheduled cell in the set of cells”.

In another example, the sub-bullet “one DCI 1_3 for the set of cells that schedules at least the scheduling cell per slot of scheduling cell, or” can be replaced with the following:
One unicast SC-DCI (for self-scheduling) or one DCI 1_3 for the set of cells that schedules at least the scheduling cell per slot of scheduling cell.

In one example, the first sub-bullet above “If the scheduling cell is in the set” can be replaced with “If the scheduling cell is in the set and is the reference cell for the set of cells”.

In one example, when the scheduling cell is in the set but is NOT the reference cell, the UE can process one DCI 1_3 per slot of scheduling cell for the set of cells. For example, the UE cannot be configured any SC-DCI for the scheduling cell.

In one example, when a UE support cross-carrier scheduling (for same or different SCS), such as FG 6-10 or FG 18-5/18-5b, or when a UE supports joint monitoring of SC-DCI formats and MC-DCI formats on all cells in a set of cell, the UE can support processing of one DCI 1_3 for the set of cells, AND one unicast DL SC-DCI per cell in the set of cells that is not scheduled by the DCI 1_3.

For example:
If the UE supports FG6-10 for all bands in the BC where the UE supports multi-cell scheduling by DCI format 1_3 for a set of cells according to 49-1:
   For any scheduled cell in the set, one unicast DL SC-DCI or one DCI 1_3 per slot of scheduling cell.
   In other words: one DCI 1_3 for the set of cells AND one unicast DL SC-DCI per cell in the set of cells that is not scheduled by the DCI 1_3

In one example, “the UE supports FG6-10 for all bands in the BC” can be replaced with “the UE supports joint monitoring of SC-DCI and MC-DCI for a given/any scheduled cell in the set of cells”.

In one example, “for any schedule cell” can be replaced with “for a given scheduled cell”. For example, the given scheduled cell can be based on a UE capability. For example, the UE can indicate that given scheduled cell by legacy SC-DCI is one or more of {scheduling cell only, reference cell only, any cell}.

Similar methods can apply to uplink multi-cell scheduling, e.g., FG 49-2 with same SCS or FG 49-2b with different SCS.

For example, when a UE does not support cross-carrier scheduling (for same or different SCS), such as FG 6-10 or FG 18-5/18-5b, or when a UE does not support joint monitoring of SC-DCI formats and MC-DCI formats on any cell from a set of cell or when a UE supports joint monitoring of SC-DCI formats and MC-DCI formats only on certain cells, such as the scheduling cell only or the reference cell (for BD/CCE/DCI size counting) only, the UE can support:
For FDD scheduling cell: processing of one DCI 1_3 for the set of cells AND one unicast UL SC-DCI for the scheduling cell if DCI 1_3 does not schedule the scheduling cell (at least if the scheduling cell is in the set of cells).
For TDD scheduling cell: processing of two DCIs 0_3 for the set of cells AND {one unicast UL SC-DCI for the scheduling cell if one of DCIs 0_3 schedules the scheduling cell OR two unicast UL SC-DCIs for the scheduling cell if none of DCIs 0_3 schedules the scheduling cell}.

For example, when a UE support cross-carrier scheduling (for same or different SCS), such as FG 6-10 or FG 18-5/18-5b, or when a UE supports joint monitoring of SC-DCI formats and MC-DCI formats on all cells in a set of cells, the UE can support processing of:
For FDD scheduling cell, one DCI 0_3 for the set of cells AND one unicast UL SC-DCI per cell in the set of cells that is not scheduled by the DCI 0_3.
For TDD scheduling cell, two DCIs 1_3 for the set of cells AND one unicast UL SC-DCI per cell in the set of cells that is scheduled by one of the DCIs 0_3 AND two unicast UL SC-DCIs per cell in the set of cells that is scheduled by none of the DCIs 0_3.

In one example:
If UE does not support FG6-10 (cross-carrier scheduling) for some bands in the BC where the UE supports multi-cell scheduling by DCI format 0_3 for a set of cells according to 49-2:
   For FDD scheduling cell, if the scheduling cell is in the set:
      one DCI 0_3 for the set of cells that schedules at least the scheduling cell per slot of scheduling cell; or
      One unicast UL SC-DCI (for self-scheduling) and one DCI format 0_3 for the set of cells that schedules other than the scheduling cell per slot of scheduling cell.
      In other words: one DCI 1_3 for the set of cells AND one unicast UL SC-DCI for the scheduling cell if DCI 1_3 does not schedule the scheduling cell.
   For TDD scheduling cell, if the scheduling cell is in the set:
      two DCIs 0_3 for the set of cells that schedule at least the scheduling cell per slot of scheduling cell; or
      Two unicast UL SC-DCIs (for self-scheduling) and two DCI formats 0_3 for the set of cells that schedules other than the scheduling cell per slot of scheduling cell; or
      One DCI 0_3 for the set of cells that schedule at least the scheduling cell, and one unicast UL SC-DCI (for self-scheduling), and one DCI format 0_3 for the set of cells that schedules other than the scheduling cell per slot of scheduling cell.
      In other words: two DCIs 0_3 for the set of cells AND {one unicast UL SC-DCI for the scheduling cell if one of DCIs 0_3 schedules the scheduling cell OR two unicast UL SC-DCIs for the scheduling cell if none of DCIs 0_3 schedules the scheduling cell}
   If the scheduling cell is NOT in the set:
      One DCI 0_3 per slot of scheduling cell for the set of cells for FDD scheduling cell.
      Two DCIs 0_3 per slot of scheduling cell for the set of cells for TDD scheduling cell.
      For example, for cells not included in any set of cells for multi-cell scheduling, the number of unicast DCIs are per legacy FGs for single-cell scheduling.
If the UE supports [FG6-10] for all bands in the BC where the UE supports multi-cell scheduling by DCI format 0_3 for a set of cells according to 49-2:
   For FDD scheduling cell, for any scheduled cell in the set, one unicast UL SC-DCI or one DCI 0_3 per slot of scheduling cell.
   In other words: one DCI 0_3 for the set of cells, AND one unicast UL SC-DCI per cell in the set of cells that is not scheduled by the DCI 0_3.
   For TDD scheduling cell, For any scheduled cell in the set, two unicast UL SC-DCIs or two DCIs 1_3 or {one unicast UL SC-DCI and one DCI 0_3} per slot of scheduling cell.
   In other words: two DCIs 1_3 for the set of cells, AND one unicast UL SC-DCI per cell in the set of cells that is scheduled by one of the DCIs 0_3 AND two unicast UL SC-DCIs per cell in the set of cells that is scheduled by none of the DCIs 0_3.

For example, not supporting FG 6-10 is not a default/baseline capability for a UE supporting FG 49-2.

In one example, “the UE supports FG6-10 for all bands in the BC” can be replaced with “the UE supports joint monitoring of SC-DCI and MC-DCI for a given/any scheduled cell in the set of cells”.

In one example, “for any schedule cell” can be replaced with “for a given scheduled cell”. For example, the given scheduled cell can be based on a UE capability. For example, the UE can indicate that given scheduled cell by legacy SC-DCI is one or more of {scheduling cell only, reference cell only, any cell}.

In one example, not supporting FG 6-10 is not a default/baseline capability for a UE supporting FG 49-2. In another example, not supporting FG 6-10 is a default/baseline capability for a UE supporting FG 49-2.

In one example, “the UE does supports FG6-10 for some bands in the BC” can be replaced with “the UE does not support joint monitoring of SC-DCI and MC-DCI for any/some scheduled cell in the set of cells”.

In another example, the sub-bullet “one DCI 0_3 for the set of cells that schedules at least the scheduling cell per slot of scheduling cell, or” can be replaced with the following:
One unicast SC-DCI (for self-scheduling) or one DCI 0_3 for the set of cells that schedules at least the scheduling cell per slot of scheduling cell.

In one example, the first sub-bullet above “If the scheduling cell is in the set” can be replaced with “If the scheduling cell is in the set and is the reference cell for the set of cells”.

In one example, when the scheduling cell is in the set but is NOT the reference cell, the UE can process one DCI 0_3 per slot of scheduling cell for the set of cells for FDD scheduling cell, or two DCI 0_3 per slot of scheduling cell for the set of cells for TDD scheduling cell. For example, the UE cannot be configured any SC-DCI for the scheduling cell.

In one example, a new e.g., FG 49-3 or a new component in FG 49-1/49-2 can be introduced for indicating cells for which joint monitoring of SC-DCI and MC-DCI is supported. For example, the value set can include one or more of {reference cell only, scheduling cell only, any cell in the set of cells}. For example, the new FG/component can include a default value such as ‘scheduling cell only’ or ‘reference cell only’. For example, the new FG/component does not have any default value.

For example, values of the new FG/component can be used, instead of a reference to single-cell scheduling UE capabilities such as one or more of FG 6-10 or FG 18-5 or 18-5b, for a description of conditions for the number of unicast DCIs per slot that a UE capable of FG 49-1/1b/49-2/2b can process.

In one example, for UE capability of number of unicast DCIs that UE can process with different SCS between the scheduling cell and the set of cells for multi-cell scheduling with DCI 0_3/1_3:
A reference to FG 6-10 can be replaced with a reference to FG 18-5/18-5b.
For the case of high-to-low SCS, “per slot of scheduling cell” can be replaced with “per N consecutive slots of scheduling cell” where N is the SCS ratio between the scheduling cell and the set of scheduled cells.
   For example, the SCS ratio N can have one or more of the following values: N=2 for (30, 15), (60, 30), (120, 60), (240, 120), and (480, 240); N=4 for (60, 15), (120, 30), (240, 60), and (480, 120); N=8 for (120, 15), (240, 30), and (480, 60); N=16 for (240, 15), (480, 30); N=32 for (480, 15).

For example, advanced UE capabilities such as FG 49-3x and 49-3y can be evaluated for both the same SCS case (FG 49-1/49-2) and different SCS case (FG 49-1b/49-2b).
For the same SCS case, one option is to have the value range of X>1 unicast DCIs based on the (maximum) supported number of co-scheduled cells per set of cells, such as {1, 2, 3, 4} or {1, 2, . . . , M} or {1, 2, . . . , ceiling(4/M)} where M is the value reported for supported UE capability for the maximum number of co-scheduled cells.
For the case of different SCS (FG 49-1b/49-2b), value range of X>1 unicast DCIs can be based on the SCS ratio, e.g. {1, 2, 4, . . . , N} where Nis the SCS ratio, and/or the (maximum) supported number of co-scheduled cells per set of cells in Component 4, e.g., {1, 2, 3, 4} or {1, 2, . . . , M} or {1, 2, . . . , ceiling(4/M)}, including set products.

For example, when a UE does not support cross-carrier scheduling (for same or different SCS), such as FG 6-10 or FG 18-5/18-5b, or when a UE does not support joint monitoring of SC-DCI formats and MC-DCI formats on any cell from a set of cell or when a UE supports joint monitoring of SC-DCI formats and MC-DCI formats only on certain cells, such as the scheduling cell only or the reference cell (for BD/CCE/DCI size counting) only, the UE can support one or more of:
Processing n DCIs 1_3 for the set of cells, and (X-n) unicast DL SC-DCI for the scheduling cell if n DCIs 1_3 do not schedule the scheduling cell (at least if the scheduling cell is in the set of cells), with n=0, 1, . . . , X. In one example, n=1, 2, . . . , X.

In one example, when a UE support cross-carrier scheduling (for same or different SCS), such as FG 6-10 or FG 18-5/18-5b, or when a UE supports joint monitoring of SC-DCI formats and MC-DCI formats on all cells in a set of cell, the UE can support one or more of:
processing n DCI 1_3 for the set of cells, AND (X-n) unicast DL SC-DCI per cell in the set of cells that is not scheduled by the n DCIs 13, with n=0, 1, . . . , X. In one example, n=1, 2, . . . , X.

For example, when a UE does not support cross-carrier scheduling (for same or different SCS), such as FG 6-10 or FG 18-5/18-5b, or when a UE does not support joint monitoring of SC-DCI formats and MC-DCI formats on any cell from a set of cell or when a UE supports joint monitoring of SC-DCI formats and MC-DCI formats only on certain cells, such as the scheduling cell only or the reference cell (for BD/CCE/DCI size counting) only, the UE can support one or more of:
For FDD scheduling cell: processing n DCIs 1_3 for the set of cells AND (X-n) unicast UL SC-DCI for the scheduling cell if the n DCIs 1_3 do not schedule the scheduling cell (at least if the scheduling cell is in the set of cells).
For TDD scheduling cell: processing of two DCIs 0_3 for the set of cells AND (X-n) unicast UL SC-DCI for the scheduling cell if the n DCIs 0_3 do not schedule the scheduling cell.

For example, when a UE support cross-carrier scheduling (for same or different SCS), such as FG 6-10 or FG 18-5/18-5b, or when a UE supports joint monitoring of SC-DCI formats and MC-DCI formats on all cells in a set of cells, the UE can support processing of one or more of all of:
For FDD scheduling cell, n DCIs 0_3 for the set of cells AND (X-n) unicast UL SC-DCI per cell in the set of cells that is not scheduled by the n DCIs 0_3.
For TDD scheduling cell, n DCIs 1_3 for the set of cells AND (X-n) unicast UL SC-DCI per cell in the set of cells that is scheduled by the n DCIs 0_3.

In various example, n=0, 1, . . . , X. In various examples, n=1, 2, . . . , X.

In one embodiment, when a multi-cell scheduling DCI format 0_3/1_3 indicates UL/DL BWP change for at least one cell from the set of cells that is associated with the DCI format 0_3/1_3, the UE transmits the scheduled PUSCHs or receives the scheduled PDSCHs (only) if respective K2/K0 values (indicating a gap between PDCCH and corresponding PUSCH/PDSCH) indicated by respective TDRA values applicable for the at least one cell is not smaller than a BWP switching delay for the UL/DL BWP. Otherwise, the UE does not transmit PUSCHs or receive PDSCHs on (the new UL/DL BWP) of the at least cell. In one example, the UE does not transmit any of the PUSCHs or receive any of the PDSCHs on (the new UL/DL BWP of) any of the cells in the set of cells.

For example, the UE determines a K2/K0 gap between a PDCCH that provides a DCI format 0_3/1_3 and PUSCHs/PDSCHs that are scheduled by the DCI format 0_3/1_3 as a maximum among K2/K0 values provided for the respective cells (at least for the case of same SCS among the cells). For example, the UE determines a K2/K0 gap between a PDCCH that provides a DCI format 0_3/1_3 and a PUSCH/PDSCH, from the PUSCHs/PDSCHs that are scheduled by the DCI format 0_3/1_3, separately for each cell, so a first gap for a first cell, and a second gap for a second cell.

For example, a UE does not expect to detect a DCI format 1_3 or 0_3 with a BWP indicator field that indicates an active DL BWP or an active UL BWP change for all cells that are scheduled by the DCI format 1_3/03, with the corresponding time domain resource assignment field providing respective slot offset values for all PDSCH receptions or all PUSCH transmissions that are smaller than a delay required by the UE for an active DL BWP change or UL BWP change, respectively [10, TS 38.133].

For example, the UE discards a DCI format 0_3/1_3 that indicates UL/DL BWP change for all scheduled cells, and all corresponding K2/K0 gaps between the PDCCH and all corresponding PUSCHs/PDSCHs are smaller than a BWP switching delay.

For example, when the DCI format 0_3/1_3 scheduled PUSCHs/PDSCHs on cells, from a set of cells for multi-cell scheduling, and the DCI format 0_3/1_3 indicates a BWP change for first cells, from the cell, and the indicated K2/K0 gaps for the first cells are smaller than a BWP switching delay, while the DCI format 0_3/1_3 does not indicate a BWP change for second cells, from the cells, or the indicated K2/K0 gaps for the second cells are not smaller than the BWP switching delay, the UE transmits PUSCHs or receives PDSCHs on the first cells, and drops PUSCH transmissions or PDSCH receptions on the second cells.

For example, if a UE detects a DCI format 1_3 with a BWP indicator field that indicates an active DL BWP change for a cell, the UE is not required to receive or transmit in the cell during a time duration from the end of the third symbol of a slot where the UE receives the PDCCH that includes the DCI format 1_3 in a scheduling cell until the beginning of a slot indicated by the slot offset value provided for the cell by the time domain resource assignment field in the DCI format 1_3.

For example, if a UE detects a DCI format 0_3 indicating an active UL BWP change for a cell, the UE is not required to receive or transmit in the cell during a time duration from the end of the third symbol of a slot where the UE receives the PDCCH that includes the DCI format in the scheduling cell until the beginning of a slot indicated by the slot offset value provided for the cell by the time domain resource assignment field in the DCI format 0_3.

In one embodiment, when a DCI format 1_3 schedules PDSCHs on cell from a set of cells and the UE receives a PDCCH providing the DCI format 1_3 in a PDCCH monitoring occasion that is before a BWP change on a cell, from the cell, or before a BWP change for a reference cell from the set of cells, or before a BWP change for all co-scheduled cells, the UE drops HARQ-ACK information corresponding to the cell or the co-scheduled cells, for example, by including NACKs for the cell or cells.

In one example, a UE drops HARQ-ACK information for PDSCHs that are scheduled by a DCI format 1_3 in a PDCCH that is received in a PDCCH monitoring occasion m when the PDCCH monitoring occasion m is before:
an active DL BWP change on all cell that are scheduled by the DCI format 1_3; or
an active DL BWP change on at least one cell from the cells that are scheduled by the DCI format 1_3; or
an active DL BWP change on a reference cell from the cells that are scheduled by the DCI format 1_3, wherein the reference cell can be, for example, a cell with smallest (or largest) cell index or cell-level CIF among the co-scheduled cells, or a cell with a PDSCH, from the co-scheduled PDSCHs, that ends last (or starts last, or ends/starts first); or
an active DL BWP change on a reference cell from the corresponding set of cells for multi-cell scheduling, wherein the reference can be, for example, same as a reference cell for DCI size and PDCCH monitoring counting, or a scheduling cell if the scheduling cell is include in the set of cells, or a cell that is configured a (linked) search space for monitoring the DCI format 0_3/1_3, or a cell with smallest (or largest) cell index or CIF, among the cells in the set of cells; or
an active UL BWP change on the serving cell of PUCCH transmission if the UE is provided pucch-sSCellDyn or pucch-sSCellDynDCI-1-2 or pucch-sSCellDynDCI-1-3, or an active UL BWP change on the PCell if the UE is not provided pucch-sSCellDyn and pucch-sSCellDynDCI-1-2 and pucch-sSCellDynDCI-1-3.

In various example, the events are further conditioned on that an active DL BWP change is not triggered in PDCCH monitoring occasion m. In various examples, the events are further conditioned on that corresponding PDSCH receptions are after the same DL BWP change.

For example, dropping HARQ-ACK information for the PDSCHs that are scheduled by a DCI format 1_3 refers to one or more of the following:
The UE provides NACKs (alternatively, ACKs) for all co-scheduled PDSCHs regardless of whether or not a DL BWP change is triggered for the co-scheduled cells (rather than individual HARQ-ACK information for each PDSCH from the co-scheduled PDSCHs); or
The UE does not provide any HARQ-ACK information for the co-scheduled cells and the monitoring occasion m; or
The UE provides NACKs (alternatively, ACKs) for first PDSCHs on first cells for which the DCI format 1_3 indicates a DL BWP change, and the ULE provides HARQ-ACK information for second PDSCHs on second cells for which the DCI format 1_3 does not trigger a DL BWP change.

In one example, an MC-DCI format 0_3/1_3 can be in association with C-RNTI and modulation and coding scheme-cell radio network temporary identifier (MCS-C-RNTI). For example, configured grant (CG) PUSCH or semi-persistent scheduled (SPS) PDSCH activation and release can be based on legacy SC-DCI formats associated with CS-RNTI. In another example, an MC-DCI format 0_3/1_3 can also support CS-RNTI and {NDI, HPN, RV, MCS, FDRA} fields that are cell-specific/Type-2 can be used for CG/SPS activation or release. For example, such operation applies to any UE capable of DCI format 0_3/1_3. In another example, such operation applies at least to MC-DCI-capable UEs that cannot support SC-DCI or that support SC-DCI only for self-scheduling of the scheduling cell, such as UEs that support scheduling of other cells via MC-DCI.

In another example, a DCI format 0_3/1_3 with CRC scrambled via C-RNTI or MCS-C-RNTI can be used for CG/SPS activation or release. For example, certain DCI fields such as one or more of {NDI, HPN, RV, MCS, FDRA} can be used for validation of SPS/CG activation or release. In one example, the repurposing can apply to CG/SPS release only and may not be used for CG/SPS activation. For example, the UE determines CG/SPS release from non-scheduled cells with invalid FDRA, in combination with other DCI fields that are used for CG/SPS release validation.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method comprising:
receiving:
first information for a set of serving cells that includes a first serving cell and a second serving cell,
second information for a first table, wherein:
the first table includes a first number of rows,
a first row, from the first number of rows, includes first time-domain resource allocation (TDRA) indexes and second TDRA indexes,
the first TDRA indexes indicate respective first time-domain resources that have a first one-to-one mapping with first downlink (DL) bandwidth parts (BWPs) of the first serving cell, and
the second TDRA indexes indicate respective second time-domain resources that have a second one-to-one mapping with second DL BWPs of the second serving cell, and
a downlink control information (DCI) format that schedules a reception of a first physical downlink shared channel (PDSCH) on the first serving cell and a reception of a second PDSCH on the second serving cell, wherein:
a value of a TDRA field in the DCI format indicates the first row of the first table, and
a value of a BWP indicator field in the DCI format indicates:
a first DL BWP, from the first DL BWPs, of the first serving cell, and
a second DL BWP, from the second DL BWPs, of the second serving cell;
determining:
a first time-domain resource, from the first time-domain resources, wherein the first time-domain resource:
is indicated by a first TDRA index, from the first TDRA indexes, and
is mapped to the first DL BWP based on the first mapping, and
a second time-domain resource, from the second time-domain resources, wherein the second time-domain resource:
is indicated by a second TDRA index, from the second TDRA indexes, and
is mapped to the second DL BWP based on the second mapping; and
receiving:
the first PDSCH in the first time-domain resource on the first DL BWP of the first serving cell, and
the second PDSCH in the second time-domain resource on the second DL BWP of the second serving cell.

2. The method of claim 1, further comprising:
receiving:
third information for values, corresponding to the first DL BWP of the first serving cell, for a parameter associated with a field in the DCI format, wherein the field is one of a rate-matching indicator field, a zero-power (ZP) channel state information reference signal (CSI-RS) trigger field, a sounding reference signal (SRS) request field, an SRS offset indicator field, or a transmission configuration indication (TCI) field, and
fourth information for a second table corresponding to the field, wherein:
the second table includes a second number of rows,
a second row, from the second number of rows, includes a first index for the first serving cell and a second index for the second serving cell,
the first index applies to any of the first DL BWPs of the first serving cell,
the second index applies to any of the second DL BWPs of the second serving cell, and
a value of the field in the DCI format indicates the second row of the second table; and
determining a value, from the values, for the parameter that is associated with the first index,
wherein receiving the first PDSCH further comprises receiving the first PDSCH based on the value.

3. The method of claim 1, further comprising:
receiving:
third information for first values for a field in the DCI format, wherein the first values are associated with the first DL BWP of the first serving cell, and
fourth information for second values for the field in the DCI format, wherein the second values are associated with a third DL BWP of the first serving cell, for the field, wherein:
the field provides a first value for the first PDSCH reception on the first serving cell, and a second value for the second PDSCH reception on the second serving cell, and
the third DL BWP is an active DL BWP of the first serving cell; and
determining:
a first number of bits for indicating a value from the first values,
a second number of bits for indicating a value from the first values, and
a first value, for the field, with the first number of bits based on a second value, wherein:
the field in the DCI format provides the second value that includes the second number of bits, and
the first value is:
the first number of least significant bits (LSBs) of the second value, when the first number of bits is smaller than the second number of bits,
the second value prepended with a number of zeros, when the first number of bits is larger than the second number of bits,
wherein receiving the first PDSCH further comprises receiving the first PDSCH based on the first value.

4. The method of claim 1, further comprising:
receiving:
third information for first values of a field in the DCI format, wherein the first values are associated with the first DL BWP of the first serving cell, and
fourth information for second values of the field in the DCI format, wherein the second values are associated with a third DL BWP of the first serving cell,
wherein the second values are same as the first values when the field:
provides a value that is commonly applicable to the first PDSCH reception and the second PDSCH reception, and
is not the BWP indicator field.

5. The method of claim 1, further comprising:
determining a value corresponding to the first PDSCH reception, the value provided by a frequency domain resource allocation (FDRA) field of the DCI format,
wherein the first DL BWP is not a dormant BWP for the first serving cell when the value comprises bits that are not:
(i) all equal to 0 for an FDRA type 0,
(ii) all equal to 1 for an FDRA type 1, or
(iii) all equal to either 0 or 1 for a dynamic switching FDRA type.

6. The method of claim 1, further comprising:
indicating a first capability for processing per N consecutive slots of a corresponding scheduling cell:
one first DCI format, from first DCI formats, for the set of serving cells, and
one second DCI format, from second DCI formats, for each serving cell from the set of serving cells that is not scheduled by the one first DCI format wherein:
an active DL BWP on each serving cell in the set of serving cells is associated with a first subcarrier spacing (SCS),
a first DCI format, from the first DCI formats, schedules one or more receptions of one or more PDSCHs on respective one or more serving cells from the set of serving cells,
a second DCI format, from the second DCI formats, schedules a reception of a single PDSCH on a single serving cell,
N=1 when a SCS of the corresponding scheduling cell is smaller than or equal to the first SCS, and
N is a ratio of the SCS of the corresponding scheduling cell to the first SCS when the SCS of the corresponding scheduling cell is larger than the first SCS.

7. The method of claim 6, further comprising:
indicating a second capability for processing per the N>1 consecutive slots of the corresponding scheduling cell:
X>1 first DCI formats for the set of serving cells, and
(X−k) second DCI formats for each serving cell from the set of serving cells that is scheduled by exactly k first DCI formats, from the X first DCI formats, wherein k is included in a set of integers {0, 1, . . . , X}.

8. A user equipment (UE) comprising:
a transceiver configured to receive:
first information for a set of serving cells that includes a first serving cell and a second serving cell,
second information for a first table, wherein:
the first table includes a first number of rows,
a first row, from the first number of rows, includes first time-domain resource allocation (TDRA) indexes and second TDRA indexes,
the first TDRA indexes indicate respective first time-domain resources that have a first one-to-one mapping with first downlink (DL) bandwidth parts (BWPs) of the first serving cell, and
the second TDRA indexes indicate respective second time-domain resources that have a second one-to-one mapping with second DL BWPs of the second serving cell, and
a downlink control information (DCI) format that schedules a reception of a first physical downlink shared channel (PDSCH) on the first serving cell and a reception of a second PDSCH on the second serving cell, wherein:
a value of a TDRA field in the DCI format indicates the first row of the first table, and
a value of a BWP indicator field in the DCI format indicates:
a first DL BWP, from the first DL BWPs, of the first serving cell, and
a second DL BWP, from the second DL BWPs, of the second serving cells; and
a processor operably coupled with the transceiver, the processor configured to determine:
a first time-domain resource, from the first time-domain resources, wherein the first time-domain resource:
is indicated by a first TDRA index, from the first TDRA indexes, and
is mapped to the first DL BWP based on the first mapping, and
a second time-domain resource, from the second time-domain resources, wherein the second time-domain resource:
is indicated by a second TDRA index, from the second TDRA indexes, and
is mapped to the second DL BWP based on the second mapping,
wherein the transceiver is further configured to receive:
the first PDSCH in the first time-domain resource on the first DL BWP of the first serving cell, and
the second PDSCH in the second time-domain resource on the second DL BWP of the second serving cell.

9. The UE of claim 8, wherein:
the transceiver is further configured to receive:
third information for values, corresponding to the first DL BWP of the first serving cell, for a parameter associated with a field in the DCI format, wherein the field is one of a rate-matching indicator field, a zero-power (ZP) channel state information reference signal (CSI-RS) trigger field, a sounding reference signal (SRS) request field, an SRS offset indicator field, or a transmission configuration indication (TCI) field, and
fourth information for a second table corresponding to the field, wherein:
the second table includes a second number of rows,
a second row, from the second number of rows, includes a first index for the first serving cell and a second index for the second serving cell,
the first index applies to any of the first DL BWPs of the first serving cell,
the second index applies to any of the second DL BWPs of the second serving cell, and
a value of the field in the DCI format indicates the second row of the second table;
the processor is further configured to determine a value, from the values, for the parameter, that is associated with the first index; and
the transceiver is further configured to receive the first PDSCH based on the value.

10. The UE of claim 8, wherein:
the transceiver is further configured to receive:
third information for first values for a field in the DCI format, wherein the first values are associated with the first DL BWP of the first serving cell,
fourth information for second values for the field in the DCI format, wherein the second values are associated with a third DL BWP of the first serving cell;
the field provides a first value for the first PDSCH reception on the first serving cell and a second value for the second PDSCH reception on the second serving cell;
the third DL BWP is an active DL BWP of the first serving cell;
the processor is further configured to determine:
a first number of bits for indicating a value from the first values,
a second number of bits for indicating a value from the second values, and
a first value, for the field, with the first number of bits based on a second value;
the field in the DCI format provides the second value that includes the second number of bits;
the first value is:
the first number of least significant bits (LSBs) of the second value, when the first number of bits is smaller than the second number of bits, and
the second value prepended with a number of zeros, when the first number of bits is larger than the second number of bits; and
the transceiver is further configured to receive the first PDSCH based on the first value.

11. The UE of claim 8, wherein:
the transceiver is further configured to receive:
third information for first values of a field in the DCI format, wherein the first values are associated with the first DL BWP of the first serving cell, and
fourth information for second values of the field in the DCI format, wherein the second values are associated with the second DL BWP of the first serving cell; and
the second values are same as the first values when the field:
provides a value that is commonly applicable to the first PDSCH reception on the first serving cell and the second PDSCH reception on the second serving cell, and
is not the BWP indicator field.

12. The UE of claim 8, wherein:
the processor is further configured to determine a value corresponding to the first PDSCH reception on the first serving cell, the value provided by a frequency domain resource allocation (FDRA) field of the DCI format; and
the first DL BWP is not a dormant BWP for the first serving cell when the value comprises bits that are not:
(i) all equal to 0 for an FDRA type 0,
(ii) all equal to 1 for an FDRA type 1, or
(iii) all equal to either 0 or 1 for a dynamic switching FDRA type.

13. The UE of claim 8, wherein:
the transceiver is further configured to transmit an indication of a first capability for processing per N consecutive slots of a corresponding scheduling cell:
one first DCI format, from first DCI formats, for the set of serving cells, and
one second DCI format, from second DCI formats, for each serving cell from the set of serving cells that is not scheduled by the one first DCI format;
an active DL BWP on each serving cell in the set of serving cells is associated with a first subcarrier spacing (SCS);
a first DCI format, from the first DCI formats, schedules one or more receptions of one or more PDSCHs on respective one or more serving cells from the set of serving cells;
a second DCI format, from the second DCI formats, schedules a reception of a single PDSCH on a single serving cell;
N=1 when a SCS of the corresponding scheduling cell is smaller than or equal to the first SCS; and
N is a ratio of the SCS of the corresponding scheduling cell to the SCS of the set of serving cells when the SCS of the corresponding scheduling cell is larger than the first SCS.

14. The UE of claim 13, wherein the transceiver is further configured to transmit an indication of a second capability for processing per the N>1 consecutive slots of the corresponding scheduling cell:
X>1 first DCI formats for the set of serving cells, and
(X−k) second DCI formats for each serving cell from the set of serving cells that is scheduled by exactly k first DCI formats, from the X first DCI formats, wherein k is included in a set of integers {0, 1, . . . , X}.

15. A base station comprising:
a transceiver configured to transmit:
first information for a set of serving cells that includes a first serving cell and a second serving cell,
second information for a first table, wherein:
the first table includes a first number of rows,
a first row, from the first number of rows, includes first time-domain resource allocation (TDRA) indexes and second TDRA indexes,
the first TDRA indexes indicate respective first time-domain resources that have a first one-to-one mapping with first downlink (DL) bandwidth parts (BWPs) of the first serving cell, and
the second TDRA indexes indicate respective second time-domain resources that have a second one-to-one mapping with second DL BWPs of the second serving cell, and
a downlink control information (DCI) format that schedules a transmission of a first physical downlink shared channel (PDSCH) on the first serving cell and a transmission of a second PDSCH on the second serving cell, wherein:
a value of a TDRA field in the DCI format indicates the first row of the first table, and
a value of a BWP indicator field in the DCI format indicates:
a first DL BWP, from the first DL BWPs, of the first serving cell, and
a second DL BWP, from the second DL BWPs, of the second serving cell; and
a processor operably coupled with the transceiver, the processor configured to determine:
a first time-domain resource, from the first time-domain resources, wherein the first time-domain resource:
is indicated by a first TDRA index, from the first TDRA indexes, and
is mapped to the first DL BWP based on the first mapping, and
a second time-domain resource, from the second time-domain resources, wherein the second time-domain resource:
is indicated by a second TDRA index, from the second TDRA indexes, and
is mapped to the second DL BWP based on the second mapping,
wherein the transceiver is further configured to transmit:
the first PDSCH in the first time-domain resource on the first DL BWP of the first serving cell, and
the second PDSCH in the second time-domain resource on the second DL BWP of the second serving cell.

16. The base station of claim 15, wherein:
the transceiver is further configured to transmit:
third information for values, corresponding to the first DL BWP of the first serving cell, for a parameter associated with a field in the DCI format, wherein the field is one of a rate-matching indicator field, a zero-power (ZP) channel state information reference signal (CSI-RS) trigger field, a sounding reference signal (SRS) request field, an SRS offset indicator field, or a transmission configuration indication (TCI) field, and
fourth information for a second table corresponding to the field, wherein:
the second table includes a second number of rows,
a second row, from the second number of rows, includes a first index for the first serving cell and a second index for the second serving cell,
the first index applies to any of the first DL BWPs of the first serving cell,
the second index applies to any of the second DL BWPs of the second serving cell, and
a value of the field in the DCI format indicates the second row of the second table;
the processor is further configured to determine a value, from the values, for the parameter, that is associated with the first index; and
the transceiver is further configured to transmit the first PDSCH based on the value.

17. The base station of claim 15, wherein:
the transceiver is further configured to transmit:
third information for first values for a field in the DCI format, wherein the first values are associated with the first DL BWP of the first serving cell, and
fourth information for second values for the field in the DCI format, wherein the second values are associated with a third DL BWP of the first serving cell;
the field provides a first value for the first PDSCH transmission on the first serving cell and a second value for the second PDSCH transmission on the second serving cell;
the third DL BWP is an active DL BWP of the first serving cell;
the processor is further configured to determine:
a first number of bits for indicating a value from the first values,
a second number of bits for indicating a value from the second values, and
a first value, for the field, with the first number of bits based on the second value;
the field in the DCI format provides the second value that includes the second number of bits;
the first value is:
the first number of least significant bits (LSBs) of the second value, when the first number of bits is smaller than the second number of bits, and
the second value with a number of zeros, when the first number of bits is larger than the second number of bits; and
the transceiver is further configured to transmit the first PDSCH based on the first value.

18. The base station of claim 15, wherein:
the transceiver is further configured to transmit:
third information for first values for a field in the DCI format, wherein the first values are associated with the first DL BWP of the first serving cell, and
fourth information for second values of the field in the DCI format, wherein the second values are associated with a third DL BWP of the first serving cell; and
the second values are same as the first values when the field:
provides a value that is commonly applicable to the first PDSCH transmission on the first serving cell and the second PDSCH reception on the second serving cell, and
is not the BWP indicator field.

19. The base station of claim 15, wherein:
the processor is further configured to determine a value, corresponding to the first PDSCH transmission on the first serving cell, provided by a frequency domain resource allocation (FDRA) field of the DCI format, and
the first DL BWP is not a dormant BWP for the first serving cell when the value comprises bits that are not:
(i) all equal to 0 for an FDRA type 0,
(ii) all equal to 1 for an FDRA type 1, or
(iii) all equal to either 0 or 1 for a dynamic switching FDRA type.

20. The base station of claim 15, wherein:
the transceiver is further configured to receive:
a first indication of a first capability for processing per N consecutive slots of a corresponding scheduling cell:
one first DCI format, from first DCI formats, for the set of serving cells, and
one second DCI format, from second DCI formats, for each serving cell from the set of serving cells that is not scheduled by the one first DCI format; or
a second indication of a second capability for processing per the N>1 consecutive slots of the corresponding scheduling cell:
X>1 first DCI formats for the set of serving cells, and
(X−k) second DCI formats for each serving cell from the set of serving cells that is scheduled by exactly k first DCI formats, from the X first DCI formats, wherein k is included in a set of integers {0, 1, . . . , X};
an active DL BWP on each serving cell in the set of serving cells is associated with a first subcarrier spacing (SCS);
a first DCI format, from the first DCI formats, schedules one or more transmissions of one or more PDSCHs on respective one or more serving cells from the set of serving cells;
a second DCI format, from the second DCI formats, schedules a transmission of a single PDSCH on a single serving cell;
N=1 when a SCS of the corresponding scheduling cell is smaller than or equal to the first SCS; and
N is a ratio of the SCS of the corresponding scheduling cell to the first SCS when the SCS of the corresponding scheduling cell is larger than the first SCS.
